(19) United States
(12) Patent Application Publication
(10) Pub. No.: US 2003/0126047 A1
(43) Pub. Date: Jul. 3, 2003

(54) Accounting engine for a lease transaction management and accounting system

(76) Inventors: Terri Hollar, Fayetteville, GA (US); Pam Schmid, San Francisco, CA (US); Audy Kotlinski, Chicago, IL (US); David Rice, San Francisco, CA (US); Karen Smith, Toledo, OH (US); Michelle Mclean, Sterling Heights, MI (US); Jeanette Johnson, Toledo, OH (US); Pramodkumar Sadalage, Des Plaines, IL (US); Matt Foemmel, Chicago, IL (US)

Correspondence Address: RADER, FISHMAN & GRAUER, PLLC, Suite 140, 39533 Woodward, Bloomfield Hills, MI, 48304, US

(21) Appl. No.: 09/896,236

(22) Filed: Jun. 29, 2001

(51) Int. Cl. G06F 17/60

(52) U.S. Cl. 705/30

(57) ABSTRACT

A system is provide for effectively managing lease transactions in a comprehensive manner. Data is generated, processed, and stored at the lowest possible logical level in order to maximize the flexibility of a user to conduct processing at the asset, billing schedule, lease, account owner, master agreement, customer, or program level. Using a fully normalized data design, similar characteristics are treated similarly and different characteristics are treated differently. Unlike other systems, assets associated with the same lease can be treated differently without having to fake asset level processing by using multiple leases with one asset each, to represent one actual lease. A hierarchy of rule settings is enforced, whereby the rule at the lower more specific level trumps the rule at the higher or more general level. The system uses a highly encapsulated accounting engine which encapsulates accounting rules in a transparent incorporates accounting expertise in flexible and transparent manner. The accounting engine is triggered by business events to automatically generate accounting entries.

### BACKGROUND OF THE INVENTION

The present invention relates in general to computer-based systems used to manage lease transactions and underlying assets, and to perform related accounting functions. In particular, the present invention relates to a comprehensive lease transaction management and accounting system that uses an encapsulated accounting transactor to perform all accounting functions triggering off of business and operational events and which is capable of processing and storing information at the asset level.

For various tax, accounting, and other business reasons, many companies decide to lease rather than purchase the equipment required to conduct necessary business activities. While such lease transactions can be desirable, each lease arrangement adds a third party lessor to a transaction that would otherwise be solely between the manufacturer or seller of the equipment, and the user of the equipment if an outright sale were involved. The third party lessor is often an entity in the financial services industry, and thus is often not interested in using the leased assets upon termination or expiration of a lease. The question of what residual value in the assets will ultimately inure to the lessor upon termination or expiration of the lease affects the terms and conditions upon which a lessor is willing to engage in a particular lease transaction. The willingness of a lessor to engage in a particular lease may also be hampered by the difficulty in assessing the true profitability of such a transaction for the lessor. In short, the leasing industry is hampered by the lack of an innovative lease management and accounting system capable of providing lessors with timely and comprehensive information relating to the lease, the underlying assets, and the relevant accounting transactions underlying to the lease and leased assets. The prior art does not provide an adequate tool for aggressively managing lease transactions from the perspective of a lessor.

The lack of relevant information to predict and track characteristics that could render a potential lease transaction more or less desirable to a lessor also hampers manufacturers, sellers, and would be lessees. Faced with incomplete information, the lessor inevitably requires that the cost of any insecurity be passed on to the lessee, rendering such transactions more expense to the lessee, and potentially cost prohibitive. A lack of relevant information on the part of a lessor impedes the ability of a lessor to offer lease terms and conditions that would add value to manufacturers, users, and lessors. Conversely, easy access to important information could allow lessors to more accurately price and structure lease transactions to the potential benefit of manufacturers, users, and lessors.

There are at least two substantial impediments facing prior art leasing systems. First, existing systems entangle operational processing with the generation of accounting information relating to the operational processing. Although accounting transactions are obviously related to operational and business events in that accounting entries are derived from the underlying business or operational event, it would be highly desirable for a lease transaction management and accounting system to be designed in such a way as to distinguish between an operational event and an accounting event. It would be highly desirable if a system could be designed such that accounting processes are automatically triggered by operational events, but are otherwise substantially transparent to a user of the system. It would be advantageous for accounting expertise to be embedded in the system such that a user of the system need not possess any accounting expertise, and such users could rely on the system to perform whatever accounting is needed to be performed. It would also be desirable if the encapsulated and transparent accounting rules could be easily changed by those with the appropriate accounting expertise. To facilitate the subsequent modification of the accounting rules, it would be desirable if the accounting rules could be changed by using the system instead of having to substantially alter the system itself to modify the accounting rules. To facilitate such flexibility, it would be highly desirable for accounting functionality to be isolated from operational functionality with respect to where the underlying logic is performed in the source and object code of the software system.

The second impediment to effective lease transaction management and accounting is the inability of such systems to accurately process and store characteristics at the appropriate level of abstraction. Certain attributes such as the identity of a customer on a master agreement, may relate to a series of leases. An attribute such as a billing schedule might relate to particular lease. The depreciation of an asset relates to that particular asset. If an asset is split into sub-components, such as a computer system being split into a monitor, keyboard, mouse, and CPU, then certain information will be particular to the subcomponent with other information relating to the combination of assets. Existing systems cannot in a comprehensive, accurate, and flexible manner store and process information at the appropriate level in the information hierarchy. In particular, true asset-level processing is not available in prior art systems. Information that truly relates to an asset is instead associated with the lease or the customer. Given the fact that most accounting functionality ultimately relates to individual assets, the lack of true asset-level processing is a substantial weakness. Some prior art systems try to work around the limitation in ways that create other inaccuracies. For example, some prior art systems mimic asset level processing by artificially creating additional leases, and associating only one asset per lease, even though in reality there is only a single lease with multiple assets. Such a system cannot then process lease information accurately because the lease is no longer accurately represented on the system. Moreover, events such as asset-splitting further removes the information on the system from an accurate portrayal of the true business picture. Further, a change in the terms of the actual lease or even the occurrence of certain events associated with the lease, must somehow be tracked across multiple “fake” leases, substantially increasing complexity and the potential for error. It would be desirable for distinct information to be treated distinctly, and similar information to be treated similar. An asset may have some relationship with a lease, but an asset is not a lease. A billing schedule may have some relationship with a lease, but a billing schedule is not a lease.

It would be highly desirable for a lease transaction management and accounting system to process and store information at the level in which such information truly applies, with asset-level information being associated with an asset, lease-level information being associated with a lease, customer information being associated with a customer, billing schedule level information being associated with a billing schedule, lessor information associated with a lessor, and pertinent third party information associated with that third party at the proper level of abstraction.

It would also be desirable if rules, information, and characteristics attributed at a lower and more specific level would trump default rules, information, and characteristics set at a higher level. For example, it would be desirable for billing criteria defined for a particular asset would trump the billing criteria set more generally on the lease for which that asset belongs.

### SUMMARY OF THE INVENTION

The present invention relates in general to computer-based systems used to manage lease transactions, leased assets, and perform related accounting functions. In particular, the present invention relates to a comprehensive lease transaction management and accounting system that uses an encapsulated accounting engine to perform all accounting functions automatically once the relevant operational or business event is triggered in the system. Accounting logic is segregated from the operational logic of the system, so data entry personnel and other users need not possess any accounting expertise. In contrast, all of the accounting rules can be established by personnel with accounting expertise during the implementation phase of the system, and automatically implemented in a transparent way by non-accounting users without such expertise. Such an encapsulated accounting engine facilitates the ability to generate multiple book entries across multiple book sets from a single operational event.

The system is extremely flexible, and is capable of storing information at the appropriate level in the data hierarchy. Information relating to an asset is stored at the asset level. Information relating to a lease is stored at the lease level. Information relating to a customer, product line, or profit center, are similarly stored at the appropriate level. Although storing information at the lowest logical level, the system can also generate consolidated views or consolidated transactions.

There are numerous examples of the flexibility provided by the system. The system can be used to support lease management and accounting functions beginning from the execution of a lease all the way through its termination or automatic expiration including the disposal of all assets relating to that lease. Different billing schedules can be created for two or more assets under the same lease because billing schedules can be created at the asset, lease, account number, account owner, and organization levels, such as a customer or any other involved third party. Assets at the end of a lease may be treated distinctly from each other. An internal rate of return (“IRR”) can be computed at the level of an individual asset, a lease, an account number, or for the aggregate of transactions relating to a particular customer. Income statements, balance sheets, depreciation schedules, and asset cost information can be made readily available for invidual assets, an individual lease, or at the account number or even customer level. Asset return and tracking can be done distinctly for each individual asset, an entire lease, an entire account number, or for a particular customer. Tax-related processing can treat each individual asset in a distinct manner with respect to jurisdiction (e.g. responsible governmental authority based on asset type and location), amount, and exemptions. Processing can also occur at the address or customer level. The assignment of charges, taxes, and penalties can be done at the asset level, the lease level, by account number, or by customer. Asset-level histories of all transactions can be stored, and thus asset level, lease level, account level, and customer level histories can be generated. Billing criteria can be set at the individual asset level so that two assets on a lease can have different billing criteria. Billing criteria can also be set at the lease, account number, account owner, and customer level. Multiple cost factors can be associated with the same asset since data is stored at the asset-level. Active assets can exist on the system even when not attached to a lease. Such assets are part of inventory, with the corresponding financial and accounting impacts. The ability to process information at various levels of abstraction, such as asset-level, lease-level, or customer-level supports the ability of a user to conduct a “what if” analysis. For example, an internal rate of return can be calculated based on a “what if” analysis of executing a particular lease with that customer. “What if” analysis can also be performed to compare different scenarios so that apparently unequal treatment can either be explained or eliminated. The system's flexibility also provides the ability to compare to the IRR of a particular lease to the overall IRR relating to the perspective customer of that particular lease.

The system also supports several internal distinctions relating to a lessor. For example, the system supports the creation, maintenance, and attribution of characteristics to lessor programs. A program is usually a subentity or internal group of a lessor. A program could be a marketing initiative, a joint venture, a subsidiary, a division, a department, or any other internal grouping in a lessor's organization. A program could also be distinguished on the basis of business practices of a vendor or manufacturer. A program can have numerous leases associated with it, with the program providing default variables for items such as financial product, accounting owner, initial direct cost rules, post termination rules, interim rent rules, and other default rules. A financial product is an offering to the marketplace on the part of a program. Examples of financial products include such things as finance leases, operating leases, options, asset sales and potentially any other transaction. A program can have multiple products but an individual financial product can only belong to one program. Other programs could have essentially identical financial products in terms of characteristics, but such financial products would not be identical. An accounting owner, described in greater detail below, is an additional example of a internal distinction of a lessor, based on internal profit and loss or “PIL” responsibility. These internal distinctions allow different organizations within a lessor to conduct business differently, and to have those differences impact default rules and accounting treatment. Thus, the system supports varied business approaches both amongst different lessors, as well as within invidual lessors.

The system allows users to book, unbook, and rebook leases with the touch of a button. Assets can be split into component parts, with each component then consituting a separate asset on the system, with all of the flexibility the system accords to assets regardless of origin. Each asset can have multiple addresses for tax purposes, and such information will be incorporated into the automatic tax calculation. Multiple book and tax depreciators can be applied to a single asset, and each asset can be treated distinctly for accounting purposes. Buyout and property tax information can automatically be included as part of a quote. The system also facilitates the ability to adjust present and future decisions based on past and present conditions. For example, if a lot of assets relatively low in value will shortly be going off lease, then the buyout price could be lowered to avoid excessive inventory.

The hierarchy of relationships from program to customer to account number to lease to asset allows the system to facilitate data entry for potentially voluminous records at the asset level. Instead of typing in a billing schedule for all assets on a lease, a billing schedule can be associated with the lease on the billing schedule screen, and the system can automatically replicate the information for each individual asset. The system allows users to refer to leases by unique descriptive text referred to as a “natural account” instead of needing to use a numerical key identifier as stored in a database. When a due date is earlier than a create date, the logical date as entered into the system is used instead of the actual calendar date that the user entered the information. Thus, penalties can be set retroactively and the commencement date can similarly be be change retroactively. System defaults for the application of charges and payments can be manually overriden. Whan a payment is unapplied, the payment is stored as unapplied, with the associated check number, due date, and the customer. The system's address book is aware that a single entity can have more than one role on the system. Thus, a customer could also be a guarantor, and a vendor. By maintaining role awareness, set off payments can be applied as appropriate.

Various additional advantages of this invention will become apparent to those skilled in the art from the following detailed description of the preferred embodiment, when read in light of the accompanying drawings.

### BRIEF DESCRIPTION OF THE DRAWINGS

In the drawings:

I. Surrounding Environment and Underlying Architecture

FIG. 1 is a high level block diagram depicting selected aspects and interrelationships established to manage lease transactions and generate accounting entries relating to leasing.

FIG. 2 is a block diagram depicting selected functional elements of the system, and selected database tables and selected object-oriented programming objects used to support the selected functional elements.

FIG. 3a is multi-layer view of the technical architecture used in the preferred embodiment of the invention utilizing the Java programming language and an Oracle SQL database.

FIG. 3b illustrates a web services registry embodiment of the invention, where individual transactions on the system can be invoked in isolation of the entire system.

FIG. 4 is a network diagram illustrating how users can access the computer system from remote locations in a preferred embodiment of the invention, which provides access to the invention through the business model of an application service provider.

FIG. 5 is a flow chart disclosing at a high level how the architecture of the invention uses enterprise beans and reusable object-oriented data objects in the preferred embodiment of the invention under Java and an application service provider business model as the delivery mechanism.

FIG. 6 is a block diagram illustrating how the lease transaction management and accounting system can be interfaced with a “front end” system for generating and managing lease originations.

II. System Flowcharts

FIG. 7 discloses a high-level flowchart disclosing selected subsystems used by the invention to manage lease transactions, from the initial setup of the system through to the completion of end of lease processing.

FIG. 7.200 discloses a detailed flowchart of a financial accounting setup process using an financial accounting subsystem.

FIG. 7.202 discloses a detailed flowchart of a create item catalog process using an item catalog processing subsystem.

FIG. 7.204 discloses a detailed flowchart of an organization setup process using the organization processing subsystem.

FIG. 7.206 discloses a detailed flowchart of a create asset process using an asset processing subsystem.

FIG. 7.208 discloses a detailed flowchart of a create master agreement process using a master agreement processing subsystem.

FIG. 7.210 discloses a detailed flowchart of a create lease process using a lease processing subsystem.

FIG. 7.212 discloses a detailed flowchart of a create billing schedule process using a billing schedule processing subsystem.

FIG. 7.214 discloses a detailed flowchart of a booking process using a booking subsystem.

FIGS. 7.216a-d disclose detailed flowcharts of a charge generation process using a charge processing subsystem.

FIGS. 7.218a-b disclose detailed flowcharts of an invoicing generation process using an invoice processing subsystem.

FIGS. 7.220a-c disclose detailed flowcharts of a payment application process using a payment processing subsystem.

FIGS. 7.222a-b disclose detailed flowcharts relating to an end of lease process using a end of lease processing subsystem.

FIG. 7.224 discloses a detailed flowchart of a charge reversal, adjustment, or credit process using a charge reversal, adjustment, or credit subsystem.

FIGS. 7.226a-b disclose detailed flowcharts of an unbook lease process using an unbook subsystem.

FIGS. 7.228a-c disclose detailed flowcharts of a rebook lease process using a rebook subsystem.

FIG. 7.230 discloses detailed flowcharts regarding a payment adjustments, reversals, and splits process using a payment adjustment, reversals, and splits subsystem.

III. Asset-Level Processing and Data Hierarchy

FIG. 8 discloses a high-level diagram indicating several levels at which data can be process and viewed.

FIG. 9 is a high-level block diagram relating business objectives to data hierarchy.

FIG. 10 is a high-level block diagram illustrating asset-based processing and functionality.

FIG. 11 is a flow chart illustrating the life cycle of an asset.

FIG. 12a is an object model for an asset in a single asset class embodiment, illustrating the relationships an asset can have with other classes of objects.

FIG. 12b is an object model for an asset in a multiple asset classes embodiment, illustrating the relationships an asset can have with other classes of objects.

FIG. 13 is an asset state model, indicating the various states that an asset can be in such as unbooked and on lease.

FIG. 14 is an object model for a lease schedule object, illustrating the relationships a lease schedule can have with other classes of objects.

FIG. 15a is an object model for a billing schedule in a single billing schedule class embodiment, illustrating the relationships a billing schedule can have with other classes of objects.

FIG. 15b is an object model for a billing schedule in a multiple billing schedule class embodiment, illustrating the relationships a billing schedule can have with other classes of objects.

FIG. 16 is an object model for an asset-on-agreement object, illustrating the relationships an asset-on-agreement object can have with other classes of objects.

FIG. 17a is picture of an asset before being split into several independent assets.

FIG. 17b is a picture of an asset after being split into several independent assets.

IV. Accounting Engine

FIG. 18 discloses selected functions of an accounting engine over the course of a lease cycle.

FIG. 19 discloses some of the data relationships incorporated into the process of generating booksets from a lease agreement.

FIG. 20 illustrates a business event and an accountable object triggering an accounting transactor to generate a bookset entry.

FIG. 21 illustrates a business event and an accountable object triggering an accounting transactor to generate a parallel entry across multiple book sets.

FIG. 22 discloses a detailed flow chart relating to the AssetAcquisition accounting transactor.

FIG. 23 discloses a detailed object diagram relating to the AssetAcquisition accounting transactor.

FIG. 24 discloses a detailed flow chart relating to the AssetAcquisition accounting transactor in an embodiment generating multiple book entries.

FIG. 25 discloses a detailed data object diagram relating to the AssetAcquisition accounting transactor in an embodiment generating multiple book entries.

V. Additional Features

FIG. 26 is a flow chart of the documentation generation process.

FIG. 27 is a flow chart of the document tracking process.

FIG. 28 is a flow chart of the inquiry search screen process.

### DETAILED DESCRIPTION OF THE PREFERRED EMBODIMENT

I. Surrounding Environment and Underlying Architecture

A. Overview

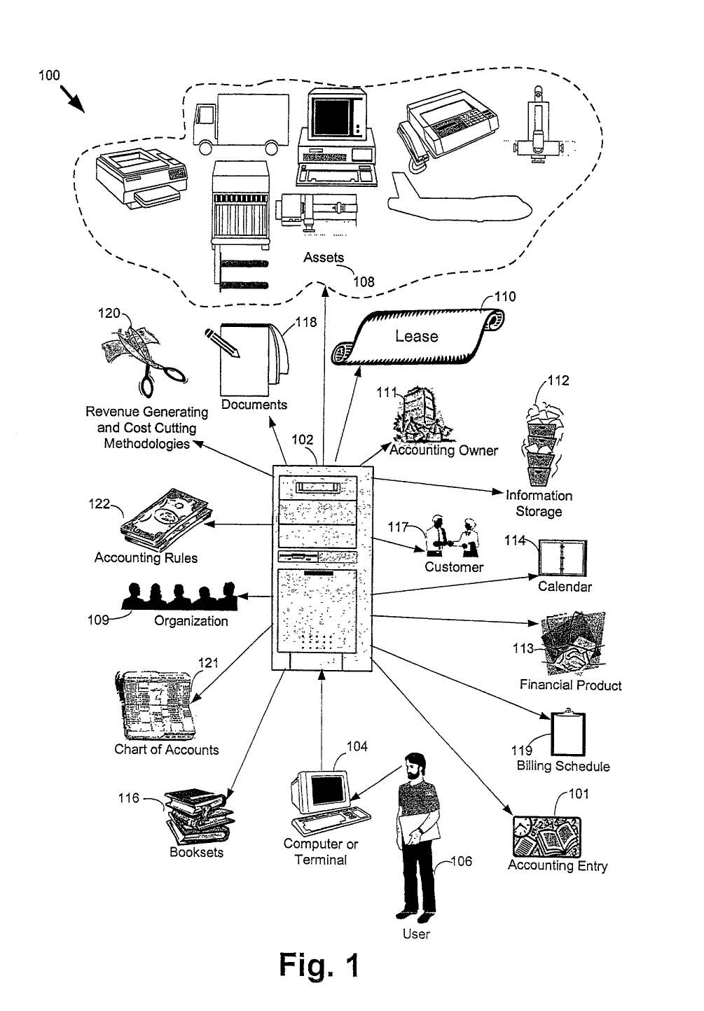

Referring now to the drawings, FIG. 1 illustrates at a very high level, a comprehensive lease transaction management and accounting system 100. The lease transaction management and accounting system 100 includes a computer system 102 in which the inventive software application is run and stored. A user 106 accesses the computer system 102 through a computer or a terminal 104. In the preferred embodiment of the system 100, a user 106 uses a terminal 104 to access the Internet to connect to the computer system 102 managed by an application service provider (“ASP”). In other embodiments, the computer system 102 can reside on an intranet, an extranet, a local area network (“LAN”), a wide area network (“WAN”), or any other type of network or stand-alone computer. If the computer system 102 resides on a network, then the computer or terminal at 104 is any machine or device capable of connecting to that network. If the computer system 102 can be accessed by the Internet, then the computer or terminal at 104 is any machine or device capable of connecting to the Internet. If the computer system at 102 is a stand-alone computer, then the computer system at 102 is the same device as the computer at 104.

The lease transaction management and accounting system 100 is a comprehensive tool for managing the transactions and accounting entries relating to asset leases. The computer system 102 is able to receive, incorporate, store, and process information that is important to the managing of leases 110 and leased assets 108. Accounting entries 101 relating to those leases 110 and assets 108 can be automatically generated by the system 100 and stored in booksets 116. Samples of different assets 108 such as automobiles, forklifts, computer equipment, and other Items are illustrated in the figure. The computer system 102 facilitates the ability of the user 106 to process information regarding an asset 108. Information from a lease agreement or contract 110 or other document is incorporated into the computer system 102. The computer system 102 can distinguish between different profit centers, departments, office geographies, subsidiaries, and other subgroups with each defined subgroup constituting an accounting owner 111 of a lessor. The user 106 defines each subgroup with accounting requirements as an accounting owner 111. The computer system 102 fulfills such requirements by generating accounting entries 101 on a bookset 116 belonging to the accounting owner 111.

The computer system 102 can also distinguish between two or more financial products 113. A financial product 113 is the type of lease offerings offered by a lessor. Capital leases, finance leases, operating leases, and $1 buyouts, are all examples of different financial products 113. Because accounting rules 122 differ for different types of transactions, the computer system 102 must be able to distinguish between financial products 113 in order to apply different accounting rules 122. Accounting rules 122 can be generated and modified by users 106 with accounting expertise, and applied in a transparent way by other users 106 without any accounting expertise, through the use of the computer system 102. A chart of accounts 121 serves as a cross-index for all booksets 116, accounting owners 111, financial products 113, and accounting rules 122. The chart of accounts 121 is a master cross-index maintained electronically by the computer system 102.

Important information 112 such as transaction history can be stored electronically using the computer system 102. Billing schedules 119, payment periods, depreciation calculations, and other calendar 114 related information are managed by the computer system 102. Documents 118 can be generated such as quotes for end of lease sales, invoices, internal comments, standardized leases, and other useful documents, through the use of the computer system 102. Whatever cost cutting or revenue enhancing methodologies 120 need to be incorporated by the user 106 or the lessor, the computer system 102 can facilitate and enforce such methodologies and generate the appropriate reports 118.

The computer system 102 processes and stores all relevant data and at the lowest logical level that such data can exist. For example, information relating to an asset 108 is stored at the asset level and information relating to a lease 110 is stored at the lease level. Assets 108 are distinct from leases 110, and thus an asset 108 is not simply an attribute of a lease. A billing schedule 119 contains information relating to a series of charges. A billing schedule 119 is distinct from both a asset 108 and a lease 110, although both may be associated with multiple billing schedules 119. Similarly, a customer 117 may be a party to several distinct lease agreements 110, and thus customer 117 information is treated distinctly from the information relating to a particular lease 110. Furthermore, not all organizations 109 are customers 117, an organization 109 can also be a guarantor, a vendor, a maintenance service organization, or virtually any other type of entity or organization that plays a role in the leasing process. The system 100 is designed with a modular architecture to maximize user flexibility, and to allow the easy interfacing with other systems.

B. Underlying Architecture

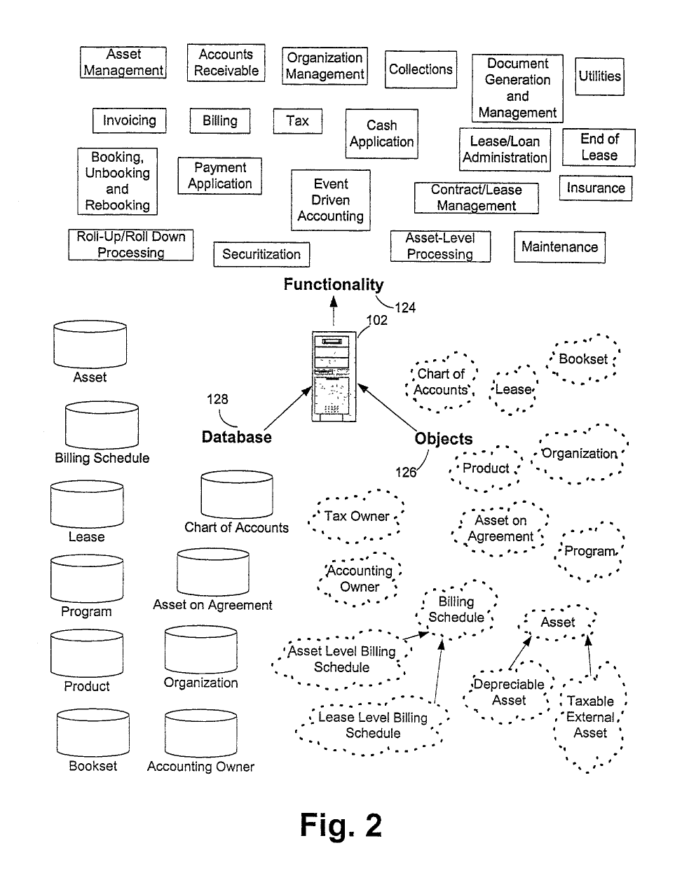

Referring now to FIG. 2, the relationship between a functionality area 124, a database table 128, and an object-oriented data object 126 is disclosed. A selected list of general functionality areas 124 includes but is not limited to asset management, accounts receivable, organization (customer/vendors) management, collections, insurance, utilities, invoicing, billing, tax, cash applications, booking/unbooking/rebooking, end of lease functionality, event driven accounting, lease/loan administration, payment application, securitization, contract/lease management, roll-up/roll-down processing, asset-level processing, and asset maintenance.

A sample list of object-oriented programming objects 126 includes but is not limited to objects representing an asset, a lease, a billing schedule, a chart of accounts, an accounting owner, an organization (customer/vendor), a bookset, a product, a program, a tax owner, and an asset on an agreement. A sample list of database tables 128 includes but is not limited to asset, billing schedules, lease, program, product, chart of accounts, organization, accounting owner, bookset, and asset-on-agreement. These database tables 128 may be in one or more databases. In various alternative embodiments of the invention, a particular class of objects can be broken down into a multiple subclasses of objects. For example, the system 100 could use a single class of billing schedule objects to perform processing relating to billing schedule for an individual asset 108 or a billing schedule relating to all of the assets 108 on a particular lease. The system could also use multiple subclasses of billing schedules 119, one subclass relating to asset-level processing and another subclass relating to lease-level processing. Similarly, a single asset class be used, or multiple subclasses of assets could be created to further isolate processing relating to asset depreciation or situations where a lessor is responsible for paying taxes on an asset 108 without owning the asset 108. The subclasses of asset objects and billing schedule objects are discussed in greater detail below.

For many functionality areas such as asset-level processing that includes creating, modifying, and activating assets 108, there is a clear correlation between asset level processing as a functionality 124, the object-oriented data type of the asset, and a data base table 128 containing information regarding asset-level attributes. Many other functionality features 124 on the computer system 102 are implemented using a similar correlation between functionality 124, database table 128, and object 126. When it is possible to do so in the preferred embodiment, objects 126 possess characteristics substantially similar to the columns of a database table 128 to generate the required functionality 124. Such an architecture often maximizes the flexibility presented by a fully normalized relational database. For example, an asset's activation date could be stored as an attribute of an object 126 which would then update the activation date on the asset database table 128. Object subclasses such as lease-level billing schedule objects are used in the preferred embodiment of the invention to further isolate certain sub-processes. However, such subclasses usually relate up to a single parent object which will correlate with a functionality area and a database table. Thus, multiple subclasses of a particular object class does not disturb the correlation described above. The use of multiple subclass objects for assets 108 and billing schedules 119 is discussed in greater detail below.

There are certain functional areas that are inherently processed based and cannot use such an architecture. For example, event driven accounting is a functionality 124 area that cannot be implemented through the use of an “event driven accounting” database table 128 or an “event driven accounting” object 126. Rather, event driven accounting is a process performed on objects 126 and through the use of objects 126, in accordance with accounting rules 122 entered into the computer system 102 during system setup. Thus, there is no event driven accounting object 126 or an event driven accounting database table 128. As will be described in greater detail below, event driven accounting is accomplished by an encapsulated accounting engine, which applies specific accounting rules 122 to specific triggering operational or business events requiring that accounting work be done. The accounting rules 122 are enforced by the computer system 102 through various functions referred to as accounting transactors, as described in greater detail below. Accounting transactors can be called to perform various types of accounting operations by various types of objects, but the functionality is fulfilled through other database tables 128 and other objects 126. The system 100 is designed to have a highly flexible architecture to facilitate easy maintenance and the development of future enhancements. The functionality 124 of the system 100 is designed to be implemented in fully modular and encapsulated way.

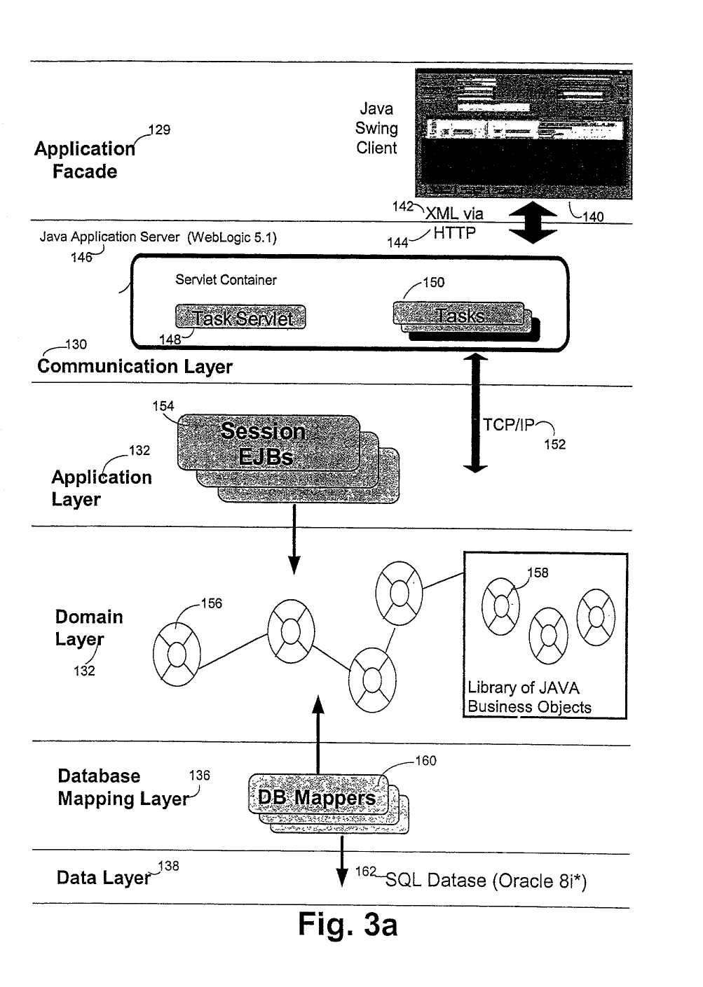

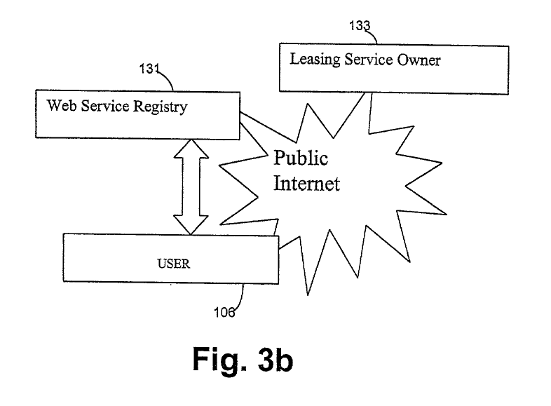

FIG. 3a illustrates the various architectural layers that make up the computer system 102. The top layer represents the level at which a user 106 directly interacts with the computer system 102. The top layer is an application facade 129. In the preferred embodiment, the user 106 accesses the computer system 102 through the Internet using a web browser at 140, and thus the application layer 128 connects to a communication layer 130 using an XML file 142 and a protocol known as HTTP 144. XML 142 means extensible Markup Language, which is a condensed form of SGML (Standard Generalized Markup Language) a common format for web site design. XML 142 supports customized tags to enhance organizational flexibility in presenting information. The HTTP 144 protocol means Hypertext Transfer Protocol, a common method for communicating information between a web browser and a web server. In the preferred embodiment of the invention, a secure connection through HTTPS, a secured form of HTTP 144, or some other security regime is used to protect all data from unauthorized access and manipulation.

The communication layer 130 is responsible for facilitating a user's 106 ability to access the computer system 102 through the application facade 128. The communications layer 130 contains an application server 146. In the preferred embodiment, the computer system 102 is written in programming language known as Java. More specifically, a Java Two Enterprise standard is used. Such an architecture will accommodate planned new components easily and is highly scalable. The architecture provides for flexible process flows, and utilizes a thin client application that is accessible via the Internet. Open interface architecture standards facilitate scalability to meet business growth. Java applications use a servlet 148 to support particular applications. A servlet 148 is a small Java program used to facilitate the performance of a software application on a server. In the preferred embodiment, a servlet 148 will exist to support the software application running on the computer system at 102 with the application constituting a task 150 to be supported.

The task 150 in the communication layer 130 interfaces with an application layer 132 using a protocol called TCP/IP 152. TCP/IP 152 means Transmission Control Protocol/Internet Protocol, a protocol suite for communication networks such as the Internet. An EJB 154 is an enterprise Java bean. Each “instance” of the software application running on the computer system at 102 will require an EJB 154. An EJB 154 provides software developers with the ability to apply Java technology to the creation of reusable server components for business applications.

A domain layer 134 contains the business logic of the computer system 102. For example, the process of validating the activation of an asset 108 or lease 110 is located in the domain layer. In the preferred embodiment of the invention, an object-oriented programming language such as Java is used to build the software that resides on the computer system 102. A domain layer 134 of an object-oriented software application will contain both a library of ancestor objects 158 and application objects 156 inheriting characteristics and functionality from the library of objects.

Beneath the domain layer 134 is a database mapping layer 136. The database mapping layer 136 contains a database mapper 160, which interfaces between the domain layer 134 where the business logic of a software application exists, and a data layer 138 that houses the commercially available relational database 162, such as SQL Server, Oracle, or Sybase, which actually stores asset 108 and the other information created, inputted, and stored by the system 100. In the preferred embodiment of the invention, Oracle is the relational database used at 162. In non-preferred embodiments, the database would not even need to be relational.

FIG. 3b discloses a high-level flow chart of a web service registry embodiment of the invention. Such a system 100 is transaction based, where a user 106 accesses a particular functionality 124 by accessing the web service registry 131 through the Internet. All leasing functionality contained within the system is packaged such that it can be invoked as a web service by querying a public domain web service registry 131 for services related to leasing. The registry would return a set of data describing all of the services available for transactional processing. Once the list of services is obtained, the business can further query the registry to obtain detailed XML document type definition (“XML DTD”) and related service description documents. The service description documents would enable a business to submit information to the web service for processing and return the value-add business result.

The process for a user 106 to access the system 100 in its web services embodiment is as follows. First, a user 106 can query the web service registry 131 using a standard messaging and transport protocol for information about available leasing services. The web service then returns a list of leasing services. The user 106 can then query the web service registry for detailed description for specific leasing service usage. The user 106 can request credentials from a leasing services owner 133 to enable authentication and interaction with the web services. The leasing services owner 133 returns the credentials in the context of a business contract for the user's 106 use of the services. The user 106 then authenticates and interacts with the selected transactional service using XML DTD as prescribed by the web services registry 131. The selected web service processes the submitted information, performs the value-added business transaction, and returns the value-added information using XML to the user 106.

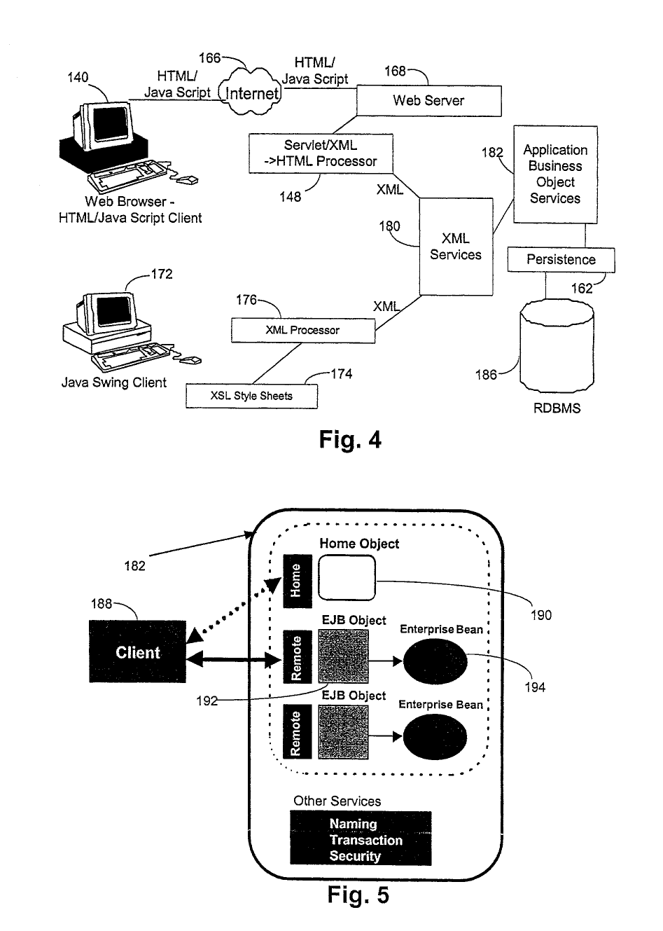

FIG. 4 discloses two preferred ways in which the user 106 can access the computer system 102. In one embodiment, a computer 104 with a web browser 140 uses the Internet 166 to access a web server 168 with an XML servlet 148, and is otherwise capable of running a Java software application. The user accesses the software application 182 on the computer system 102 through XML services 180 supported by the XML servlet 170. The application 182 accesses data in a persistence 184 (data stored in a database) through a relational database management system 186.

The other embodiment disclosed in FIG. 4 for accessing the computer system 102 is also a preferred embodiment. A computer 172 accesses the XML services at 180 through an XML processor 176 and XSL Style Sheets 174. XSL is an acronym for extensible stylesheet language. It is a language for specifying stylesheets that format complex XML data. In contrast to cascading style sheets (CSS), which map an XML element into a single display object, XSL can map an individual XML element into more than one type of display object. For example, a single XML element could be an element in a list, and an item in a table. The flexibility in displaying data makes XSL a desirable tool.

FIG. 5 discloses a basic flow chart illustrating how an object-oriented Java software application 182 utilizes objects. All domain-level objects reside as a home object at 190. When such objects are needed by a user 106 acting through a client 188 machine, such as a computer or terminal at 104, an instance of an enterprise Java bean object 192 is generated along with a enterprise bean 194. An enterprise Java bean object 192 and an enterprise bean are created for each user 106 utilizing the application software 182. As disclosed by the Figure, the supporting services of security, data transactions, and naming which are known under the art are also provided in this framework.

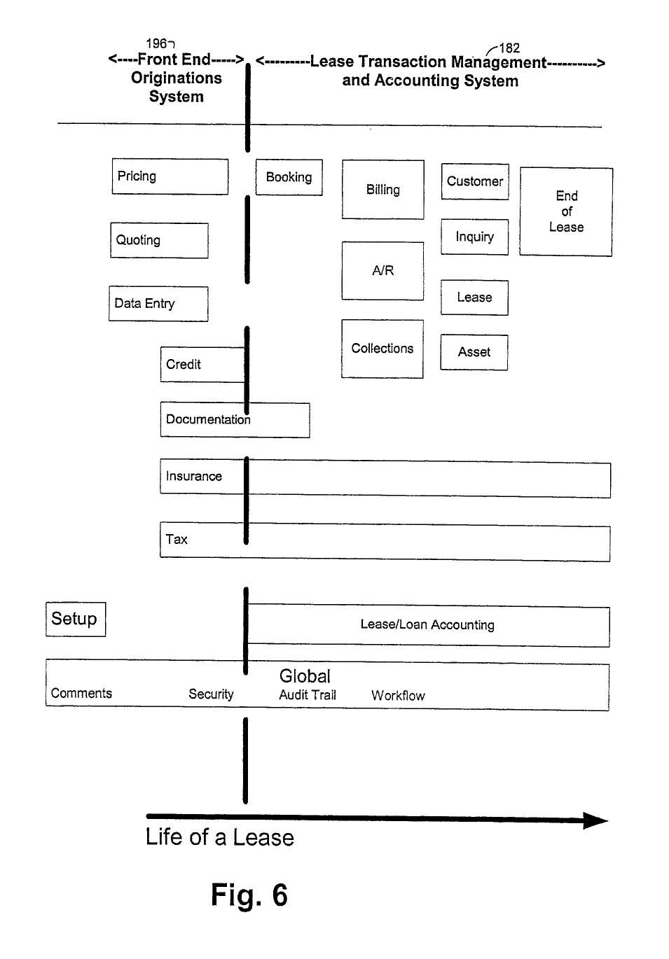

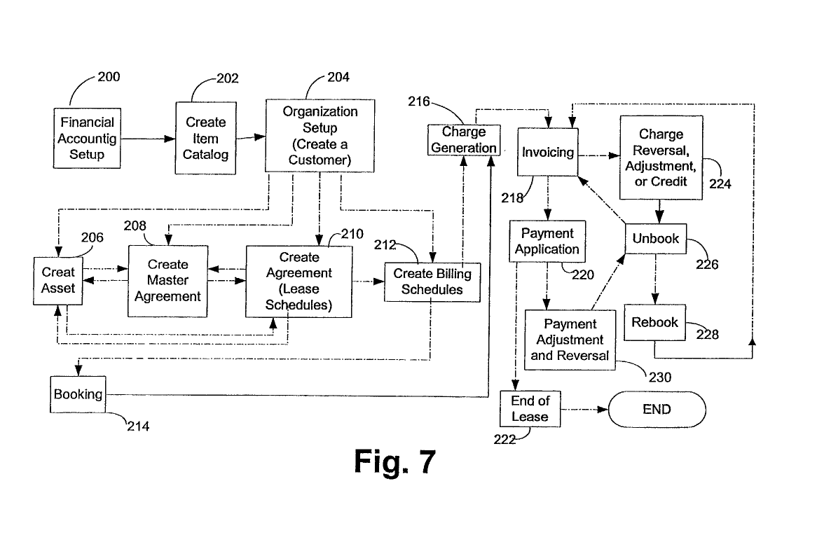

FIG. 6 illustrates how the software application 182 for lease transaction management and accounting could interface with a “front end” originations software application 196. An originations system 196 manages the process from tracking potential leads for a lease through the time that a lease 110 is actually executed, and the application software 182 then takes over. In the preferred embodiment of the invention, the front end originations system 196 will generate potential pricing, quoting, credit analysis, lease documentation, insurance, and tax information, and such information will freely interface with the transaction management and accounting software application 182. The Figure discloses that certain functions such as comments, security, audit trail, and workflow are global, and thus should be accessible at any point in the process. Other functions such as lease/loan accounting are related to leases, and not merely potential future leases. In the embodiment disclosed in the Figure, the setup process which includes the defining of accounting rules 122, is performed before the front end originations system 196 is used to track leads, generate potential processing, or otherwise begin implementation. The system 100 is designed in a modular way to facilitate the interfacing of other systems.

II. Using the System from the Startup through End of Lease

A. High Level Flow Chart for Overall System

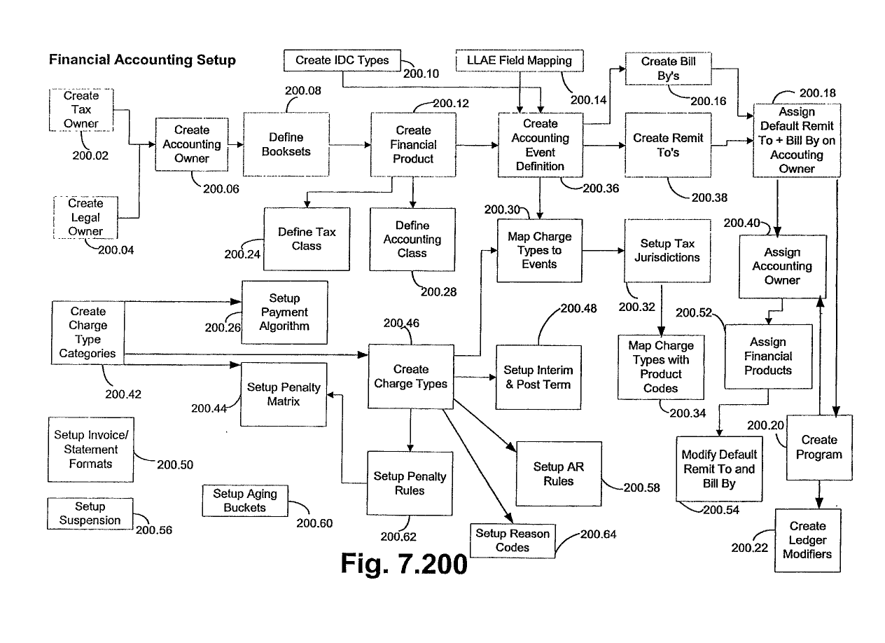

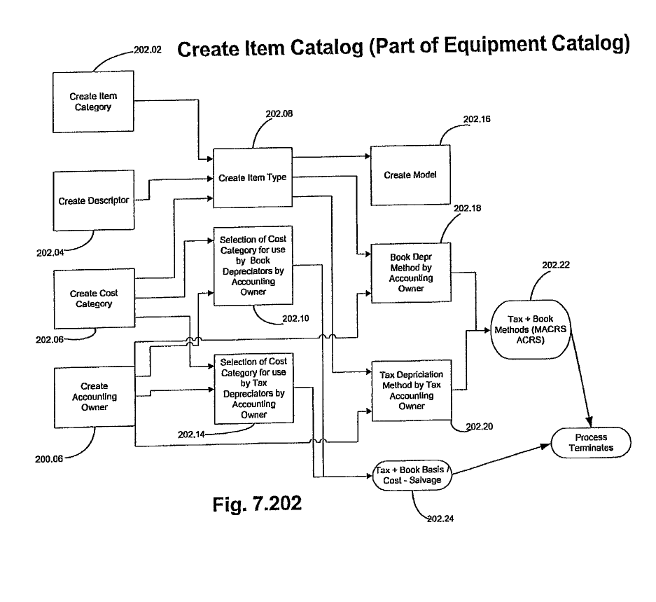

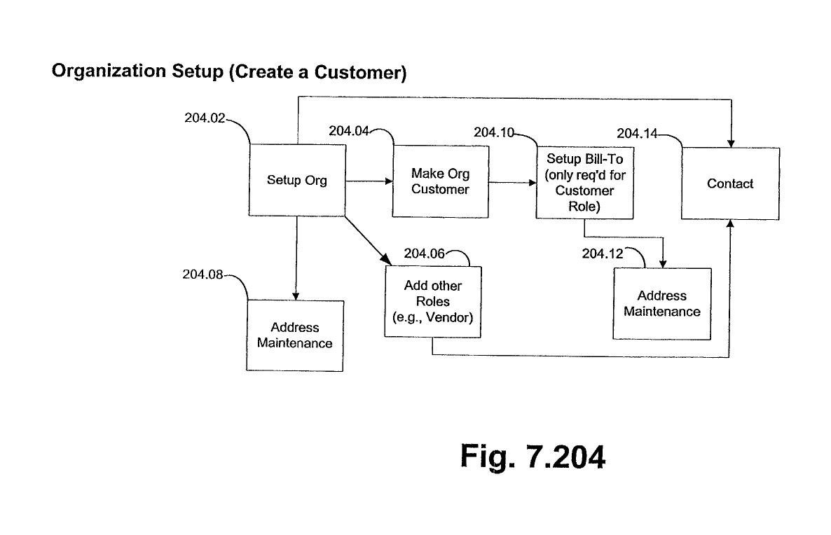

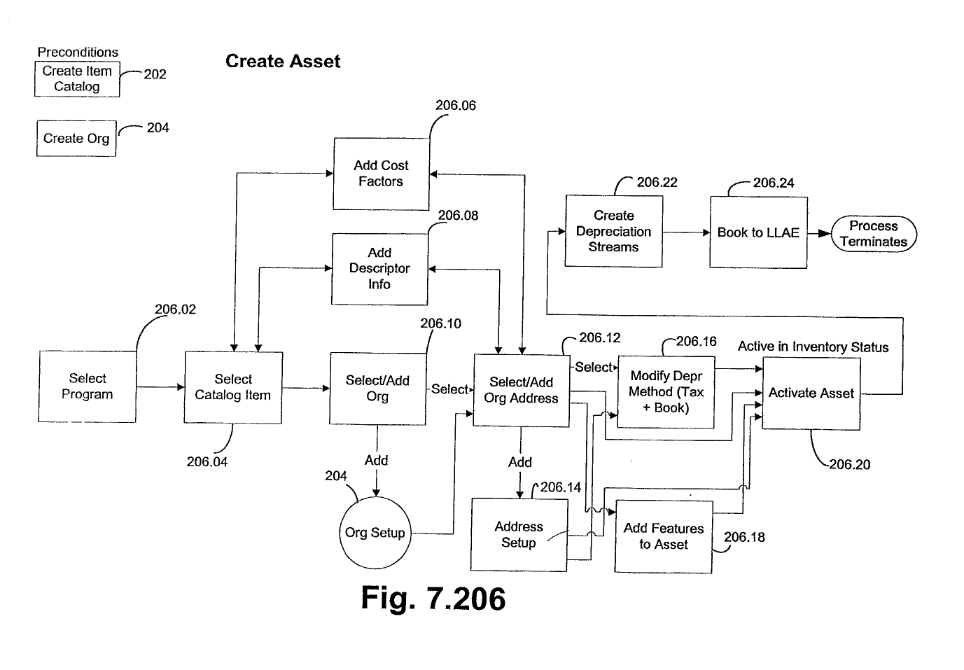

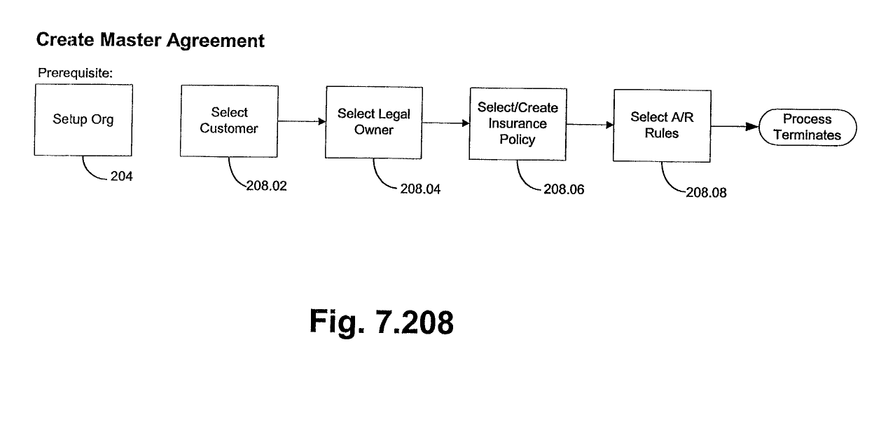

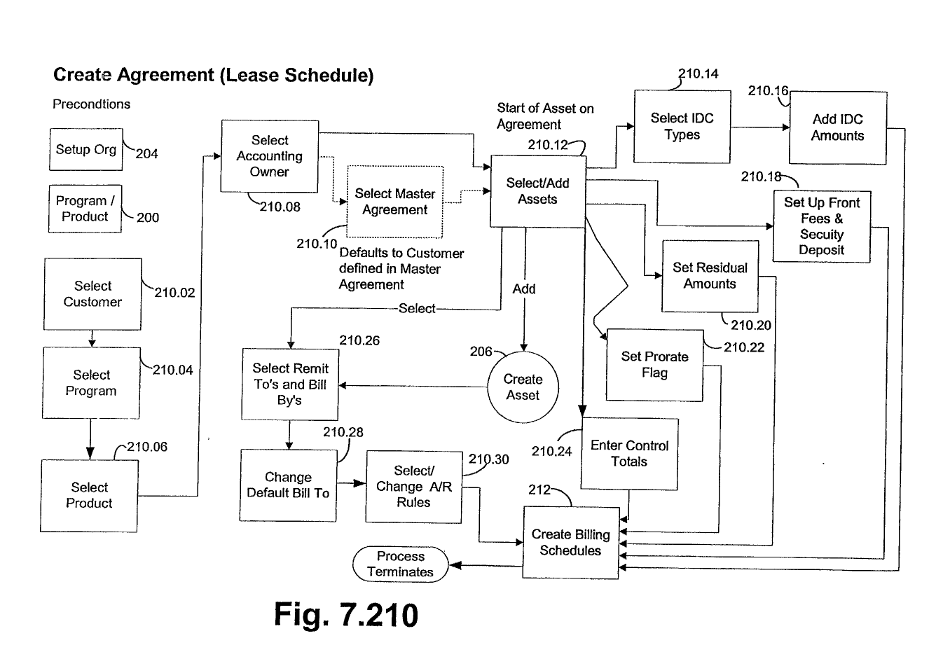

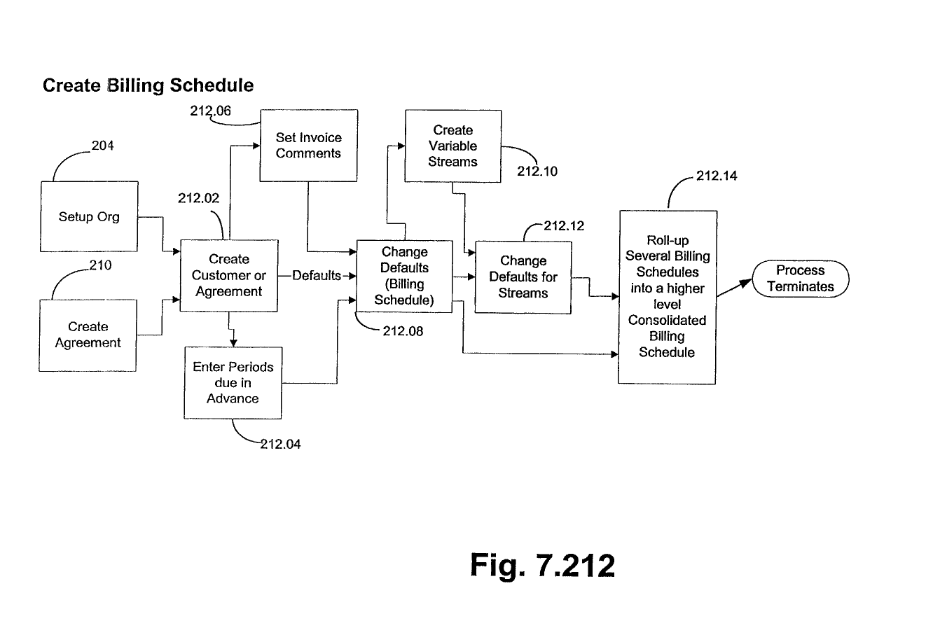

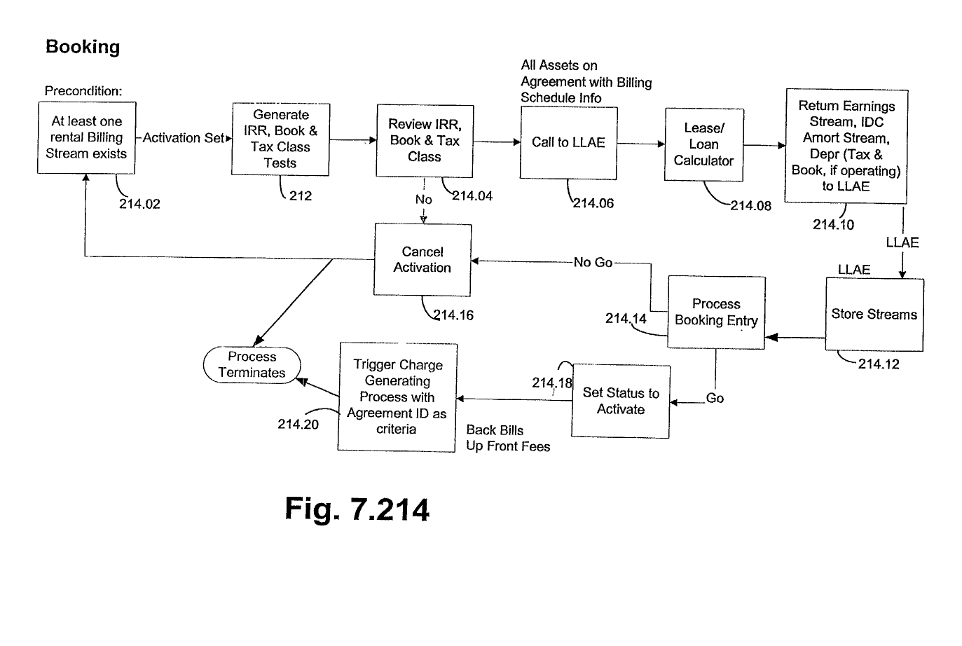

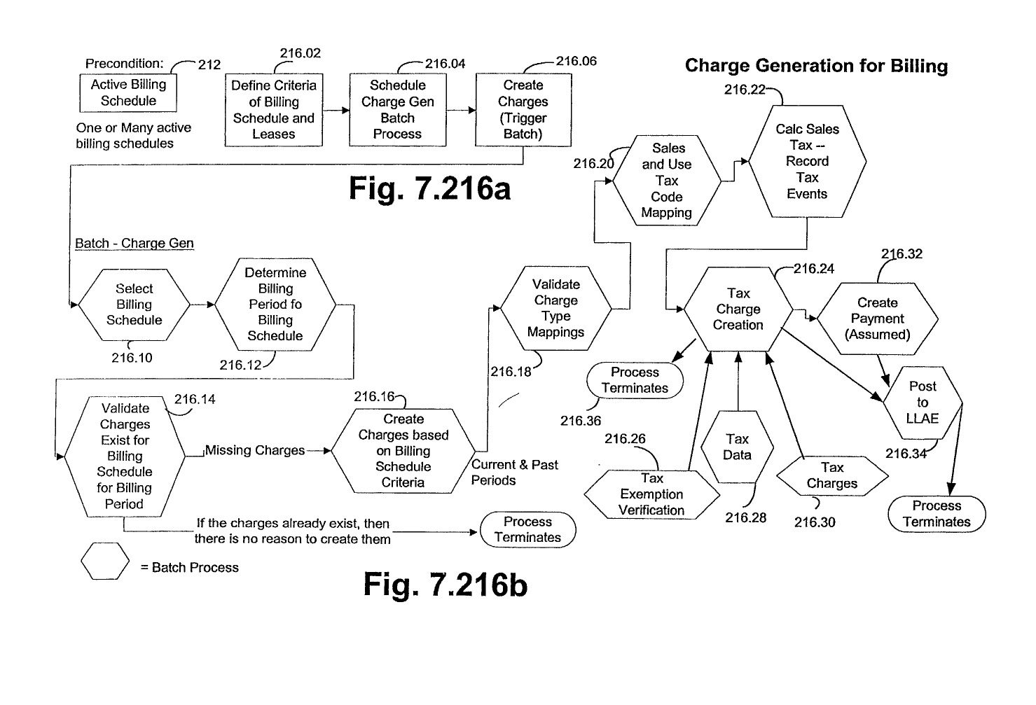

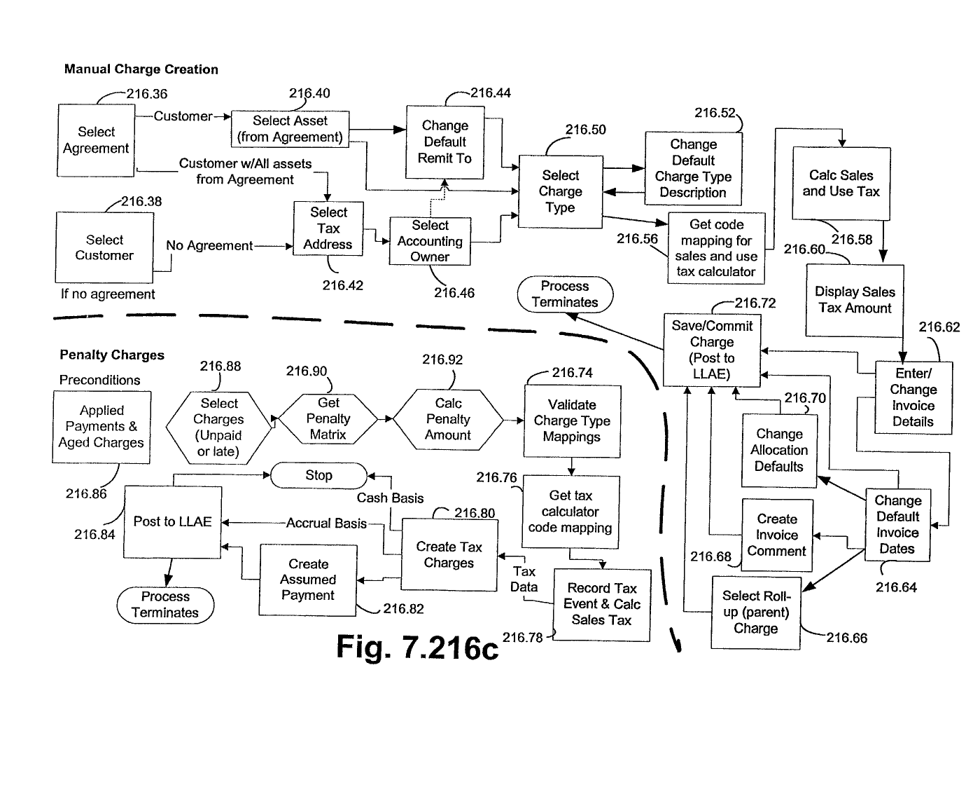

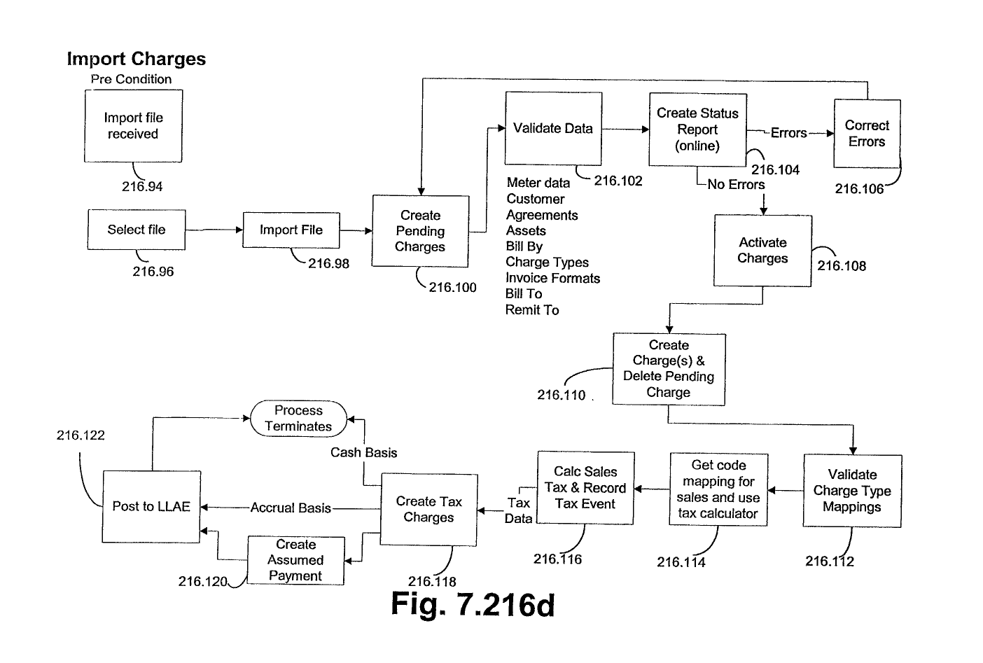

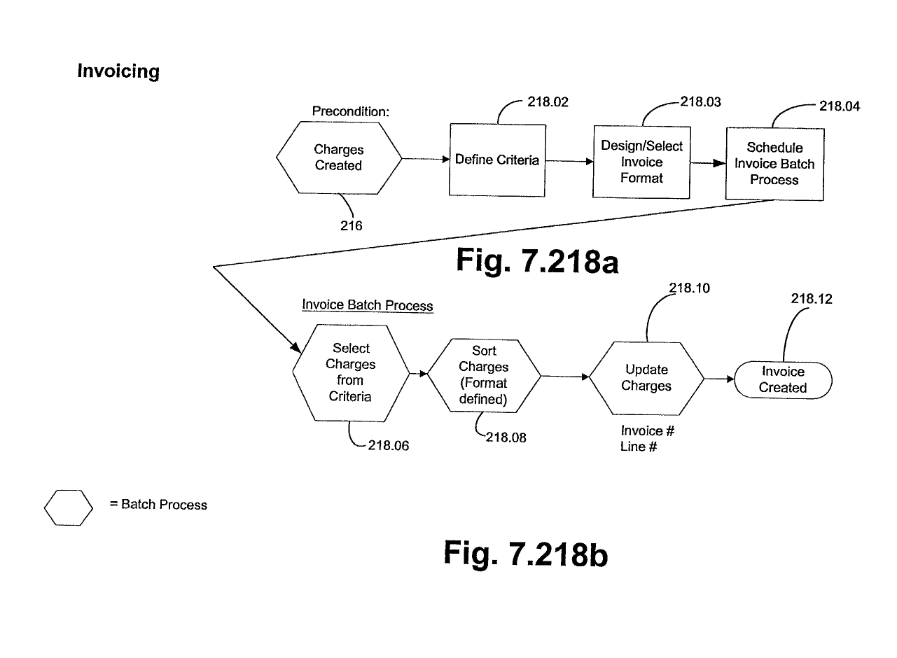

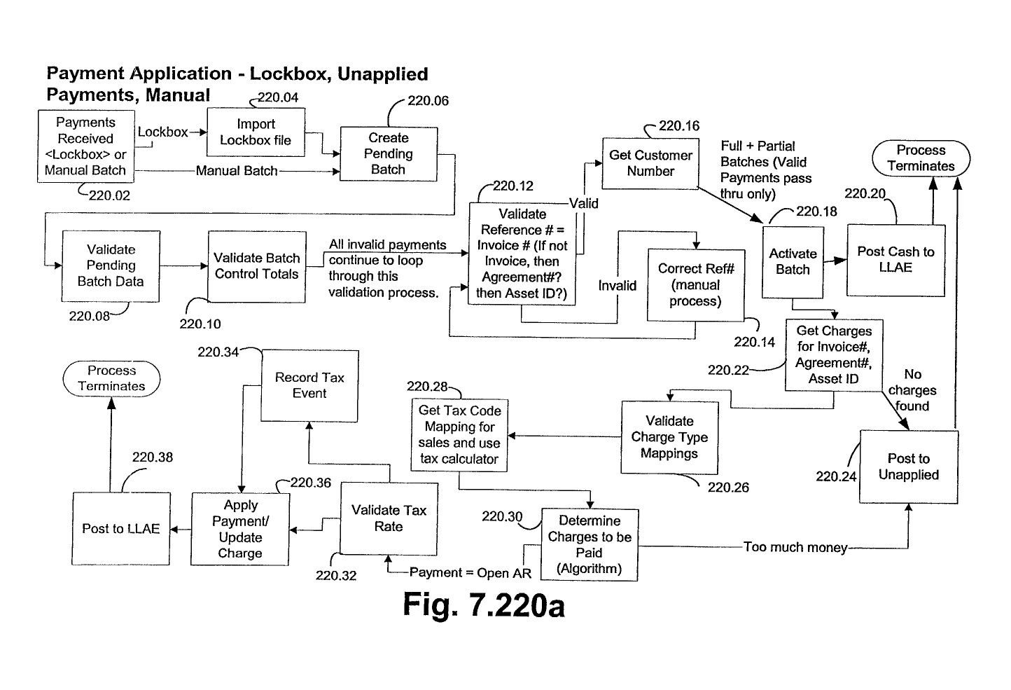

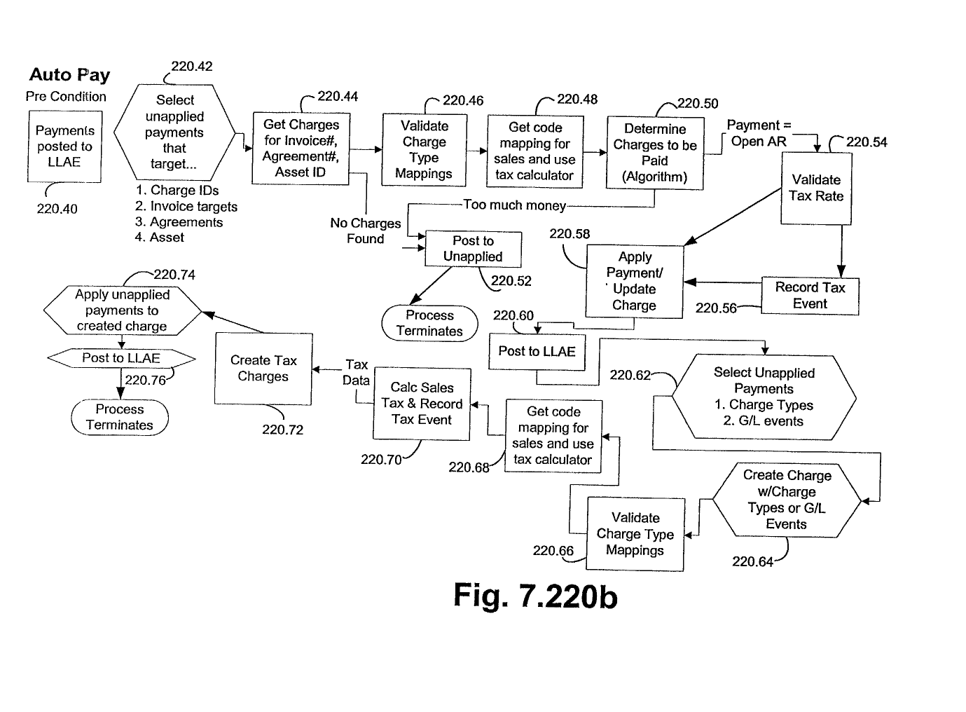

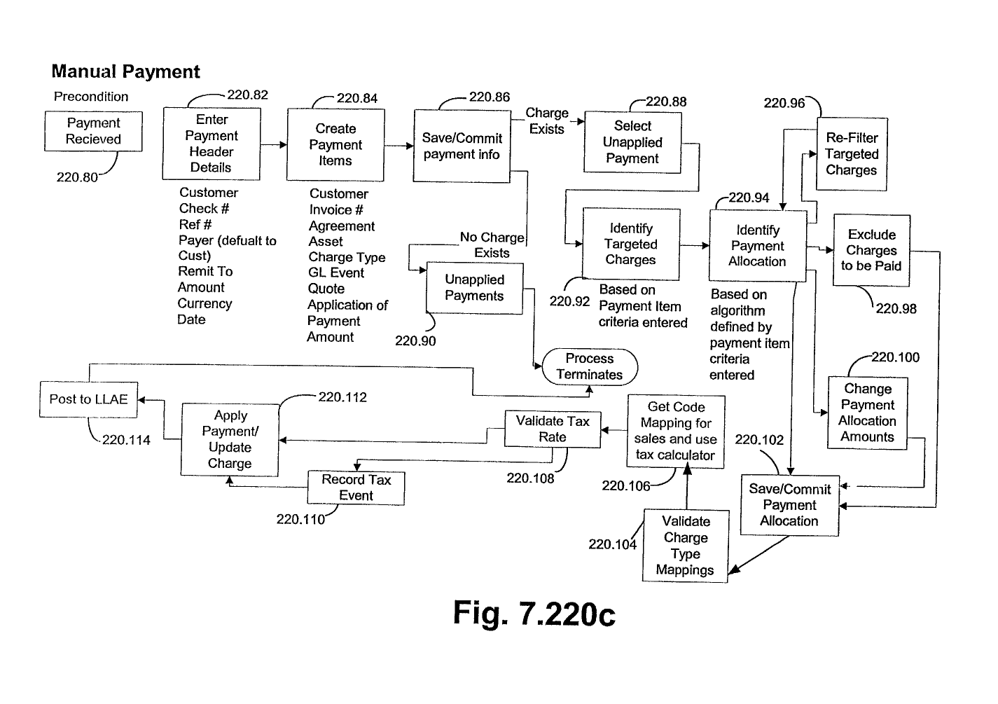

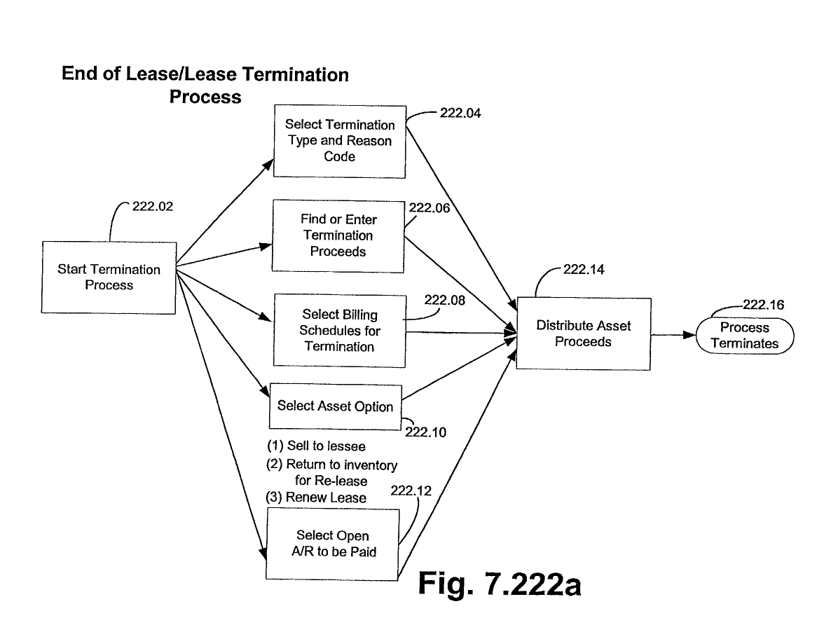

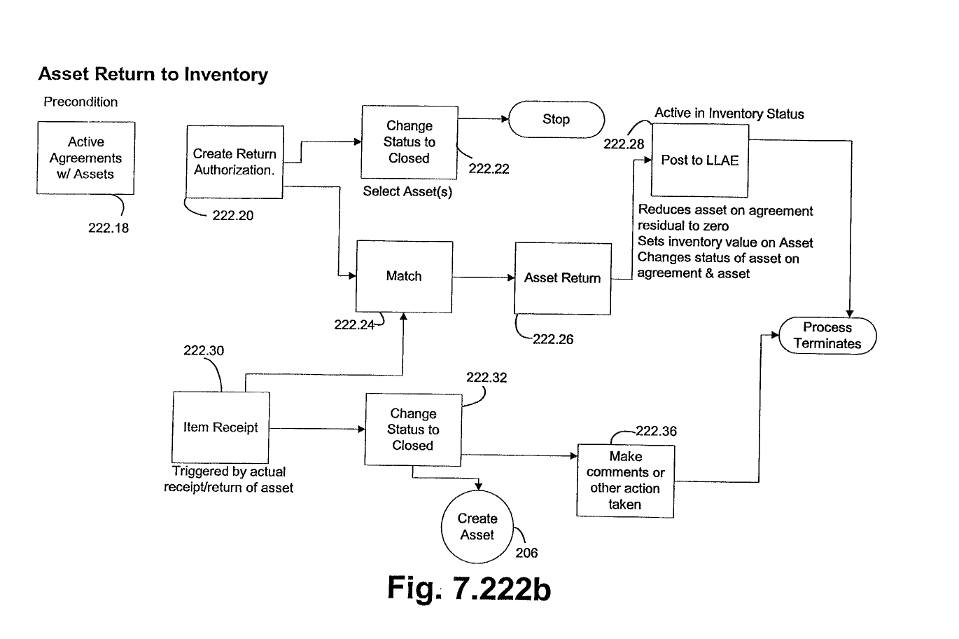

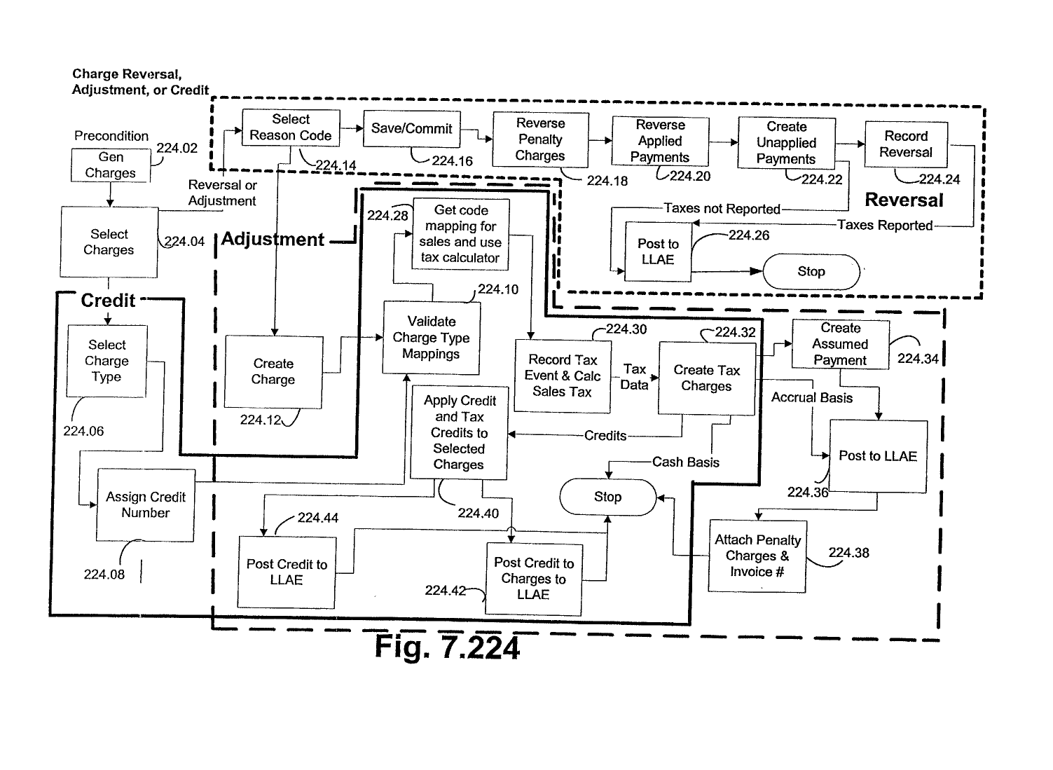

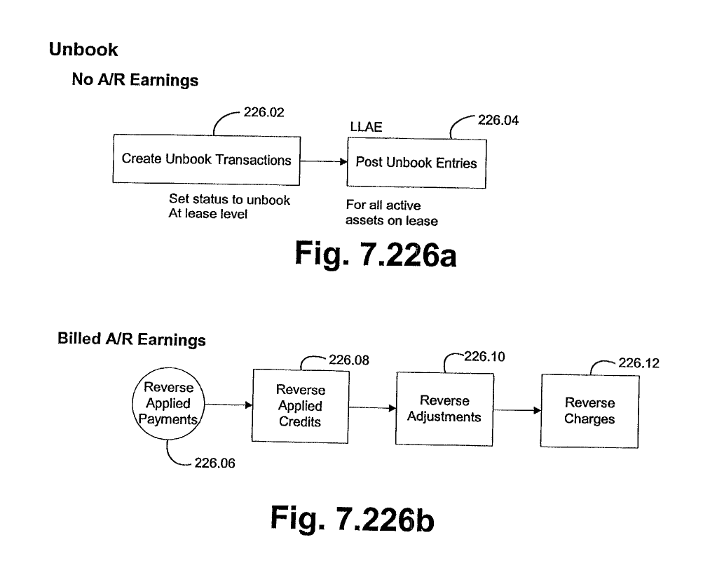

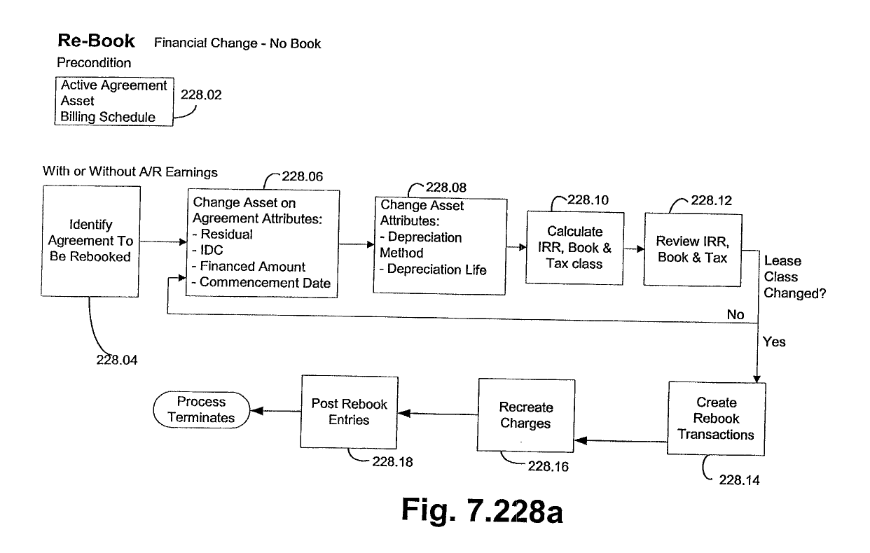

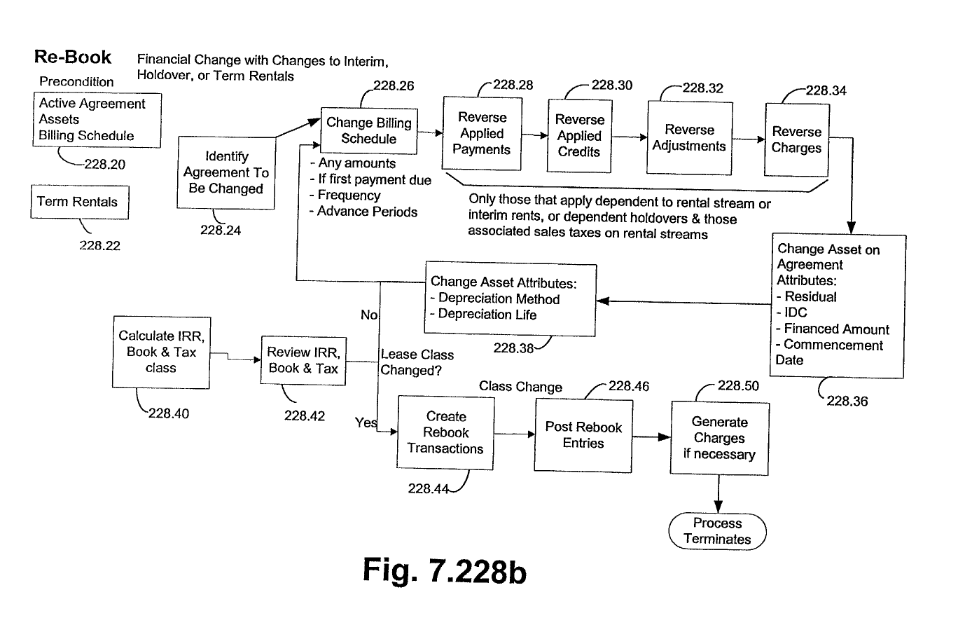

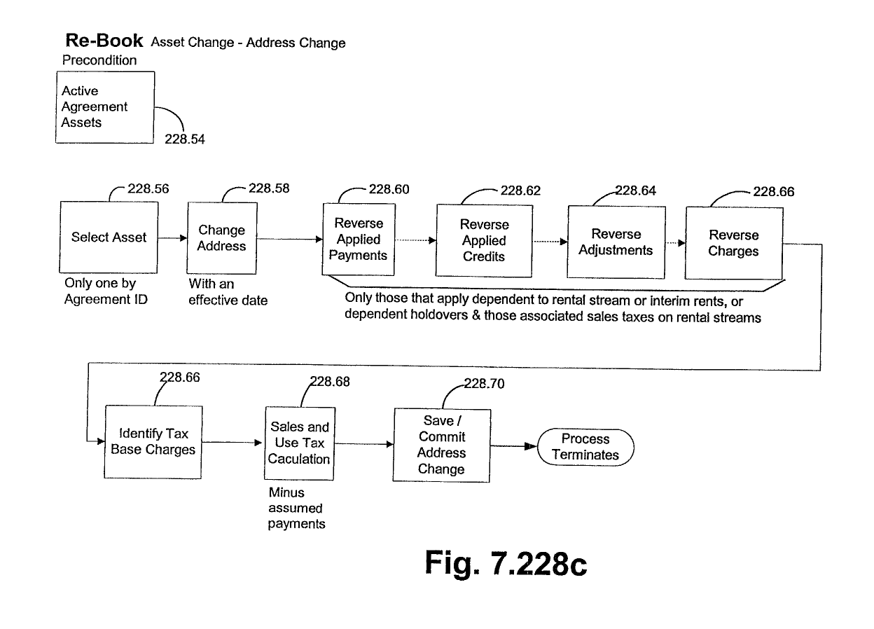

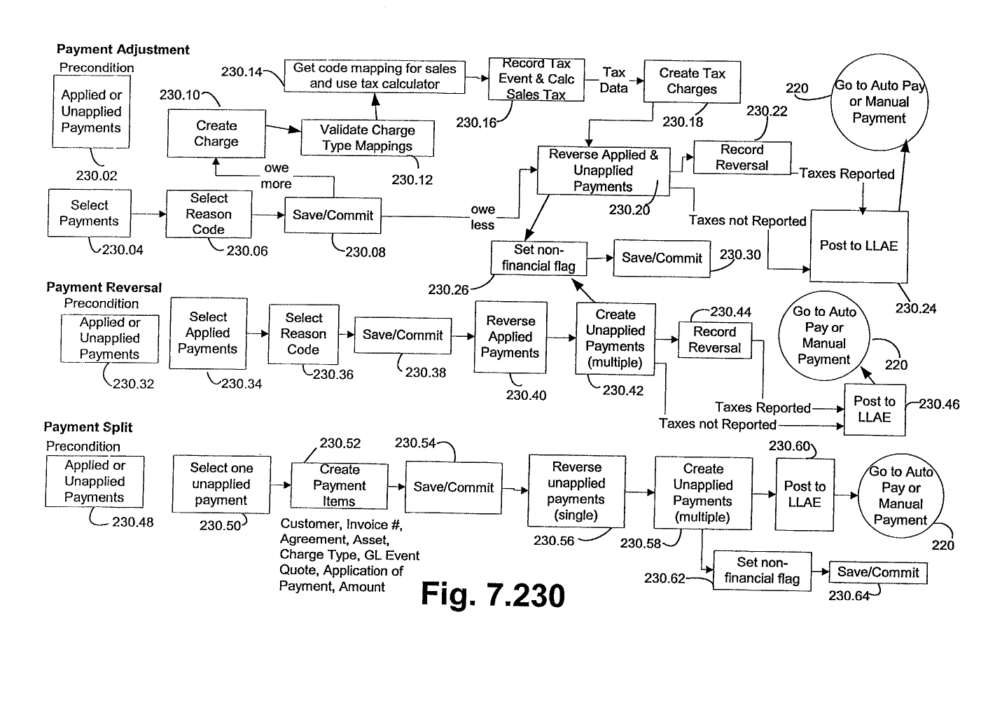

Referring now to FIG. 7, there is a high level flow chart illustrating the basic process of using the computer system 102, beginning with a setup of financial accounting 200 and ending with an end of lease subsystem 222. In the preferred embodiment of the invention, the computer system 102 utilizes a flexible graphical user interface (“GUI”) which allows the user 106 to drive the lease management process and to determine the order in which certain processing is done. The computer system 102 does not force any order of steps on the user 106. As disclosed in the Figure, the system 100 does not require a user 106 to conduct business processing in a particular order. Thus, multiple paths can lead to the same subsystem, and multiple paths can lead out of the same subsystem. The system 100 is designed so that business needs will dictate as much process flow as possible, and that the system 100 will not artificially place process constraints on a user 106. The natural flow of business processing does influence the order in which a user 106 will perform certain functions. For example, an asset 108 needs to be created before it can be attached to a lease 110 and accounting entries 101 can be added to a bookset 116 for the acquisition of the asset 108. Thus, the flow chart in FIG. 7 is illustrative of how a lease 110 could be booked using the computer system 102.

The first step in the startup process is a setup of the financial accounting rules 122 at 200. Before any assets, leases, or any other data can be inputted into the computer system 102, the accounting rules 122 governing those leases 110 and assets 108 must first be setup and customized. Accounting owners 111, tax owners, legal owners, transaction codes, “natural” accounts, remit-to's, payment algorithms, charge types, tax classes, penalty matrices, accounting events, indirect cost types (“IDC types”), A/R rules, reason codes, aging buckets, invoice/statement formulas, ledger modifiers and other items need to be defined or created using the financial accounting setup subsystem 200.

As described earlier, an accounting owner 111 is a subgroup of the lessor that has profit and loss responsibility for a particular lease 110 and its assets 108. Similarly, a tax owner is entity or subgroup of any entity responsible for paying taxes on an asset 108. A legal owner is the entity that holds legal title to an asset. In most cases, the legal owner is the lessor. Transaction codes define the type of transaction, such as an initial lease term, a buyout, an extension, a holdover, or a return. A “natural” account is an abstract category for certain types of accounts used by the system 100 as part of an index for the chart of accounts 121 as described below. Individual accounts represented by a unique account number are grouped into “natural accounts” on the basis of shared characteristics (with respect to accounting treatment) with other accounts, as discussed below. A remit-to is the party's name and address to which a lessee submits payment. The remit-to will also determine the accounting entries for cash receipt, and defines assumed or non-assumed payment behavior. A payment algorithm is the process in which a lessor allocates payments, which could be across several different accounts belonging to the same customer 117, and may include the allocation of payments that are insufficient in the aggregate of all charges for that customer 117. A charge type is a category of charges for which a lessor charges a lessee, such as rent, service fees, equipment maintenance, or other charges relating to a lease or leased asset. A charge type represents the nature and behavior of a charge. A charge type determines the nature of the resulting accounting entries that result from a charge. A penalty matrix defines penalty charges that may be assessed to the lessee resulting from early termination of a lease. Initial direct cost types (“IDC types”) are costs incurred by the lessor that are directly associated with negotiating and consummating a lease 110. Initial direct costs could include commissions, legal fees, cost of credit investigations, and the costs of preparing and processing documents for new leases.

An accounting event is triggered by a business event, including any operational or temporal events (including the mere passage of time), requiring that any accounting be performed. An accounting event is when the computer system 102 must perform accounting. An accounting event is always triggered by a business event, such as the activation of an asset, the unbooking of a billing schedule, the passage of time so that a new rent period has begun, or some other event relating to a lease transaction. A reason code is code representing the justification for an accounting change, such as the reversal of a payment application. The system 100 supports customized accounting, and thus a user 106 with accounting expertise will need to define accounting events for the computer system 102. Invoice/statement formulas are the calculations used to generate charges. An aging bucket is a group of categories used to measure the age of a receivable. Typical aging bucket categories are less than 30 days past due, 31-60 days past due, 61-90 days past due, and over 90 days past due.

Financial accounting setup subsystem 200 is also where charge types are mapped to business events and tax codes, programs are assigned to accounting owners, and other accounting relationships are established. In the preferred embodiment, all information is inputted into one or more databases 162 through the use of the software application 182 Itself. Financial accounting setup could also be done by information technology personnel by directly inputting the various rules and data directly into the database 162, or using various files to load the database 162, bypassing the software application 182. Regardless of the technical means by which information is inputted, persons with accounting expertise need to make the decisions with respect to the accounting rules 122. Financial accounting setup is described in greater detail below.

Next in the process is the creation of an item catalogue 202. The item catalogue 202 contains information relating to categories of assets 108 that can be later become associated with leases 110. Item category, item types, item models, cost categories, and other data is inputted. Book depreciation inclusion, tax depreciation inclusion, book depreciation method, and tax depreciation method are also are defined by accounting owner in the create item category subsystem 202.

An item category is a high level description for a class of assets, such as office equipment. An item type is a lower-level subset for an item category, such as a computer. A model is the lowest level category for a class of assets, such as a particular model of laptop. A cost category is a category of equipment cost used to determine taxability and eligibility for capitalization, i.e. the ability to be included in the financial amount that is being recovered via the rent billing schedule. A depreciation method is a calculation method used to determine the depreciation amount for periodic recognition. There are separate depreciation methods for book depreciation and tax depreciation. The create item catalogue subsystem 202 is described in greater detail below.

An organization processing subsystem 204 can then be used to define information about customers 117 and other entities such as vendors. Address and other contact information can be stored for all organizations 109, and a particular entity can fulfill more than one role (e.g. an organization 109 could be both a lessee and a vendor). Thus, an organization's overall financial exposure can be viewed and used for the purposes of exercising set-off rights. Billing locations and invoice defaults can be set at the customer 117 or organization 109 level. An organization 109 can also be linked to a parent organization. Guarantors and vendors are also created and stored using the organization processing subsystem 204. The organization setup process at 204 is described in greater detail below.

From organization setup 204, a user 106 may either create an asset at 206, create an agreement at 210, create a master agreement at 208, or create a billing schedule at 212. Creation of an asset at 206 allows the user 106 to add cost factors, features, and descriptor information to assets 108. A user 106 can also modify the depreciation method used for an asset 108, overriding a depreciation method set for an item category or item type. Assets 108 can also be activated, booked on the general ledger, and used to create depreciation streams. Assets 108 can be split, with each component of the initial asset then constituting a separate and distinct asset on the computer system 102. Asset splitting permits the addition of new assets 108 to an existing agreement 110, and recreates all financial attributes in accordance with the split. Information at the asset level has important financial implications, which are discussed below. The asset processing subsystem 206 is discussed in greater detail below.

From asset creation 206, the user 106 may create a master agreement 208 or create a non-master agreement (lease) at 210. A master agreement created at 208 is an umbrella agreement between a lessor and a lessee that might execute multiple different lease agreements 110. A master agreement provides the ability to set certain commonalities amongst multiple lease agreements. A/R rules, insurance information, invoicing formats, billing dates, penalty matrices, and certain end of lease characteristics may be set once for a master agreement at 208, where they can they be applied to numerous leases 110 and assets 108. The master agreement processing subsystem 208 is described in greater detail below.

A user 106 completing the master agreement creation process at 208 will subsequently either create an asset at 206 or create an agreement at 210. A lease processing subsystem at 210 allows the user 106 to create a lease 110 and attach specific created assets 108 to a specific lease 110, as well as select IDC types, set up upfront fees and deposits, set residual amounts, set proration flags, change default bill to's, change A/R rules, and other functions. More information typically exists at the level of a lease than at the level of a master agreement. Add-ons, assignments, renewals, and various validations are performed at the lease level. The lease processing subsystem at 210 is discussed in greater detail below.

From a create agreement 210 screen, a user 106 will usually go to a create billing schedule 212 screen or to book a lease at 214. A billing schedule processing subsystem at 212 can be used to set invoice comments, create variable streams, enter payments due in advance, or any other function associated with the generation or modification of a billing schedule. Interim rent billing schedules may be created in accordance with customizable interim rent rules. Post-term billing schedules may be created in accordance with customizable holdover rules. Periods to be included in up-front payments may be specified. A billing schedule with options can be suspended. A suspended billing schedule can be resumed, with an update to a bad debt reserve. The computer system 102 performs billing schedule validation at 212. Pre-booking charges can be generated for an agreement. A billing schedule can be activated at 212 before booking. Charges generated before booking can be reclassified at 212 after the lease is booked. The billing schedule processing subsystem 212 is described in greater detail below.

After the user 106 creates a billing schedule 212, that user will usually be ready to book a lease at 214. A booking subsystem 214 allows the user 106 to calculate the internal rate of return percentage (“IRR”), the IDC amortization stream, and determine book and tax classes before activating the lease and generating book entries. Although a user 106 can book an individual asset 108, a billing schedule 212, or an entire lease 110, booking is always implemented at the asset level. Accounting entries 101 are generated for the assets 108 on a billing schedule 119 and lease 110. Outside of assets 108, a billing schedule 119 or a lease 110 has nothing to book accounting entries 101 for. The booking of a billing schedule books every asset 108 attached to that billing schedule. The booking of a lease 110, books each of the assets 108 attached to that lease 110. Billing schedules are activated, in turn triggering the generation of accounting entries 101. Earning streams are created. Depreciation start dates can be set, as well as effective dates for an asset's location. The status of an asset 108 in inventory or on a lease 110 can be updated. A bad debt reserve can be established using the booking subsystem 214. In the preferred embodiment, many of these functions may be performed by interfacing with a commercially available loan calculator software product, such as SuperTRUMP sold by Ivory Consulting Corporation, headquartered in Walnut Creek, Calif. The booking subsystem 214 is described in greater detail below.

After the creation of a billing schedule 212 and the booking of a lease 214, a charge generation 216 subsystem will allow the user 106 to generate lease-related charges. Such charges are generated based on billing schedule criteria, charge type mappings are validated, sales tax is calculated, and other related functions are performed. Charges can be generated in one of four ways. A charge can be generated automatically through the daily process, a charge can be imported from an external file, a user 106 can create a charge through invocation of a batch process, or a user 106 can create an individual charge using the computer system 102. The charge generation 216 subsystem is described in greater detail below.

After charges are generated by the charge generation subsystem 216, an invoicing subsystem 218 allows the user 106 to invoice lessees on the basis of invoice criteria, to update charges, format invoices, and then to issue invoices. Line item detail is customizable at the customer, agreement, billing schedule, or asset level. Invoices can also be formatted by the invoicing subsystem 218. If the customer has more than one lease with the lessor, invoicing can be done on either a consolidated or unconsolidated basis. Invoicing can be stopped and started. Invoices can be generated automatically as part of the daily process, or by a user initiated batch process. In the preferred embodiment of the invention, the system 100 may interface with a third-party form generating software such as JetForm Design version 5.2.8.312 from JetForm Corporation, located in Ottawa, Ontario in Canada, for the purpose of formatting invoice forms. The invoice processing subsystem at 218 is described in greater detail below.

After an invoice is generated at 218, the user 106 will usually go to a payment application subsystem 220, although the user 106 could also invoke the charge reversal, adjustment or credit subsystem 224. A payment application subsystem 220 allows the user 106 to apply a payment, determine which charges have been paid or not paid, post cash, validate tax and charge mappings, or other functions relating to a lessee's payment. Payment application can be performed automatically by the computer system 102 or manually by a user 106. The subsystem 220 also triggers the appropriate accounting entries 101 to be made in the appropriate booksets 116. The payment application subsystem 220 is described in greater detail below.

After invocation of the payment application subsystem 220, a user 106 could use a payment adjustment and reversal subsystem 230, or if no such adjustments are required, ultimately the user will need to use an end of lease subsystem 222. The end of lease subsystem 222 allows the user 106 to process a return of assets 108 to inventory by way of a repository or to facilitate the release or disposal of the previously leased assets. A user 106 may also renew a lease 110 by invoking the end of lease subsystem 222, which would invoke the lease processing system 210 to generate a new lease 110 in the system, while maintaining prior history, depreciation, and other useful accounting information. In a termination situation, all aspects of the residual value of the assets are available for subsequent processing. Standard quotes and non-standard complex quotes with options for asset disposition can be processed. All termination scenarios are accounted for included lease termination, early lease termination, termination with a bad debt write-off, and termination of a suspended lease. Termination can occur at a billing schedule level or at the lease level. The end of lease subsystem 220 calculates financial information, including balances, costs, and gain/loss amounts for book and tax calculations. Termination reason codes are customizable by the user 106. The end of lease subsystem 222 is described in greater detail below.

A charge reversal, adjustment, or credit subsystem 224 allows a user to modify charges generated at 216, even if such modifications are being done retroactively. Individual charges can be modified, or all of the charges relating to an asset 108 or even to a lease 110 can be affected with the same amount of data entry work by the user 106. Only non-financed charges can be reversed, otherwise the unbook subsystem 226 must be invoked first. A reason code is associated with each modification to a charge. The charge reversal, adjustment, or credit subsystem 224 is described in greater detail below.

A payment adjustment and reversal subsystem 230 performs analogously to the charge reversal, adjustment, or credit subsystem at 224, except that payments are being modified instead of charges. A reason code is associated with each modification of a payment. Payments can be reapplied manually or automatically. There are tax and accounting implications to any change that must be tracked by the accounting system 100 in the appropriate manner. The application of payments are always mapped and validated against charges. If a user 106 needs to adjust or reverse charges at 224 or to adjust or reverse payments at 230, then the user 106 may also need to unbook 226 and then rebook 228 the assets 108 and charges 122 relating to the lease 110.

Any active agreement with an active asset billing schedule can be unbooked at 226. Even an asset 108 that is not associated with a lease 110 can be booked, and thus can be unbooked at 226. Although a user 106 may refer to booking a lease or booking a billing schedule, the computer system 102 books transactions at the asset level. Thus, when a lease 110 is booked, the computer system books every asset 108 attached to that lease 110. The unbooking of a asset 108, billing schedule 119, or lease agreement 110 is a way to “undo” accounting processing that is no longer correct. If no earnings or other accounting transactions have been posted to the assets 108 before unbooking, unbooking is a relatively simple process. If A/R earnings do exist, applied payments need to be reversed, applied credits need to be reversed, any adjustments need to be reversed, and all charges will be reversed. The unbooking subsystem 226 is described in greater detail below.

A rebooking subsystem 228 is then used to rebook a lease 110 and its assets 108 after the desired changes are made to the assets 108 or lease 110. Only an unbooked lease can be rebooked. Rebooking involves the same type of validations, such as for internal rate of return, that booking a lease involves. Rebooking a lease generally involves a user 106 making changes to asset 108 attributes, such as residual value, initial direct costs, commencement date, depreciation method, or interim rent, a charge for the use of equipment from either its inservice date or delivery date on which the base term of a lease 110 commences. Holdover and term rental payments will also require the entry of accounting entries, as will the reapplication of charges and payments. The rebooking subsystem 228 is described in greater detail below.

B. Financial Accounting Setup

Referring to the Financial Accounting Setup Subsystem 200 in FIG. 7.200. The financial accounting setup subsystem 200 is triggered by the implementation of the lease transaction management and accounting system 100. The financial accounting setup subsystem is also triggered by such events as the existence of a new business channel, a new division, new types of assets and or businesses in a portfolio, or any other change or expansion in business practices such that new accounting rules 122 need to be setup. Some of the process steps disclosed in the Figure are optional, while others are one-time only steps performed during the implementation process for the system 100. Many of steps in the financial accounting setup subsystem 200 need not follow a particular order. The user 106 is free in many ways to enter data in accordance with the user's 106 particular preferences. This flexibility is limited only by the logical relationships between various types for data. For example, since indirect cost types can be used to create accounting events, the creation of IDC types at 200.10 must be performed before the creation of accounting event definitions at 200.36. However, IDC types could be created at any time before the creation of accounting event definitions at 200.36. Thus, the Figure discloses processing boxes which are not exclusive to other processes, and the Figure does not necessarily disclose the exact order of processing pursued by the user 106.

In terms of process flow, an arrow leading to a particular step in the process indicates that the previous step is a precondition for that particular step. A process step can have more than one precondition. For example, the creation of a defined accounting event at 200.36 requires that IDC types first be created at 200.10, that accounting engine field mapping occur at 200.14, and that a financial product is created at 200.12. Similarly, a process step can also constitute the precondition for more than one other process step. For example, a financial product at 200.12 is a precondition for defining a tax class at 200.24, defining an accounting class at 200.28, or creating an accounting event definition at 200.36.

A tax owner is created at 200.02. A tax owner is the entity responsible for any resulting tax payments. A tax owner is needed to perform tax processing and is related to both a legal owner at 200.04 and an accounting owner 111 created at 200.06. A creation of a tax owner at 200.02 is a precondition for the creation of an accounting owner 111 at 200.06.

A legal owner is created at 200.04. A legal owner is the entity that owns the assets 106. In many cases, the legal owner 200.04 and the tax owner 200.02 will be the same entity or subgroup of an entity. A legal owner at 200.04 is a precondition for the creation of an accounting owner at 200.06.

Accounting owners 111 are created at 200.06. An accounting owner 111 is any subgroup of the lessor that needs to have their own distinct accounting books. Thus, an accounting owner 111 can be a department, a division, an office distinction based on geography, a joint venture, a subsidiary or any other user 106 defined subgroup of the lessor. No more than one legal owner and one tax owner can be represented by accounting owner 111. The reason for creating accounting owners 111 at 200.06 is so that bookset 116 can be defined and created at 200.08.

A bookset 116 is defined at 200.08. A bookset 116 can have only one accounting owner 111, but an accounting owner 111 can have multiple booksets 116. The flexible relationship between accounting owners 111 and booksets 116 allows the system 100 to trigger accounting entries 101 in multiple booksets 116 if necessary.

Financial products are created at 200.12. As defined above, a financial product could be an operating lease, a finance lease, or any other type of financial transaction. Financial products can be defined with sufficient specificity to include options, buyouts, and other types of transaction distinctions. Different financial products receive different accounting treatment, so a user 106 with accounting expertise is needed to help define the necessary financial products. Further complicating matters, different jurisdictions apply their own accounting rules to assets 106 with the jurisdiction. Thus, different jurisdictions may apply different accounting rules to the same financial product. In fact, different jurisdictions may even classify the same lease transaction in a different manner. For example, under U.S. Generally Accepted Accounting Principles (“GAAP”), a particular lease could be classified as a direct finance lease, but that same lease could be classified as an operating lease under French GAAP rules. The system 100 can incorporate the sophistication to make such distinctions as described in greater detail below. Financial products 200.12 are important and useful because they can require particular tax treatment and particular accounting treatment. The creation of financial products at 200.12 is a precondition for defining tax classes at 200.24, accounting classes at 200.28 and accounting event definitions at 20.36.

Tax classes are defined at 200.24. A tax classification is the means by which the system 100 groups similar types of tax charges. For example, purchase tax, up front tax, sales tax, and use tax all constitute different tax classes. The entry of different tax classes allows the system to distinguish between the various taxation categories when accounting work is performed. In the preferred embodiment of the invention, the system 100 may interface with a commercially available sales and use tax calculator application, such as provided by Taxware International, Inc., headquartered in Salem, Mass. If a third party software product is used, tax classes are defined in a way that is consistent with the tax classed used by the third-party product.

Accounting classes are defined at 200.28. An accounting class is the means by which the system 100 groups similar types of accounting transactions and treatment. Accounting classes relate to financial products, as financial product distinctions generally result in accounting class distinctions. An accounting class can have multiple financial products, but a financial product is associated with only one accounting class. Distinct accounting classes are used by the system 100 to distinguish the required accounting rules 122 to be applied.

Initial direct cost (“IDC”) types are created at 200.10. The creation of IDC types at 200.10 is one of the preconditions for the creation of accounting event definitions at 200.36. IDCs are costs incurred by the lessor that are directly associated with negotiating and consummating a lease. Initial direct costs include commission, legal fees, costs of credit investigations, and the costs of preparing and processing documents for new leases 110.

Lease loan accounting engine (“LLAE” or simply “accounting engine”) field mapping is performed at 200.14. The accounting engine is described in greater detail below. The accounting engine is encapsulated and distinct from operational processing performed on the computer system 102. The system implements an event-driven accounting system, where a business event requiring that accounting be performed, triggers an accounting engine to generate an accounting entry 101 in the appropriate bookset 116. Variables that could be used in the mapping process include salvage value, inventory value, amount, status (such as active or inactive), types of transactions, or any other user defined characteristic relating to accounting treatment. The mapping referred to at 200.14 prepares the linkage between accounting processing and an accounting event as defined at 200.36.

All of the previous data discussed relating to the financial accounting setup subsystem 200 must be defined in order to create an accounting event at 200.36. By using business events, which include all types of operational and temporal events, to trigger accounting functionality, accounting expertise need only apply during the financial accounting setup at 200. A subset of business events translate to accounting events. Those accounting events result in the generation of accounting entries 101 into booksets 116 by the accounting engine. The transparency of the accounting engine, and the desirability of that transparency, is discussed in greater detail below. During subsequent processing, users 106 need only understand how the system 100 operates, without any special accounting knowledge. The process of creating accounting event definitions at 200.36 is a precondition for creating bill by's at 200.16, creating remit to's at 200.38, and mapping charge types to accounting events at 200.30.

After accounting events are defined at 200.36, bill-by's can be created at 200.16 and a remit-to can be created at 200.38. A remit-to is the contact person and address where payments by the lessee are to be received by the lessor. A list of alternatives can be entered into the system 100, and a user 106 would then be able to utilize that list and select a particular remit-to for a particular lease 110. A specific remit-to is generally set forth in the lease 110. A bill-by is the subgroup or sub-entity that executes the lease agreement as lessor, and under which the lease 110 is billed and invoiced. Bill by's must be created at 200.16 and remit to's must be created at 200.38 before a default remit-to and bill-by can be set for each accounting owner at 200.18. These defaults can later be overridden for specific customers, leases, or assets.

The process of assigning default remit to's and bill by's at 200.18 begins a repeatable loop with the processes of creating programs at 200.20, creating ledger modifiers for those programs at 200.22, and assigning accounting owners 111 to those programs at 200.40. Each accounting owner 111 has one default remit to and one default bill by. Those defaults are set at 200.18.

Programs are created at 200.20. A program is associated with the lessor, and represents an initiative, division, subsidiary, joint venture, or other subgroup of the lessor. A single program can have many potential financial products associated with it, but each financial product belongs to a single program. Many default values can be set at the program level, including the financial product, accounting owner 111, IDC rules, post termination rules, and interim rent rules. A program can have more than one accounting owner 111, but each accounting owner 111 belongs to only one program. The relationship between accounting owners 111 and programs requires that an accounting owner 111 created at 200.06 be selected at 200.40 for association with a particular program.

Ledger modifiers are created at 200.22 on a program by program basis. Ledger modifiers are defined at 200.22, to be applied by the accounting engine. Ledger modifiers constitute the basic toolkit of all potential accounting entries 101.

Programs are assigned accounting owners 111 at 200.40 The system supports multiple accounting owners 111 and multiple programs, and in fact, a single accounting owner 111 can itself have many programs. Thus, the loop from 200.18 to 200.20 to 200.40 will need to be repeated for each accounting owner 111 and each program.

Financial products 113 are assigned to accounting owners and programs at 200.52. The relationships between financial product 113, program, and accounting owner 111 can be used to set up a hierarchy of default operation rules for using the system 100. A financial product 113 level default can be set at 200.54 for remit to and bill by information at 200.54. These defaults trump a program or accounting level default, but values selected for a particular lease would trump the defaults selected at 200.54.

A different branch of the financial accounting setup subsystem begins at 200.42 where a charge type category can be defined. A charge type category is a category of charges for which a lessor charges a lessee, such as rent, service fees, equipment maintenance, or any other charge relating to a lease or leased asset 108. A charge type category represents the nature and behavior of a charge. A charge type category determines the nature of the resulting accounting entries that result from a charge. Each charge type category is associated with one or more charge types. Charge type categories and their charge types are used to create payment algorithms 200.26, charge types at 200.46, and to setup a penalty matrix at 200.44.

Payment algorithms are setup at 200.26. A payment algorithm determines how payments are applied. Charge types can be used by the payment algorithms in determining how particular payments are to be applied to particular charges. The payment algorithm is particularly important when the value of the payments are less then the value of the charges. A payment algorithm incorporates accounting consideration by incorporating the charge type. Payment algorithms also distinguish between different programs, as created at 200.20.

A charge type as created at 200.46 is more specific than a charge type category created 200.42. Each charge type is affiliated with exactly one charge type category, but a charge type category can possess multiple charge types. Charge types 200.46 are used to map charge types to accounting events at 200.30, setup reason codes at 200.64, setup A/R rules at 200.58, setup penalty rules at 200.62, interim and post termination rules at 200.46, and a penalty matrix at 200.44.

Charge types are mapped to accounting event definitions at 200.30. This allows the system's 100 accounting engine to be automatically triggered by business events, even though the user 106 inputting the operational event or data, has no accounting expertise. Accounting event distinguish between different charge types. The mapping of charge types is a precondition for setting up potential tax jurisdictions at 200.32.

Tax jurisdictions are setup at 200.32. This is where the various sales and use tax rules are stored in the system 100. In the preferred embodiment of the invention, a commercially available sales and use tax calculator application as discussed above is used to provide this functionality.

Charge types are mapped at 200.34 to product codes used by the sales and use tax calculator used to perform sales and use tax calculations. In the preferred embodiment, the sales and use tax calculator used to perform tax calculations may be an interfacing third party product, which will require the mapping of product codes at 200.34 to enable use of the product. If a third party product is not used, the system 100 will still require some form data relationship to connect tax treatment for a particular asset to other asset attributes and related accounting information. That linkage is setup at 200.34.

Interim operational rules and post termination operational rules are setup at 200.48, using the charge types created at 200.46. Interim rules relate to any interim rent collected by the lessor. Interim rent are lease payments received by the lessor before the lease agreement is formally executed. Conversely, post termination rules apply to the time period after which a lease terminates, but before assets are either returned, or otherwise dealt with by the lessee.

Reason codes are setup at 200.64. Reason codes help link operational events to the accounting treatment they receive. Reasons can be associated with charges, payments, and various decisions that a user 106 can implement using the system 100.

A/R rules are setup at 200.58. A/R rules define how charges are incurred and payments are applied. A/R rules determine whether accounting is to be performed on an accrual basis, where an corresponding earning is generated with each charge, or on a cash basis, where a accounting entry 101 for a charge is not generated until a payment is actually received. A/R rules are defined in a matrix format, by accounting owner 111 and charge type.

Penalty rules are setup at 200.62. Penalties determine the impact of certain lessee actions, such as early termination of a lease. Penalty rules are defined by accounting owner 111, and can distinguish between reasons for the improper conduct on the basis of reason code, the extent of the improper conduct, such as being one day late or over 30 days late, and whether a particular penalty-inducing behavior is a first-time event, or a repeating occurrence. The matrix of penalties is setup at 200.44.

There are some free-floating boxes on FIG. 7.200 which represent setup processing that should be performed before a user 106 moves on to the item catalog subsystem at 202. Default Invoice formats can be setup at 200.50. Although the system 100 supports the dynamic creation and customization of invoice formats, it is still desirable in the preferred embodiment of the invention to maintain a library of standard default invoice formats.

Suspension setup occurs at 200.56. Due to the failure of a lessee to make lease payments, a lessor will want the ability to suspend certain transactions. Such suspensions will require accounting entries to be made, and those rules are set at 200.56.

Aging buckets are setup at 200.60. Aging buckets are the time frames in which collections are measured, e.g. under 30 days, between 31 and 60 days, between 61 and 90 days, and over 90 days.

C. Create Item Catalog (Part of Equipment Catalog)

FIG. 7.202 discloses the item catalog creator subsystem at 202. Item categories are created at 202.02. An item category is the highest level at which an asset 108 can be categorized, such as office equipment, or industrial machinery. In one embodiment of the invention, the United Nations Standard Product and Service Classifications (“UNSPSC”) are incorporated as item categories.

A descriptor for an item category is created at 202.04. A descriptor is a short narrative description of an item category. A descriptor is a precondition for the creation of item types at 202.08.

Cost categories are created at 202.06, and they represent a category of equipment cost such as rent, used to determine taxability and eligibility for capitalization. Item categories, item category descriptors, and cost categories are preconditions for the creation of item types at 202.08.

Item types are created at 202.08, with each item type relating to exactly one item category created at 202.02. Item categories are more specific to the type of asset than an item category. Computer equipment could constitute an item type, with office equipment constituting the item category. The creation of an item type at 202.08 also incorporates cost category information created at 202.06 and a descriptor created at 202.04.

A model is created at 200.16, which is the most specific classification for a type of equipment. A model is almost as specific as an asset 108, only without a serial number or any other characteristic to distinguish it from assets 108 of the same model. Each model is associated to one item type, although a single item type can possess multiple models.

The creation of an account owner 111 occurs during the financial accounting setup process at 200.06. The determination of whether a particular cost category can be included for book depreciation purposes is made at 202.10.

Book depreciators and accounting owners 111 can be setup to only use and recognize certain cost categories. This selection process occurs at 202.10. The determination at 202.10 is made by account owner 111, so different account owners 111 can give different accounting treatment to the same cost category. The system 100 supports flexibility in depreciation selection, but combinations of operators put parameters around that flexibility.

A cost category is an example of an operator. An operator is any data such as cost categories, reason codes, depreciators, charge types, and any other type of data which can be attributed to an object in the system which then allows the system 100 to distinguish between the objects on the basis such an operator. An object is any element, item, or aspect in the system 100 which is capable of having attributes. Assets, leases, billing schedules, master agreements, customers, and programs, are each examples of objects. An object is represented by one or more objects 126 in the system. The process at 202.10 is an example of how accounting rules 121 can be based on a combination of different operators. An accounting owner 111 can determine which cost categories apply to it. Certain cost categories are allowed, while other are not. Similarly, an item type can limit the types of cost categories that are applied to it. The selection of which cost categories can apply to a particular book depreciator is limited by the combination of limitations arising from the accounting owner 111 and the item type. The system 100 is highly flexible, and supports numerous combinations of such operators.

Similarly, the determination of whether a particular cost category can be included for tax depreciation purposes is made at 202.14, and this determination is also done on an account owner 111 basis. Different accounting owners 111 can depreciate the same cost category differently. Different accounting owners 111 can also make the same decision with respect to whether a cost category can be depreciated. Item types similarly limit the pool of cost categories that can be associated with a tax depreciator.

The determination of what can be depreciated is then followed by the method of depreciation. Book depreciation methods are set at 202.18, and these methods are defined per accounting owner 111. The determination of book depreciation method is also dependent on the item type as created at 202.08. Similarly, tax depreciation methods are defined at 202.20, on an account owner basis. The determination of tax depreciation method is also dependent on the item type as created at 202.08. Accounting owners 111 may share the same depreciation method, but a specific depreciation is selected per accounting owner 111, item type, and cost category.

Tax and book methods are stored at 202.22 and tax and book basis for cost and salvage values are stored at 202.24. In the preferred embodiment, the data stored at 202.22 and 202.24 are usable by a lease loan calculator, such as the SuperTRUMP product produced by Ivory Consulting Corporation, headquartered in Walnut Creek, Calif. The process at 202.22 is referred to in the art as a modified accounting cost recovery system.

D. Organization Setup

FIG. 7.204 discloses use of an organization processing subsystem to create an organization 109 at 204. The organization setup process provides the user 106 with a mechanism for distinguishing between the different entities outside the lessor and the roles that those entities play. An organization 109 can be a customer 117, a vendor, a guarantor, a maintenance service organization, or any other entity involved in the leasing business. A customer 109 that is also a vendor may trigger certain set-off determinations that would not be triggered by a customer. The system 100 will support the ability of an organization to possess more than one type of role. The system 100 allows different organizations and different roles to be treated differently. The organization processing subsystem 204 can also be used to assign a lease 110 from one customer 109 to another customer 109, invoking the lease processing subsystem 210 to create a new lease 110 for a new customer 109 while preserving the history of the leased assets 108. The organization processing subsystem 210 includes one or more organization objects and one or more organization database tables, and all of the attributes of an organization 109, such a role, an address, the existence of master agreement, or any other information relating to an organization rather than some other level of information, such as asset or lease level information. The organization processing system 204 is invoked by a user 106 or another subsystem any time an attribute of an organization is created, modified or deleted. The organization processing subsystem 204 allows the system to make distinctions based on an organization 109. This maximizes the flexibility of the system 100.

For example, larger organizations 109 may expect more favorable terms than smaller organization 109. An economically more significant customer 117 may insist on dictating invoice formats and other unique idiosyncrasies. A larger and more significant customer 117 may also merit different A/R treatment in the areas of collections, manual credits, and receivables aging. Different organizations may require different treatment with respect to booksets 116, a master agreement, lease schedules 110, contact information, and other functions and characteristics.

Organizations 109 are created at 204.02. An organization 109 can be classified as a customer 117 at 204.04 or in other roles at 204.06. An organization 109 can be both a customer 117, while at the same time being a vendor, or other non-customer entity.

A multi-role organization can have one global address at the address maintenance screen at 204.08. The creation of a bill-to at 204.10 is only required for customer organizations since customers must have an address to receive invoices and other communications. A bill-to, at 204.10 can also be setup for vendors and other non-customer organizations, but it is optional for those roles. Separate contact information can be set at 204.14 and separate address information can be maintained at 204.12. Contact information includes physical and electronic addresses.

Many operational rules may be defined as organization attributes. A/R policies such as aging buckets, collection practices, the issuance of manual credits, and other characteristics can be set at the organization level.

E. Create Agreement (Lease Schedule)

FIG. 7.210 discloses a flow chart of the lease processing subsystem at 210. In order for an agreement to be created at 210, a customer with whom the agreement is to be made, must be created at 204. If a master agreement at 208 has not been created for that customer, then the appropriate program and product must be defined at 200 before a lease agreement can be created at 210. If a master agreement does exist, then organizational setup is not required because that master agreement will already be associated with a customer 119. A lease agreement 110 can be created at 210 even though no assets 108 have been created at 206. Of course, such a lease 110 cannot be activated without any assets 108.

The process begins at 210.02 with a selection of the customer 119 for whom a lease agreement 110 is desired. Subsequent to the selection of a customer 119, a program is selected at 210.04. The selected program will have a list of products associated with the program, and a user 106 may select from such a list of products at 210.06. Programs and products are defined and created in the financial accounting setup subsystem 200.

An accounting owner 111 is selected at 210.08. The accounting owner 111 represents the organization within the lessor that will have profit and loss responsibility for the lease agreement 110 that is created. Associating an account owner 111 to the lease 110 will allow the computer system 102 to automatically generate accounting 101 entries in the appropriate bookset(s) 116. If the user 106 desires to use default characteristics from a master agreement, the appropriate master agreement can be selected at 210.10. Assets 108 can be selected and added to the lease at 210.12. If assets need to be created on the system 100, the user 106 can invoke the creation of assets 108 by engaging the asset processing subsystem at 206.

For added or selected assets 108, remit-to's and bill-by's may be selected at 210.26. Default values for remit-to and bill-by information set at the program or accounting owner level, can be overridden for a particular lease at 210.26. Remit-to's and bill-by's identify the address to which payments are to be sent and the lessor's organization.

The default bill to for a customer 119 can similarly be overridden for a particular lease 110 at 210.28. A/R rules and other operational rules for the created assets can be selected and changed at 210.30 before a billing schedule is created at 212.

A parallel stream of processes relating to accounting information must be completed before a billing schedule 119 can be created at 212. First, the initial direct cost types (“IDC”) must be selected at 210.14 and attributed to the lease 110. The corresponding IDC amounts for the IDC types can be added to the lease 110 at 210.16. Up front fees and security deposits can be attributed to a lease 110 at 210.18. For financial leases, residual amounts can be attributed to a lease at 210.20.

The user 106 can set the proration flag at 210.22. If the proration flag is set, a billing schedule will be created for each individual asset. This creates a “ground up” view of the lease, with a lease 110 substantially constituting a merely a collection of assets 108, with each asset possessing its own billing schedule. Otherwise, the default outcome is a non-prorated billing schedule, which consolidates all assets 108 associated with the lease 110 into a single billing schedule 119.

The last precondition for activating a lease 110 and generating the appropriate billing schedules at 212 is the entry of control totals at 210.24. The control totals process looks at the lease in the aggregate, consolidating all of the individual asset level billing schedules into one single billing schedule for the entire lease 110. Validation is performed on the resulting billing schedules. Such validations can include confirming an internal rate of return that is required by the accounting owner 111, program, or lessor. Other common validation variables are known in the art. The system 100 can perform such validations automatically. The system 100 can also be set to either issue a warning if the proposed lease fails the validation, or the system can actually prevent the user 106 from activating the lease 110. Any type of automatic validation can also be turned off, as desired. With validations complete, billing schedules can then be created at 212. A lease 110 cannot be activated unless every asset 108 associated with that lease 110 is associated with at least one billing schedule 119.

The lease processing subsystem at 210 includes a lease 110 and all lease attributes. One function provided by the lease processing system 210 is the ability to assign an existing lease 110 to a new customer 117. This process creates a new lease 110 while maintaining book and tax depreciation information maintained at the asset level.

Many of the functions that may appear to the user 106 to be performed at the lease-level are not actually lease attributes. Rather, the lease processing subsystem 210 often invokes other subsystems, such as the asset processing subsystem 206 or the billing schedule subsystem at 212. For example, the activation of lease has meaning only in the sense that billing schedules 119 have been activated, and charges can be generated. Similarly, leasing screens can be used to invoke the asset processing subsystem 206 to make changes to assets 108 associated with a lease 110, but such activity does not turn an asset attribute into a lease attribute. Lease-level information exists with respect to information, invoicing defaults, asset defaults, assets associated with the lease, billing, contacts, activation, and end of lease processing. One key lease attribute is the association of assets to the lease. Such an association does not transform asset attributes into lease attributes, although the lease processing subsystem 210 may invoke to the asset processing subsystem 206 to make parallel changes across each and every asset 108 associated with a lease. In instances where a non-lease attribute is to be manipulated or processed, the lease processing system 210 invokes the appropriate subsystem. In many ways, a lease 110 may be thought of merely as a collection of assets 108 and billing schedules 119, although the system supports aggregating data across a lease 110 for the ease of use by a user 106. The distinctions between asset attributes, lease attributes, and other types of attributes are described in greater detail below.

F. Create Asset

Referring now to FIG. 7.206 which describes how the asset processing subsystem 206 creates an asset 108. Before assets can be created, the appropriate item categories, item types, and models must be created at 202. A vendor organization must also have been created at 204 because each asset 108 must have a vendor or manufacturer associated with it. An asset 108 can exist without a customer 117 or even a lease 110. Such an asset 108 can even be activated and in inventory, generating accounting entries 101 relating to book and tax deprecation.

The asset processing system can either be invoked directly by a user 106 or by another subsystem. Any time an asset or an asset attribute is being created, modified, or deleted, the asset processing system 206 is invoked to perform all processing. As the system 100 is designed to attribute data to its lowest logical data, much of the relevant operational and accounting information in the system 100 are based on data associated with an asset attributes. The calculation of sales tax is based on asset attributes, such as the address of the asset. Book and tax depreciation is performed at the asset-level, and constitute asset attributes include such variables as depreciation life, depreciation method, residual value, and other key concepts. The nature of asset attributes, and their relationships with other types of attributes and subsystems, is described in greater detail below.

The first invocation of the asset processing system 206 is to actually create assets. At the beginning of the asset creation process, a user 106 must select a program at 206.02. As discussed above, the program represents a marketing initiative, division, department, or other affiliation or some other subset of the lessor. Next a catalog item is selected at 206.04. A catalogue item determines the general category of the equipment, such as a desktop computer. A catalog item is associated with default cost factors and descriptors at 202. However, those defaults cost factors and descriptors can be added at 206.06 and 206.08.

An organization is selected at 206.10 or can be created by engaging the organization processing subsystem at 204. As disclosed above, each asset needs to be attributed to a vendor which is a type of organization. Similarly, an organization address can either be selected at 206.12 or added at 206.14.

A user 106 can determine how an asset is to be depreciated by modifying the tax and book depreciation method at 206.16. The possible selections are limited by cost factor and by accounting owner 111. Default book and tax depreciators are associated with a particular item type at 202, but can be overridden here.

The create asset process at 206.18 anticipates that certain assets 108 can be upgraded during the course of their existence, and thus asset features can be added. A classic example of such an upgrade is the replacement of a computer's CPU with a faster more powerful CPU. An upgrade may affect the depreciation of the asset, and may ultimately result in other accounting entries 101. An upgraded asset obtains new attributes at 206.18, but prior asset history is still maintained. As asset's history, which includes historical information relating to many on asset's attributes, is itself an asset attribute.

A user 106 can activate an asset at 206.20, reflecting that the asset 108 is available in inventory to be attached to a lease 110, even though no such relationship with a lease 110 yet exists. The activation of an asset 108 triggers the accounting engine to generate accounting entries 101 in the accounting owner's 111 booksets 116 reflecting the tax and book depreciation of the asset 108. An asset 108 can also be activated by being attached to a lease 110 that is activated, because such an activation invokes the asset processing system 206 to change the status of each asset to active. The status of an asset 108 as active or inactive is an asset attribute, and thus can only be modified by the asset processing system 206.

Although a customer is not required to activate an asset at 206.20, cost factors and an accounting owner 111 are required. Cost factors and the accounting owner 111 determine the accounting rules 122 for an asset 108, and thus it is not possible to activate an asset 108 without a relationship to a cost factor and to an accounting owner 111.

Depreciation streams are generated by the loan lease calculator at 206.22. In order for an asset 108 to be depreciated, it needs to have a start date and it needs to have a depreciation life. While these attributes can be set at 202, they can be overridden at 206.24. In the preferred embodiment, the loan lease calculator is a commercially available software product, such as SuperTRUMP as described above. The system 100 is designed to easily interface with such outside systems, although the same functionality can be generated with the system 100 itself in other embodiments. The system 100 can include a loan lease calculator.

Entries are then exported at 206.22 to the accounting engine (LLAE or lease loan accounting engine). General ledger entries are made pursuant to the accounting rules 122 that relate to the accounting owner and the cost factors. The nature of assets, and the ability to manipulate data at the level of individual assets is disclosed in greater detail below.

G. Create Master Agreement

FIG. 7.208 describes in greater detail, the process by which master agreements are created by the master agreement processing subsystem at 208. A user 106 is never required to create a master agreement. Master agreements do however, provide a convenient way to manage multiple lease agreements 110 that exist between the same two parties. The ability to set a default characteristic or rule only once, or the ability to change a characteristic or rule across all lease agreement through one simple data entry change, is a powerful potential tool for users 106 and lessors. Operational or business rules, including those that relate to invoicing and A/R policies, can be set at various levels in the system 100, including at the master agreement level.

The only prerequisite for creating a master agreement at 208 is that an organization at 204 must exist so that it can be a party to the master agreement at 208. A customer organization is selected at 208.02. Then a legal owner must be selected at 208.04. Insurance policy information is then either selected or created at 208.06. The system 100 supports the ability of a user 106 to track multiple insurance limits, the capturing of basic policy information, the tracking of expiration dates, and the addition of new policies. If master agreement at 208 requires certain insurance coverage for all of the assets 108 under a master agreement, that insurance information can updated in one place, and in conjunction with the master agreement. Similarly, default A/R rules can be selected for each of the lease agreements 110 associated with an individual master agreement. A/R rules relating to penalties, charge generation, payment application, and other functions relating to the accounts receivable process as known in the prior art are described both above and below.

A/R rules associated with a master agreement at 208 trump the default A/R rules associated with a program at 200.20. Only one master agreement created at 208 can exist per customer organization. Multiple individual lease agreements can be associated with a single master agreement. Invoicing formats and billing dates can be set at the master agreement level. The ability to set various operational and business rules at various levels in the data hierarchy, such as the asset, billing schedule, lease, master agreement, customer, or program level is described in greater detail below.

H. Create Billing Schedules

FIG. 7.212 describes the creation of billing schedule 119 using the billing schedule processing subsystem at 212. The creation of a billing schedule 119 requires that an organization 204 exists for that billing schedule 119, and that an agreement 210 exists for that billing schedule 119. A lease agreement 110 is necessary for the creation of a billing schedule 119. but each asset 108 on the lease 110 can have its own individualized billing schedule 119. If a user 106 has not yet created the appropriate organization 109 or lease schedule 110 for the billing schedule 119 to be associated with, the create billing schedule process at 212.02 will prompt the user 106 accordingly so that all required information is generated at 212.02. If advance payments are part of the lease agreement 110, such as the requirement that the last month's rent is paid in advance, the advance periods are entered at 212.04. If a particular billing schedule 119 requires the certain comments be displayed on an invoice, the relevant information can be entered by the user 106 at 212.06

Billing schedules 119 are subject to defaults set at the lease 110, master agreement 208, organization 109, and program levels. However, those defaults can be overridden at the billing schedule level. A user 106 can override those defaults at 212.08. Interim rules, post term payments, bill to's, remit to's, charge types, payment types, and invoice formulas can be overridden at 212.08.

Variable payment streams 212.10 can be generated by the user 106 The default streams can be changed at 212.12. A user 106 at 212.12 can perform lease level proration, or partial proration, removing assets 108 from the lease-level billing schedule and associating a particular asset with its own billing schedule 119. Remit to's, bill to's, and invoice formats cannot be overridden at 212.12, such overrides are made at 218 as discussed below. Rolled=up billing schedules 119 can be generated at 212.14 for invoicing and other purposes. A rolled-up billing schedule 119 is a consolidated view of asset level billing schedules into one lease level billing schedule, even though full lease level proration has occurred and each asset possesses its own billing schedule.

Billing schedule attributes include a relationship to a lease 110, a relationship to a customer 117, a charge type, a charge type description, the various payments and due dates described in a particular schedule, and any other data, information, or attribute relating to a billing schedule 212. Billing schedule processing provides the ability to set various dates, to generate schedules, to perform financial calculations relating to the billing schedule 119.

I. Booking

FIG. 7.214 describes the booking process 214 in greater detail. The existence of at least one billing schedule 212 is a prerequisite for booking a lease. If there is no billing schedule, there are no charges, no payments, and no additional accounting would need to be performed. The booking process is largely an accounting process, where the accounting rules 122 are applied to one or more billing schedules.

If at least one billing schedule does not exist at 214.02, then the user 106 will not be able to select a billing schedule to book. Before a billing schedule is actually booked, the user 106 has the ability to see what the financial results of booking the lease would be at 214.03. The internal rate of return (“IRR”), and book and tax classes are generated at 214.03 and are viewed at 214.04. In the preferred embodiment of the invention, a commercially available loan lease calculator product such as SuperTRUMP as described above, is used to perform financial calculation and depreciation streams. The IRR and book and tax classes can be reviewed at 214.06 by the user 106, or the computer system 102 can automatically enforce default rules relating to the required target yields and the calculated IRR. If the review is not satisfactory, the activation is cancelled at 214.16 and a billing schedule screen can be used to generate an acceptable billing schedule.

If the terms are acceptable at 214.06, then a call to the lease loan accounting engine (“LLAE” or simply the “accounting engine”) is made at 212.08 where the appropriate accounting transactors are used to accurately draft journal entries on the relevant bookset(s) for the billing schedule. The next step in the process is to generate a return earnings stream, an indirect cost (“IDC”) amortization stream, and tax and book depreciation streams at 214.10. In the preferred embodiment of the invention, step 214.10 is performed by an interfacing third-party loan lease calculator as described above.

All of the resulting data from step 214.10 is stored by the accounting engine at 214.12 on a database described below. Activation of the billing schedule 119 occurs at 214.14, when the actual book entries 101 are processed and saved. At 214.14, a user 106 can still undue the activation of the assets 108 on the lease at 214.16 by canceling activation at 214.16 because no changes have been made to the database and the journal entries on the bookset(s) 116 have not yet been saved.

If the user 106 decides to go ahead with activation, the status on the computer system 102 of the assets 108 is activated at 214.18. At 214.18, a billing schedule 119 is activated, booking all of the assets 108 associated with that billing schedule. The appropriate security deposit and upfront charges are booked as well as the depreciation streams resulting from the booked assets. The rental billing stream may also be reclassified with respect to payments made before the booking of the billing schedule. If there are backdated charges, the appropriate “catching up” can be done at 214.20.

J. Charge Generation for Billing

FIGS. 7.216a-d illustrate in flow chart form, the charge generation process at 216. Before the charge generation process can begin, at lease one active billing schedule must first exist at 212. The first step in charge generation is to define the criteria of billing schedules and leases at 216.02. Charge generation may depend on criteria such as the particular program, the particular customer, the provisions of a master agreement, the provisions of a lease agreement 110, a charge type, or an invoice due date. After the relevant criteria have been set, a generate charges batch process can then be scheduled at 216.04. At the scheduled time, the charge generation batch process is then triggered at 216.06. The charge batch process is disclosed in greater detail in FIG. 7.216b.

The first step in the FIG. 7.216b batch process is selecting a billing schedule in which to generate charges 216.10. A billing period for the billing schedule is then determined at 216.12. The computer system 102 validates at 216.14 whether or not charges exist for the particular billing period. If no charges need to be generated for the billing period, then the batch process terminates at 216.34. Only if there are missing charges (e.g. charges need to be generated) does the process continue to 216.16.

It is possible that charges for past billing periods should have been generated, but were not generated. If there are past charges missing from past billing periods, those charges are created at 216.16 in addition to the current charges. The charges generated at 216.16 are based on billing schedule criteria. Charge-type mapping is validated at 216.18. This is simply another way of saying that the system 100 will issue charges in accordance with charge type criteria, customer, tax address, and amount or else no charge will be generated. Charge type criteria, customer, tax address, and amount need to be accurate if any type of accounting is to be performed, and so those variables must match their counterparts relating to the billing schedule information set in 212. In the preferred embodiment of the invention, a commercially available sales and use tax calculator product as described above, is used at 216.20, to generate sales tax calculations at 216.22, based on the charge type and the location of the underlying assets. Tax exemption information is examined at 216.26 to determine if sales tax needs to be applied. Tax data at 216.28 and the tax charge information at 216.30 are generated by a sales and use tax calculator as described above, and are used to generate the relevant sales tax charge at 216.24. If a non-zero tax charge is calculated at 216.24, an assumed payment is created automatically at 216.32 and the payment is subject to the accounting rules 122 as applied by the accounting engine. An assumed payment is a internal payment owed by an organization 109 related to the lessor such that payment is not made by an actual check, but rather is accomplished via accounting entries on the booksets 116 of the accounting owner 111. Any tax charges at 216.24 and any assumed payments created at 216.32 must be posted to the accounting engine at 216.34 for accounting treatment and the appropriate bookset 116 entries. If there are no assumed payments to be created at 216.32, the process goes directly from tax charge creation 216.24 to the posting of charges to the accounting engine at 216.34

Charges can also be imported or manually generated without the batch process. FIG. 7.216c discloses a flow chart describing both the manual charge creation process, and the penalty charge generation process. The manual charge process begins with the selection of an agreement at 216.36, unless no agreement exists, in which case a customer is selected at 216.38. If an agreement exists at 216.36, then an asset can be selected from the agreement at 216.40, the default remit to can be changed at 216.44, and the charge type manually selected at 216.50. If no agreement exists, then to reach the selection of a charge type at 216.50, a tax address must be selected at 216.42 and an accounting owner 111 must be selected at 216.46. Selection of an accounting owner 111 at 216.44 allows the user 106 to change to default remit to at 216.44.

No matter the exact path, manual charge creation requires the selection of a charge type at 216.50. After a charge type is selected at 216.50, the default charge type description may be manually and permanently changed at 216.52 for the limited purpose of the particular charge. The charge type at 216.50 is then used to get the tax product code mapping at 216.56. The sales tax is then calculated at 216.58. In the preferred embodiment of the invention, step 216.58, interfaces with a sales and use tax calculator as describe above, and thus the product code mapping at step 216.56 is the product code mapping for such a product. In any case, the sales tax is displayed to the user 106 at 216.60. Invoice details such as bill to, secondary bill to, invoice description, invoice format, and bill by can be manually changed by the user 106 at 216.62. Invoice default dates can be changed at 216.64. The default creation date for a manual charge is the date in which it is entered, but the default creation date can be changed at 216.64. Accordingly a new due date and a new date to invoice may also need to be calculated at 216.64 if the default creation date is changed. Charges can be reallocated amongst assets at 216.70, thus changing the allocations from the default values. Otherwise, charges default in accordance to charge types and the item category of a particular asset 108. Invoice comments can be created at 216.68 to explain the nature of the manual charges, to explain changes from default practices, or for any other desirable reason. Charges can be rolled-up at 216.66, allowing charges pertaining to individual assets to be combined into a single charge for the purposes of printing an invoice. The resulting manual charge can then be saved by the user 106 and committed to the database 162 at 216.72.

The process of penalty charges is also disclosed on FIG. 7.216c. A precondition for a penalty charge is the application of payments and aged charges at 216.86. The unpaid or late charges are selected at 216.88. Those unpaid or late charges are then applied against the penalty matrix at 216.90 to determine the penalty amount at 216.92. Those charges are then validated against charge type mappings at Charge type mappings can then be validated at 216.74. In the preferred embodiment of the invention, the sales and use tax calculator product code mapping is next obtained in 216.76. Sales tax is calculated and the taxable event is recorded at 216.78 and used by the computer system 100 to generate tax charges at 216.80. If the tax charge at 216.80 is on a cash basis, the process stops. If the charge is on an accrual basis, it is posted to the accounting engine at step 216.84 so that the appropriate accounting entries can be generated. An assumed payment can be generated at 216.82 before the charge is posted to the accounting engine at step 216.84.

The process for importing charges from an electronic file is described in FIG. 7.216d. The only prerequisite for the importing of charges from file is that there must a be file of valid charges to import at 216.94. At 216.96, the file is selected and the contents of the file are imported at 216.98 so that pending charges are created at 216.100. The pending charges are validated at 216.102 with respect to customer, agreements, assets, bill by, charge types, invoice formats, invoice formulas, bill to's, and remit to's. A status report is then generated at 216.104 with the results of the validation. If errors are found, the errors are corrected at 216.106 and the pending charges are re-created at 216.100. If there are no errors, the charges can be activated at 216.108. The charges can then be created at 216.110 and the pending charges are deleted. The charge type mappings are validated at 216.112. Product code mappings are obtained at 216.114. In the preferred embodiment of the invention, sales and use tax calculator mappings are obtained so that sales tax can be calculated and the tax event recorded at 216.116. In any embodiment, the tax data is obtained at 216.116, and tax charges are generated at 216.118. If the tax charge at 216.118 is on a cash basis, no accounting entries 103 need be made so then the process is complete. If the tax charge at 216.118 is on an accrual basis, the transaction is sent to the accounting engine at step 216.122 so the appropriate accounting entries can be generated. If the tax charge is neither on an accrual basis nor a cash basis, an assumed payment is generated at 216.120 before the transaction is posted to the accounting engine at step 216.122 and then the process is completed.

K. Invoicing

FIG. 7.218a provides a depiction of the invoice subsystem at 218. For the invoicing subsystem to be invoked, charges must first be generated at 216. After charges are generated by the charge generation subsystem 216, an invoicing subsystem 218 allows the user 106 to invoice lessees on the basis of invoice criteria, to update charges, format invoices, and then issue invoices. Customer, lease, charge type, due date, and invoice format can each serve as invoice criteria at 218.02. If the customer has more than one lease with the lessor, invoicing can be done on either a consolidated or unconsolidated basis. On the basis of the invoice criteria at 218.02, the invoice batch process can be scheduled at 218.04.

FIG. 7.218b provides a flow chart describing the invoice batch process. First, charges are selected at 218.06 on the basis of the criteria set at 218.02. The charges are then sorted at 218.08 in accordance with the defined format. The actual invoice number and line number information is updated with updated charge information at 218.10. Line item detail is customizable at the customer, agreement, billing schedule, or asset level. In the preferred embodiment of the invention a commercially available invoice formatting software product as described above is used at 218.12 to customize the formatting of invoices.

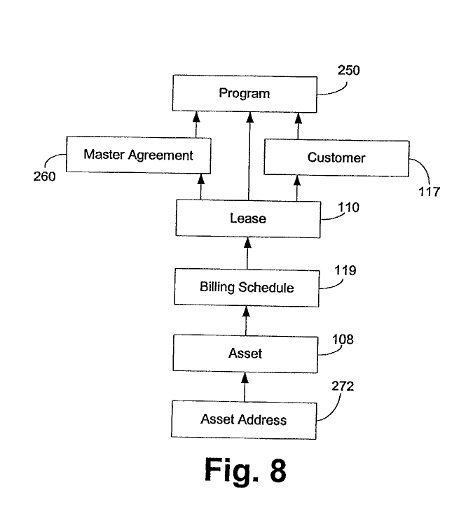

FIG. 8.218 discloses a screen print of the invoicing tab for the billing schedule screen. The various invoice criteria shown on FIG. 8.218 are the same criteria used at 218.02 to schedule invoices at 218.04.

L. Payment Application

After an invoice is generated at 216, the user 106 will usually go to a payment application subsystem 220, although the user 106 could also invoke the charge reversal, adjustment or credit subsystem 224. A payment application subsystem 220 allows the user 106 to apply a payment, determine which charges have been paid, determine which charges have not been paid, post cash, validate tax and charge mappings, and other functions relating to a lessee's payment. Payment application can be performed automatically by the computer system 102 or manually by a user 106. The subsystem 220 also triggers the appropriate accounting entries to be made in the appropriate booksets 116.

FIG. 7.220a describes the batch or lockbox method of payment application. Payments are received at 220.02. If received by lockbox, the lockbox file is imported at 220.04. The pending batch process is created at 220.06 regardless of whether the payments were received by lockbox or by manual batch. That batch of pending payments is then validated at the individual payment level at 220.08. This is done by matching a payment to a corresponding invoice number, or if necessary, to a list of unpaid charges and the appropriate charge criteria. Validation is then performed on the batch control totals, i.e. the aggregate batch payments at 220.10. Validation at 220.12 verifies whether each payment is associated with an invoice. If a reference number is incorrect at 220.12, the reference number is corrected at 220.14, and the validation loop with 220.12 continues until all reference numbers have been reviewed.

For valid payments, the customer number is extracted at 220.16. The pending batch is then activated at 220.18, with cash posted to the accounting engine at step 220.20. The charges corresponding to the payments are then obtained at 220.22. If no charges are found, then the payment is posted to unapplied at 220.24.

If charges are found, then the charge type mappings are validated at 220.26. As described above, charge type mapping validation is the process of matching a payment to a charge through invoice numbers, and it necessary, through the charge type criteria and other information used to validate charges against a booked billing schedule. Product code mappings are obtained at 220.28. Product code mapping links the payment to the appropriate product. In the preferred embodiment of the invention, the product code mappings obtained at 220.28 relate to sales and use tax calculator (as described above) interfacing the computer system at 102. The payment algorithm is applied at 220.38, and if there is excess funds, those monies are posted to unapplied at 220.24. The payment algorithm is the means by which payments are allocated to charges. If payment is sufficient to cover the amount of charges, the payment algorithm simply applies payments to charges that are correctly mapped. If payment is insufficient to cover the amount of charges, the payment algorithm determines which charges receive payment and to what degree, on the basis of charge type and other criteria used by the charge generation subsystem at 216. Payments against open A/R then have their tax rates validated at 220.32. In the preferred embodiment, the validation is performed by the sales and use tax calculator as described above. The tax event is recorded at 220.34 and the payment is applied and charge updated at 220.36. The taxes and the application of payment are then posted to the accounting engine at step 220.38 for the purposes of generating the relevant accounting entries on the appropriate bookset(s) 116.

The automatic payment process is illustrated in FIG. 7.220b. The only precondition for automatic payment is the posting of payments to the accounting engine at step 220.40. Unapplied payments that target charge IDs, invoice targets, agreements, or assets are selected at 220.42. Charges for the corresponding invoice numbers, agreement numbers, and asset IDs, are then obtained at 220.44. If no charge is found at 220.44. the payment is posted to unapplied at step 220.52. If a charge is found, the charge type mapping is obtained at 220.46. The product code mapping for tax calculations is subsequently obtained at step 220.48. Tax treatment is determined in part by product code, so the system at 220.48 confirms that the tax calculations are appropriate for the particular product code. In the preferred embodiment of the invention, the tax calculations are preferably performed by the sales and use tax calculator as described above. The payment allocation algorithm as described above then determines the charges to be paid at 220.50. The tax rate is then validated at 220.54 by looking up the product code on the sales and usage tax calculator. In the preferred embodiment of the invention, a commercially available sales and use tax calculator is used to perform the validation and send the results back to the computer system at 102. The tax event is then recorded at 220.56, which is also done through the sales and use tax calculator in the preferred embodiment of the invention. The payment is then applied at 220.58 and the tax charge updated at 220.58. The new payment and charge updates are subsequently posted to the accounting engine at step 220.60 for the generation of the pertinent accounting entries.

Unapplied payments are then selected at 220.62 on the basis of charge type and gain/loss events. Corresponding charge types are then selected at 220.64 with the appropriate charge types or gain/loss event. Charge type mappings are validated at 220.66 as described above and product code mapping obtained at 220.68 as described above. In the preferred embodiment of the invention, step 220.68 is performed by a commercially available sales and usage tax calculator software product as described above. The sales tax can be calculated and the tax event recorded at 220.70. The tax data is then used to generate tax charges at 220.72 so that unapplied payments can be applied at 220.74. The applied payments are then posted to the accounting engine at step 220.76, while the unapplied payments remain unapplied back at 220.52.

The process for manual payment application is disclosed in FIG. 7.220c. The only precondition for the process is that a payment must be received at 220.80. Payment header detail is entered by the user 106 at 220.82. Such information can potentially include a customer, check number, reference number, a payer (defaulting to a customer), remit to, amount, currency, and a date. Payment items are created at 220.84, such as customer, invoice number, agreement, asset, charge type, gain/loss event, quote, and amount. The payment information can then be saved by the user 106 and committed to the database 162 at step 220.86. The information saved on the database 162 records that payment has been received and the corresponding charge satisfied by the payment. The payment and satisfaction of the charge is then posted to the accounting engine, which then generates the appropriate accounting entries and saves all changes to the database 162. If there aren't any unapplied payments at 220.90, the payment application process is completed.

If unapplied payments remain, they are selected at 220.88. The appropriate charges are attempted to be identified at 220.92 through the payment item criteria entered at 220.84. The payment allocation algorithm is then applied at 220.94 as described above. Targeted charges can then be re-filtered at 220.96, by attempting to match such charges to the appropriate charge criteria. Charges with a payment already attributed to them are excluded at 220.98. Payment allocation amounts are modified at 220.100. The user 106 saves changes committing the changes in the database at step 220.102.

Charge type mappings are validated at 220.104 as described above. Product code mappings are obtained at 220.106 as described above. The tax rate is obtained at 220.108, and the tax event is recorded at 220.110 as described above. In the preferred embodiment of the invention, a sales and usage tax calculator as described above, is used to perform steps 220.106, 220.108, and 220.110. The payments are then applied, and charges updated to include the tax charges at step 220.112. The payment applications and charge updates are then posted to the accounting engine at step 220.114 so that the appropriate journal entries can be made to the appropriate bookset(s) 116.

M. End of Lease/Lease Termination Processing

After invocation of the payment application subsystem 220, a user 106 could use a payment adjustment and reversal subsystem 230, or if no such adjustments are required, ultimately the user 106 will need to use an end of lease subsystem 222. The end of lease subsystem 222 allows the user 106 to process a return of assets 108 to inventory, a repository where such assets could then be re-leased or to facilitate the sale of the previously leased assets. A lease 110 can also be renewed, by invoking engaging the lease processing subsystem to generate a new lease 110 on the computer system 102 maintaining lease attributes such as assets associated with the lease. Thus, historical information regarding the assets 108 is maintained despite the execution of a new lease 110.

Regardless of whether a lease 110 is renewed, a new lease 110 is executed with a new customer 109, whether assets 108 are disposed of, or whether assets are simply returned to inventory, all aspects of the residual value of the assets are available for subsequent processing. Standard quotes and non-standard complex quotes with options for asset disposition can be processed. All termination scenarios are accounted for including lease termination, early lease termination, termination with a bad debt write-off, and termination of a suspended lease. If a lessor complains about an asset 106 and refuses to pay the lessor any additional payments, scenarios for early termination, early termination with a bad debt write-off, or suspension of a lease followed by termination of the suspended lease could each constitute valid ways to deal with such a customer. Termination can occur at a billing schedule 119 level or at the lease 110 level. The end of lease subsystem 222 calculates financial information, including balances, costs, and gain/loss amounts for book and tax calculations. Termination reason codes are customizable by the user 106.

The termination process is described in greater detail in FIG. 7.222a. The termination process begins at 222.02. The type of termination and the appropriate reason code explaining the termination are selected at 222.04. The termination proceeds can either be entered at 222.06 or obtained at 222.06. The billing schedules for termination are selected at 222.08. The select asset option at 222.10 results in either the selling of the asset 108 to the lessee, or the returning of the asset 108 to inventory where that asset 108 can then be released. The process of returning an asset 108 to inventory is disclosed in greater detail below. The user 106 next selects the open A/R to be paid at 222.12. The proceeds for all sold assets are distributed at 222.14, and the termination process is completed at 222.16

FIG. 7.222b discloses the process of returning an asset to inventory at 222.10. The only precondition to returning an asset 108 to inventory at the termination of a lease 110 is that active agreements with assets 108 must first terminate at 222.18. Return authorization is created for the selected assets 108 at 222.20. The assets may be manually closed at 222.22, essentially undoing their return, Otherwise, the system 100 will try to match the return authorization with the selected assets at 222.24. If there is a match, the asset 108 is returned to inventory at 222.26, and the asset 108 is active, but no longer belongs to an agreement 110. Inventory value is increased by the value of the asset 108. The changes to inventory are then sent to the accounting engine at step 222.28 to generate the appropriate accounting entries. If there is not a match at 222.24, then the item receipt is acknowledged at 222.30. The status is changed to closed at 222.32 and the user makes comments or takes some other action at 222.36. A new asset 108 could subsequently be created at 222.34 for the newly received asset.

There are essentially threes way to return an asset to inventory if there is no match: (1) a user 106 can either force a match by retroactively editing the authorization; (2) a user 106 can perform a portfolio search; (3) or the asset can be manually closed.

N. Charge Reversal, Adjustment, or Credit

A charge reversal, adjustment, or credit subsystem 224 allows a user to modify charges generated at 216, even if such modifications are being done retroactively. Individual charges can be modified, or all of the charges relating to an asset or even to a lease can be affected with the same amount of data entry work by the user 106. Only non-financed charges can be reversed, otherwise the unbook subsystem 226 must be invoked first. A non-financial charge is a charge that has not yet been booked, and thus no accounting entries 101 have yet been created for that charge. A reason code is associated with each modification to a charge. The charge reversal, adjustment, or credit subsystem 224 is disclosed in greater detail in FIG. 7.224.

1. Credit

The precondition for generating a credit is that a charge exists at 224.02. The charge is selected at 224.04. The charge type for which a credit is to be issued is selected at 224.06. A credit number is subsequently assigned at 224.08. Charge type mappings are validated at 224.10. Product code mappings are obtained at 224.28. Sales tax is calculated, and the tax event recorded at 224.30. In the preferred embodiment, a commercially available sales and use tax calculator as described above is used to perform steps 224.28 and 224.30. Tax charges are created at 224.32. If the credit is to be issued on a cash basis, the process is completed. If issued as a credit, the credit is applied to selected charges at 224.40. The credit to charges and credit are posted to the accounting engine at steps 224.42 and 224.44 respectively.

2. Adjustments

The precondition for generating an adjustment is that a charge must exist at 224.02 in order for the charge to be adjusted. The charge is selected at 224.04. Then a reason code representing the reason for the adjustment must be selected at 224.14. Charges are created at 224.12 and then the process at 224.10 follows the same path from 224.10 through 224.32 as if a credit was being issued. Those steps are described above. If tax charges at 224.32 are generated on a cash basis, then the process terminates. If the adjustment charges are done on an accrual basis, they are posted to the accounting engine at step 224.36 and a penalty charge is attached with an invoice number at 224.38. If the adjustment is made neither on an accrual basis nor on a cash basis, then an assumed payment is made at 224.34 so that the assumed payment is also posted along with the charges at 224.36.

3. Reversals

The precondition for reversing a charge is that a charge must exist in order for it to be reversed at 224.02. The appropriate charge is selected at 224.04. Then a reason code representing the reason for the reversal must be selected at 224.14. The user 106 saves the selection of reason codes so that the database changes can be committed at step 224.16. Penalty charges are reversed at 224.18. Applied payments are reversed at 224.20. Unapplied payments are created at 224.22. In the non-preferred embodiment of the invention, the reversal transactions would be posted to the accounting engine at step 224.26 without any type of tax awareness. In the preferred embodiment, a commercially available sales and use tax calculator is used at 224.24 to record the reversal and report any tax consequences before the various transactions are posted to the accounting engine at step 224.26.

O. Payment Adjustment and Reversal

A payment adjustment and reversal subsystem 230 performs analogously to the charge reversal, adjustment, or credit subsystem at 224, except that payments are being modified instead of charges. A reason code is associated with each modification of a payment. Payments can be reapplied manually or automatically. There are tax and accounting implications to any change that must be tracked by the computer system in the appropriate manner. The application of payments are always mapped and validated against charges. The payment adjustment and reversal subsystem is described in greater detail at 230. If a user 106 needs to adjust or reverse charges at 224 or to adjust or reverse payments at 230, then the user 106 may also need to unbook 226 and then rebook 228 the assets 108 and charges 122 relating to the lease 110.

1. Payment Adjustment

FIG. 7.230 discloses the payment adjustment. The only precondition for adjusting a payment is that an applied or unapplied exist at 230.02. The payment(s) in question is selected at 230.04. Reason codes representing the reason for the adjustment are selected at 230.06. The user 106 then saves the reason code selection so that the changes may be committed to the database at step 230.08. A charge is created at 230.10. The charge type mapping is then validated at 230.12. The product code mapping is obtained at 230.14. The sales tax is calculated and the tax event recorded at 230.16. In the preferred embodiment. Steps 230.12, 230.14, and 230.16 are performed by interfacing sales and use tax calculator as described above.

Tax charges are created at 230.18 with the resulting tax data. The payment adjustment is then applied at 230.20. The payment adjustment is recorded at 230.22, and the adjustment is posted to the accounting engine at step 230.24, and the user 106 must use the payment application subsystem at 220 to either invoke auto pay or to apply the payments manually. The non-financial flag may also be set at 230.23, and such setting can be saved by the user 106 and committed to the database in step 230.30. The non-financial flag allows the user 106 to engage in a what if analysis by exploring what would happen if a particular change were made, without causing the accounting engine to generate the resulting accounting entries 101.

2. Payment Reversal

The only precondition to reverse a payment is that an unapplied or applied payment exist to be reversed at 230.32. The payment to be reversed is selected at 230.34. The reason code justifying the reversal of payment is selected at 230.36. The selection of the reason code is saved by the user 106 and committed to the database at step 230.38. The payment application is then reversed at 230.40. An unapplied payment is created at 230.42. The non-financial flag is set at 230.26 and is saved by the user 106 and committed to the database at step 230.30. The reversal is recorded for tax purposes at 230.44. and the results of the reversal are posted to the accounting engine at step 230.46. The user 106 must engage the payment application subsystem at 220 to apply the unapplied payments. In the preferred embodiment of the invention, step 230.44 is performed by a commercially available sales and use tax calculator software.

3. Payment Split

FIG. 7.230 also discloses a flow chart illustration of how payments can be split. The only precondition for splitting a payment is that a payment must exist to be split at 230.48. An applied or unapplied payment is selected at 230.50. Payment items such as customer, invoice number, agreement, asset, charge type, gain/loss event, quote, and amount are created at 230.52. The user 106 saves the changes, and the data is committed to the database at 230.54. The unapplied payments are reversed at 230.56, and unapplied payments are subsequently created at 230.58. The non-financial flag can be set at 230.62, and saved by the user 106 and committed to the database at step 230.64. The reversal and creation of unapplied payments are then posted to the accounting engine at step 230.60. The application of any unapplied payments will require use of the payment application subsystem at 220.

P. Unbook

Any active agreement with an active asset billing schedule can be unbooked at 226. Even an asset 108 that is not associated with a lease 110 can be booked, and thus can be unbooked at 226. Although a user 106 may refer to booking a lease 110 or booking a billing schedule, the computer system 102 books transactions at the asset level. Thus, when a lease 110 is booked, the computer system 102 books every asset 108 attached to that lease. The unbooking of a asset, billing schedule, or lease agreement is a way to “undo” accounting processing that is no longer correct. If no earnings have been posted to the assets before unbooking, unbooking is a relatively simple process. If A/R earnings do exist, applied payments need to be reversed, applied credits need to be reversed, any adjustments need to be reversed, and all charges will be reversed. The unbooking subsystem 226 is disclosed in FIG. 7.226.

In a situation where there are no A/R earnings the unbook process is very simple, as shown in FIG. 7.226a. An unbook transaction is created at 226.02, and the results are posted to the accounting engine at step 226.04.

As shown in FIG. 7.226b, a situation can arise where there are billed A/R earnings, the applied payments are reversed at 226.06. The applied credits are reversed at 226.08. Adjustments are reversed at 226.10. Charges are reversed at 226.12, and the unbook process is complete.

Q. Rebook

A rebooking subsystem 228 is then used to rebook a lease 110 and its assets 108 after the desired changes are made to the assets 108 or lease 110. Only an unbooked lease can be rebooked. Rebooking involves the same type of validations, such as for internal rate of return, that booking a lease involves. Rebooking a lease generally involves a user 106 making changes to asset 108 attributes, such as residual value, initial direct costs, commencement date, depreciation method, or interim rent, a charge for the use of equipment from either its inservice date or delivery date on which the base term of a lease 110 commences. Holdover and term rental payments will also require the entry of accounting entries, as will the reapplication of charges and payments.

The complexities of rebooking depend on the surrounding conditions. FIG. 7.228a illustrates an example of a rebook due to a financial change, but with an unbooked inactive agreement. The precondition for rebooking is the existence of an unbooked billing schedule at 228.02. The agreement to be rebooked is selected at 228.04. The asset on agreement attributes are changed at 228.06, with regards to characteristics such as residual value, IDC, financial amount, and commencement date. Asset 108 attributes such as depreciation method and determination life may be changed at 228.08 Next, the new IRR is calculated and new book and tax classes are obtained at 228.10 just as they would in the booking process. In the preferred embodiment, a loan lease calculator as described above, is used to perform the step at 228.10. The IRR and book and tax classes are then reviewed at 228.12 and validated, either manually by the user 106 or automatically by the computer system 102. If the lease class has not changed, processing returns to the change asset on agreement step at 228.06. If the leasing class has changed, a rebook transaction is created at 228.14, rebook entries are posted at 228.16, and charges are re-created at 228.18.

FIG. 7.228b discloses re-booking in the context of financial change with changes to interim, holdover and term rentals. Interim rentals are rent charges for a period of time before a lease agreement 110 is actually executed. Holdover rentals relate to a period of time after a lease 110 expires, but the assets 108 have not been returned to the lessor. Term rentals refer to rent charges in accordance with the terms of an active lease agreement 110. The preconditions for this process include an active agreement, assets and a billing schedule at 228.20 and term rentals at 228.22. The first step is the identification of the agreement to be changed at 228.24. The billing schedule is changed 228.26 in terms of amount, the date in which the first payment is due, the frequency of payments, or with respect to advance periods. Applied payments are then reversed at 228.28. Applied credits are reversed at 228.30. Adjustments are reversed at 228.32. Charges are reversed at 228.34. The asset on agreement attributes are then changed at 228.36 with respect to the residual value of the assets, the IDC, the financial amount, and the commencement date. The asset attributes are changed at 228.38 with respect to the depreciation life and depreciation method. The IRR, book class, and tax class are obtained at 228.40 and 228.42. In the preferred embodiment of the invention, the steps at 228.40 and 228.42 are performed using a commercially available loan lease calculator as described above.

If after 228.42, the lease class has not changed, the process returns to 228.26 to change the billing schedule. If after 228.42, the lease class has changed, the rebook transactions are created at 228.44. Rebook entries are posted to the accounting engine at 228.46 and charges are generated at 228.50.

FIG. 7.228c discloses a re-booking process to effectuate an asset change and an address change. The only precondition in FIG. 7.228c is the existence of an active agreement with assets at 228.54. Assets are selected at 228.56. The address is changed at 228.58. Applied payments are reversed at 228.60. Applied credits are reversed at 228.62. Adjustments are reversed at 228.64. Charges are reversed at 228.66. Tax base charges are identified at 228.67. The sales and use tax calculator is used at 228.68 to determine the resulting tax implications. Changes are saved by the user 106 at 228.70 and committed to the database. The user 106 is still free to not save the rebooking, undoing the entire process.

III. Asset Level Processing and Data Hierarchy

The system 100 can process transactions and store data at the individual asset level even when a lease 110 has multiple assets 108. The system 100 uses different database tables 128 to represent assets 106, billing schedules 119, leases (agreements) 110, accounting owners 111, programs, products, customers 117, and other organizations 109. By actually generating, processing, and storing data at the appropriate level, the flexibility of the system 100 is maximized. Attributes or characteristics are stored at the lowest-level in the data hierarchy that such characteristics can logically be attributed. In terms of financial and accounting transactions relating to leases 110, assets 108 are usually the lowest level in that hierarchy. Similarly, operational rules can be created, applied, and implemented as the asset address, asset 108, billing schedule 119, lease 110, master agreement, customer 117, or program level because operation rules are applied to attributes, or groupings of attributes. This allows the system 100 to roll-up or roll-down the data hierarchy of the system 100 as a result of driving attributes down to their lowest logical level.

An attribute is any characteristic or trait of an item, element, or object processed by the system 100. An operational rule is any rule applied by the system 100 to the processing of an attribute. A value exists for each particular instance of an attribute. For example, each asset 108 possess the attribute of status. For an asset 108, a status can have the value of either active (the asset is available for attachment to a lease and is being depreciated in inventory) or inactive (the asset exists on the system, but is not generating any accounting entries 101).

Operational rules can be based on operators, general categories or characteristics associated in some way with an item, element, or object. For example, in the financial accounting setup subsystem at 200 and the item catalogue subsystem at 202, operators such as billing criteria, reason codes, charge types, penalty rules, charge type categories, and other operators are defined. Those operators can be used by both the accounting rules 121 and the operational rules to distinguish both whether something is done, and how something is done.

Objects 126 in the system 100 can be grouped by the values contained in their attributes, or by their relationships with other objects 126. For example, the system can search and identify all assets 108 relating to a particular billing schedule 119, lease 110, customer 109, master agreement, program, or accounting owner 111.

FIG. 8 is a high level block diagram showing different levels of data which are often used by the system 100. At the highest level is the program 250. Financial data can be aggregated to the program 250 level with regards to revenue, profitability (IRR), and other data. Various operational rules can also be set at the program level. A program 250 can possess many different master agreements 260 and many different customers 117. Operational rules can be applied and financial data obtained for a particular customer 117 or for an entire master agreement 260. One level below a master agreement 260 or customer 117 is a lease 110, because a lease 110 can only belong to one customer 117 and to one master agreement 260, but a master agreement 260 and a customer 117 can have multiple leases 110. Default rules can be set and financial data obtained at the lease level. A billing schedule 119 is beneath a lease 110 because a billing schedule 119 can only belong to one lease 110, but a lease 110 can possess many billing schedules 119. Default rules can be set and financial data obtained, at the billing schedule level. Although an asset 108 can have multiple billing schedules 119, a billing schedule can have multiple assets 108, a billing schedule 119 is at a higher level of processing because a billing schedule 119 will generally have many assets 108, and lease level billing schedules are common. For most types of information, asset 108 level processing is the lowest level of processing. For sales and use tax information, the address 272 of an asset 108 is important. Although an asset address 272 is a mere attribute of an asset 108, in some ways, an asset address 272 is the lowest level of processing in the system 100. An asset 108 can have more than one address 272 over the course of its history, but an asset 108 can only have one address 272 at a time because an asset 108 cannot be in two or more places at once. Thus, an asset 108 can have multiple former asset addresses, but only one current asset address. The asset address 272 level of processing is used primarily for sales and use tax purposes.

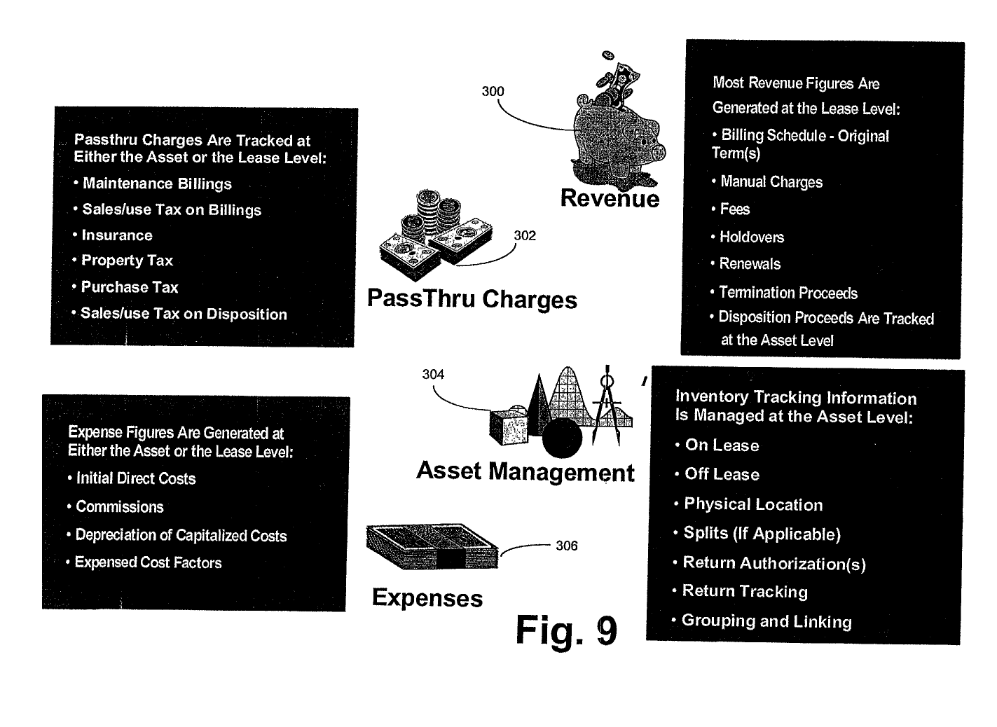

FIG. 9 is a high level diagram illustrating both the interplay and distinctiveness between a lease 110 and an asset 108. Revenue 300 is usually calculated at the lease level. Billing schedules, manual charges, fees, renewals, holdovers, and termination proceeds are usually calculated at the lease level, although asset disposition proceeds are generally tracked at the asset level. In contrast, inventory tracking information 304 is necessarily managed at the asset level. Assets can go on and off lease, and thus cannot be tracked effectively at the lease level. Physical location, asset splits, return authorizations, return tracking, and grouping and linking are generally performed at the asset level. Pass through charges 302 and expense figures 306 are managed at both the asset and lease level. Pass through charges include maintenance billings, sales/use tax on billings, insurance, property tax, purchase tax, and sales/use tax upon disposition. Expenses 306 include initial direct costs, commission, depreciation of capitalized costs, and expensed cost factors. FIG. 9 makes it clear that to maximize the advantages of the system 100, it is necessary to operate at various levels in the data hierarchy.

A. Asset Level Processing

The generation, processing, and storage of individual asset-level information allows the system 100 to represent the lease 110 in such a way that is consistent with a user's 106 perception of a lease, while at the same time maximizing system flexibility. Asset-level processing is not achieved by artificially using a series of one-lease assets to represent one lease with a number of assets being treated in a distinct manner.

The benefits of asset-level processing manifest itself in many ways. Different billing schedules 119 can be created for two or more assets 108 under the same lease 110. Assets 108 at the end of a lease 110 can be treated distinctly from each other despite being attached to the same lease. The internal rate of return (“IRR”) and other financial calculations can be computed at the level of an individual asset. Income statements, balance sheets, depreciation schedules, and asset cost information can be made readily available for individual assets. Asset return and inventory tracking can be done distinctly for each individual asset. Each individual asset 108 can be treated distinctly with respect to the appropriate tax jurisdiction, tax amount, and tax exemptions. Charges, taxes, and penalties can be assigned at the asset level. Billing criteria can be set at the individual asset level by overriding the lease-level billing criteria for an asset. Multiple cost factors can be associated with the same asset 108 since data is actually stored at the asset level. Assets can be activated in inventory before being associated on a lease, and assets remain in existence even after the termination of the lease they were associated with. Certain events relating to assets, such as book and tax depreciation, are totally independent of whether or not an asset is associated with a lease. Other processing, such as sales or use tax calculation which is based on the asset type and the jurisdiction of the asset's address, are only indirectly related to a lease since the provisions of the lease will determine where an asset is located.

The system 100 can process at the asset level because asset level processing is performed using an object-oriented class of objects 126 called “asset.” Various subclasses to delineate and emphasize different aspects of assets, may also be used, as described above and below. Asset attribute information is stored in one or more asset database tables 128, as described above.

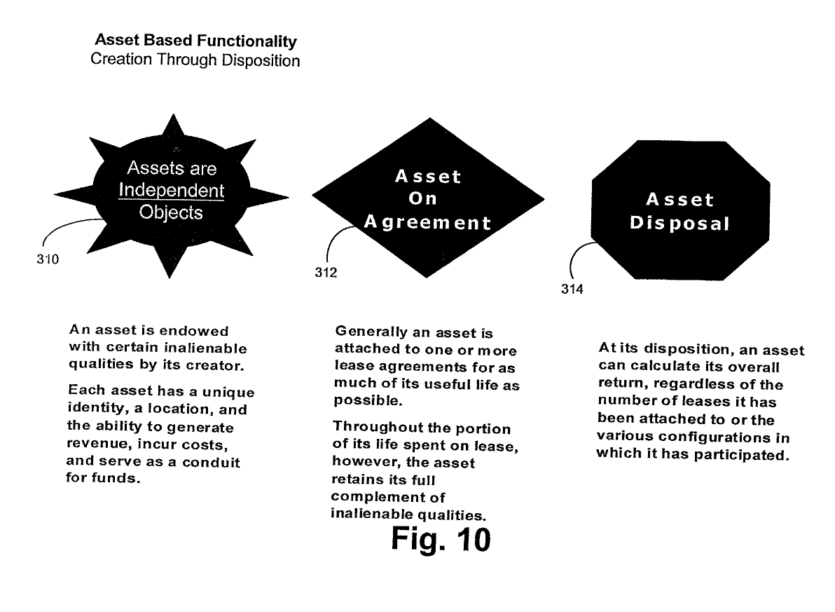

FIG. 10 discloses a block diagram illustrating certain facts about asset based functionality. Assets are independent objects 310 in the system 100. The types of traits that can logically exist at the asset level are the traits of an asset object. Asset objects are distinct from lease objects. The way in which assets interact with leases are captured in a distinct object-oriented class called asset-on-agreement 312. An asset-on-agreement object and database table 312 incorporates the key attributes of placing an asset on a lease schedule without attempting to incorporate aspects of lease 110 that have nothing to do with an asset 108, or aspects of an asset 108 having nothing to do with a lease 110. The distinctions between a lease and its assets is never more important that in the asset disposal process 314. By definition, a lessor maintains ownership over the assets 108 in a lease 110, and thus those assets 108 need to be dealt with at the termination of the lease 110.

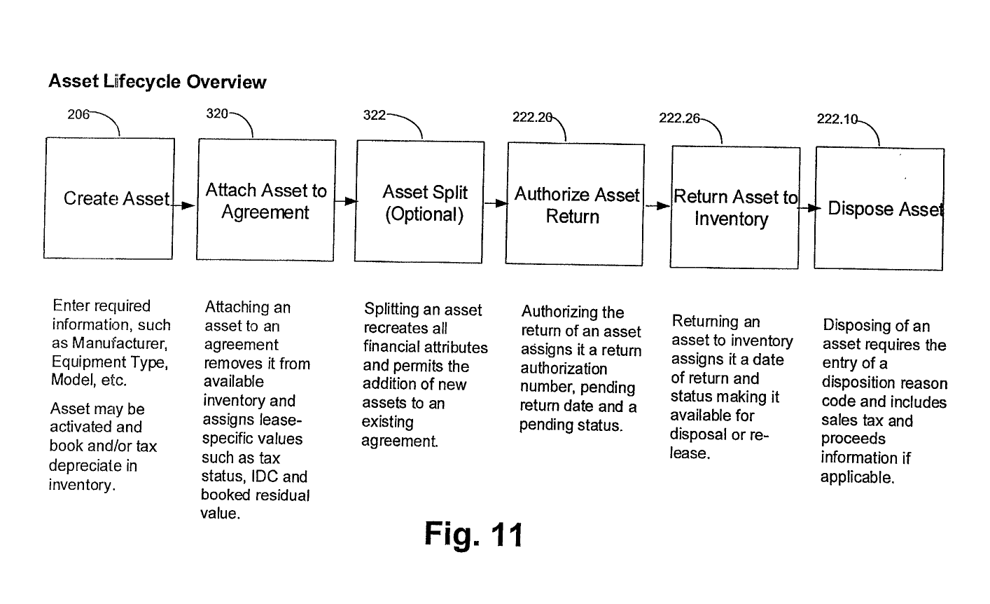

FIG. 11 illustrates the lifecycle of an asset. The creation of an asset was described above, by using the asset processing subsystem at 206. The attachment of an asset to an agreement occurs at 320. As will be described in greater detail below, the attachment of an asset 108 to a lease 110 is done through the intermediary object-class called asset on agreement. Although the attachment of an asset 108 to a lease 110 is done through a lease processing screen, the affiliation of an asset to a lease is an asset attribute, requiring the lease processing subsystem 210 to invoke the asset processing subsystem 206 make the appropriate modifications in asset attributes.

Asset splits are identified at 322. An asset on an agreement or off an agreement, can be split into component pieces, with each component constituting an independent asset object. When as asset 108 is split, the new asset 108 on the system 100 is a child asset, and the asset 108 from which the child asset is derived is a parent asset. Splitting an asset 108 recreates all financial attributes and permits the addition of new assets to an existing agreement. Asset history is retroactively and automatically created for the newly split component by prorating the asset history before the asset split occurred. The attributes of the parent asset are similarly adjusted if necessary, to reflect for example, the fact that prior depreciation may now be attributed to the child asset.

The remaining stages in an asset's life all relate to the end of lease subsystem at 222. Before an asset 108 can be returned to the inventory (“repository”) of the lessor, authorization for the return of the asset 108 must first be entered into the system 100. The authorization for return of the assets occurs at 222.20, which is disclosed in greater detail above. Authorizing the return of an asset assigns it a return authorization number, a pending return date, and a pending status. The return of an asset to inventory occurs at 222.26. Returning an asset to inventory assigns it a date of return and status making the asset available for disposal or release to a new lease 110. The disposition of an asset at 222.10 requires a user 106 to enter a reason code and enter sales tax and proceeds information so the appropriate accounting entries can be made in accordance with the accounting rules 122.

FIG. 12a, discloses an asset object model. The Figure discloses example relationships that an asset 108 can have, as well as the nature of those relationships. The relationship between object classes is represented by a line. Each line has a notation on both ends of the line, either a “1” or an “*.” A “1” indicates a singular correlation while an “*” represents that there could be multiple correlations. For example, each asset 108 has only one model, but there could be multiple assets 108 of the same model. A particular model has only one manufacturer, but a manufacturer may produce many different models. Similarly, an asset can belong to only one organization but an organization can have many assets. Some relationships are one to one, such as asset to book depreciation. There are no many to many relationships involving an asset 108. This is a natural result of a data hierarchy which treats similar items similarly, and distinct items distinctly

Book depreciation methods and tax depreciation methods depend on the asset 108 because the accounting rules 122 depend on the type of asset, and the expected life span of an asset 108. Item category, item type, and model relate to an asset because each of those three categories represents a category of asset types. Cost factors and cost categories are features related to the item type that an asset belongs. Organization, address, and address usage each relate to the lessor of an asset, while an accounting owner 111 and program relate to subgroupings of the lessor which conduct particular types of transactions using particular types of assets. It is important to note from FIG. 12 that an asset 108 has no direct relationship with a lease 110. The lease object does not appear on FIG. 12. Rather, leases and assets are connected indirectly through an object called asset-on-agreement, a distinct class objects. The asset-on-agreement object and the lease object are described in more detail below.

FIG. 12b discloses an alternative embodiment of the asset object model. In stead of merely one asset object, the asset class (the abstract asset class in the Figure) is divided into several subclasses relating back to one parent asset class, the abstract asset class. Abstract taxable assets represent a subclass of assets in which taxes must be paid. A taxable external asset, an asset for which taxes must be paid on an asset that is not owned, and a depreciable asset, a taxable asset which can be depreciated, both relate up to an abstract taxable asset, which relates to the abstract asset. The subclass of external asset, relates to assets not owned by the lessor. There may be performance reasons and development reasons for dividing up the asset object class into a series of subclasses. Many different derivations of subclasses could be used pursuant to this invention. The important consideration is that asset attributes must be characteristics of an asset object, and only be accessible by an asset object, and thus the asset processing subsystem at 206.

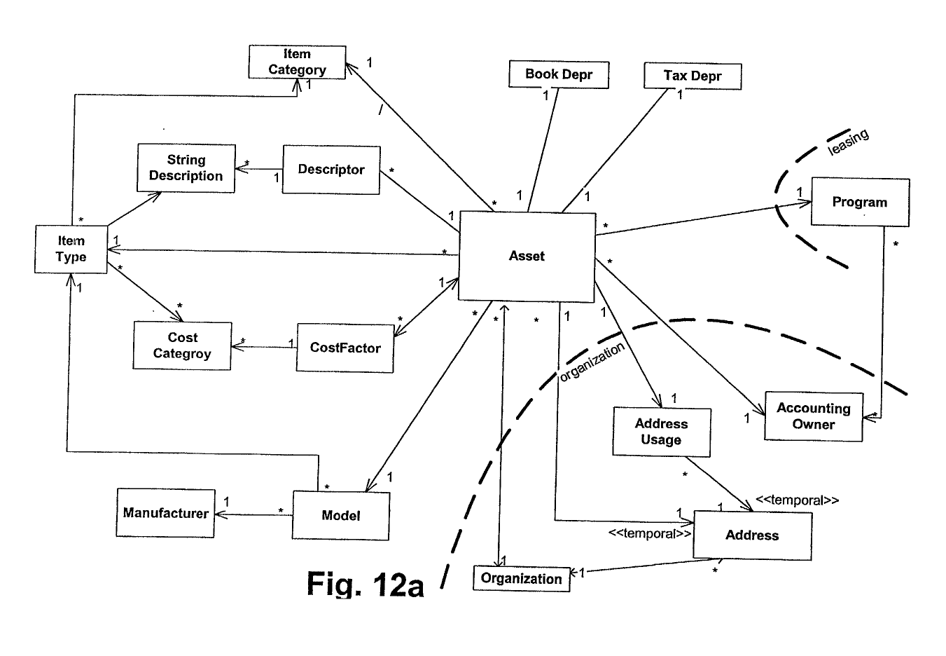

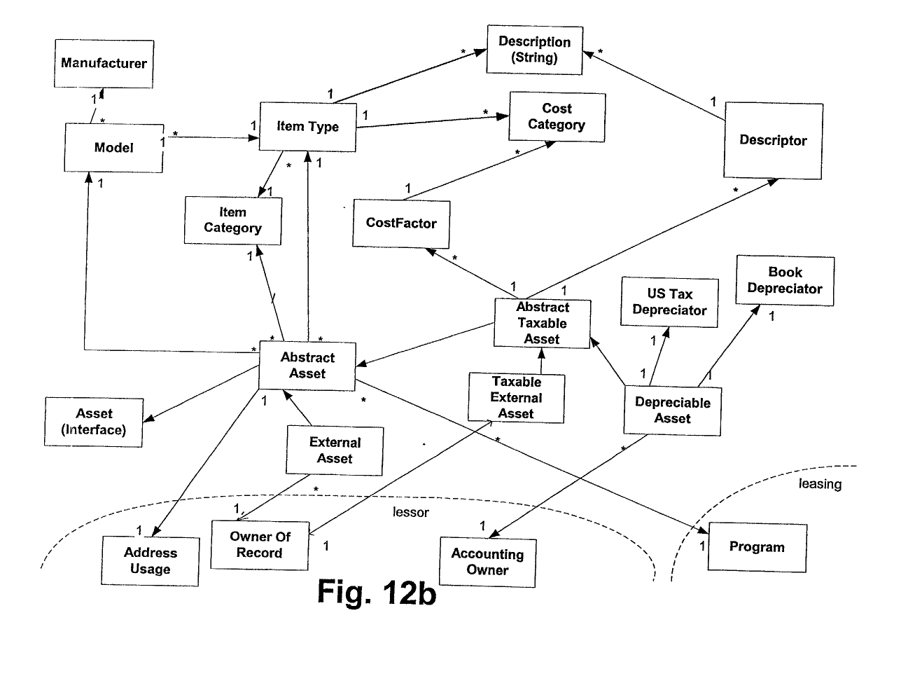

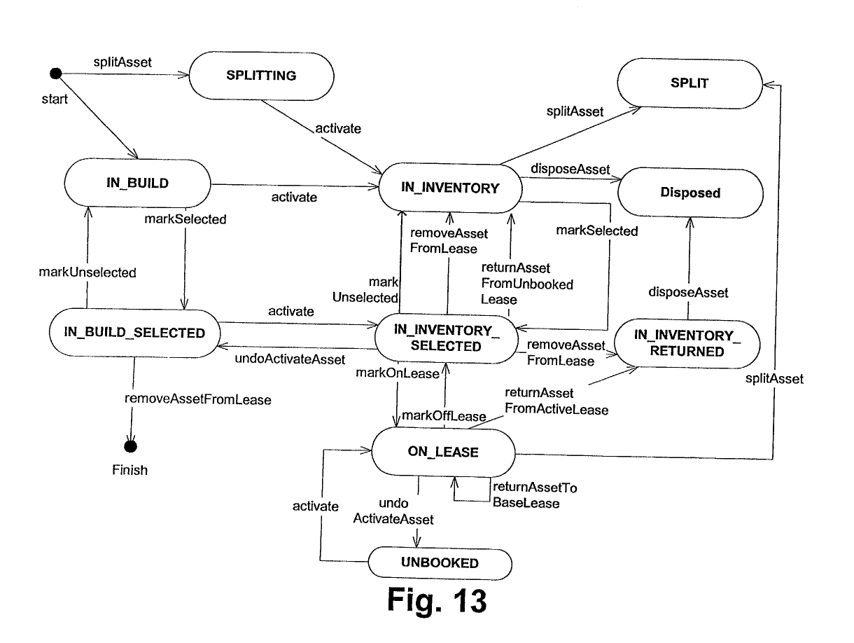

FIG. 13 discloses an asset state model. An asset state is one of many important asset attributes. As an object, an asset is something that a user 106 can create, modify, activate, attach to leases, remove from leases, and be disposed of after a lease 110. All of these activities require the invocation or engagement of the asset processing subsystem 206. The figure describes each possible asset state, and how an asset can migrate from one state to another.

At the start an asset is created at 206. This can be done either before of after an asset is actually purchased. An asset is created by either splitting (SPLITTING) from another existing asset 322, or by being created (IN_BUILD) through the create asset subsystem at 206. Either way, the activation of the asset places it in inventory (IN-INVENTORY). An asset in inventory can be split or disposed. An asset in inventory can also be selected by a user 106, which would render the asset IN_INVENTORY_SELECTED. The fact that an asset is selected does not mean that it is attached to a lease, it merely means that the asset is actively highlighted by a user 106 for one of a number of reasons. If an asset is attached to a lease 110, it is then ON_LEASE. If an asset ON_LEASE is de-activated, the asset enters the state of being UNBOOKED. An UNBOOKED asset cannot enter another state without first become activated, and thus back ON_LEASE.

Similarly, the only way an asset can be disposed is by first being in a state of IN_INVENTORY or IN_INVENTORY_RETURNED. No other state directly connects to being disposed. An asset ON_LEASE needs first to be returned to inventory 222.26 (IN_INVENTORY_RETURNED) before the asset can be disposed of at 222.10.

On the left side of FIG. 13, the state IN_BUILD refers to an asset that has not yet been activated yet. If selected by a user 106, it enters the state of IN_BUILD_SELECTED, where activation will keep the asset selected, and render the asset IN_INVENTORY_SELECTED.

The ability to disclose an asset state model to describe activities that can be done to asset objects exemplifies the advantages of using asset objects distinct from lease objects, billing schedule objects, asset on agreement objects, and other types of objects representing data that relates in some direct or indirect way to objects. To alter the state of an asset 108, the asset processing subsystem at 206 must be invoked.

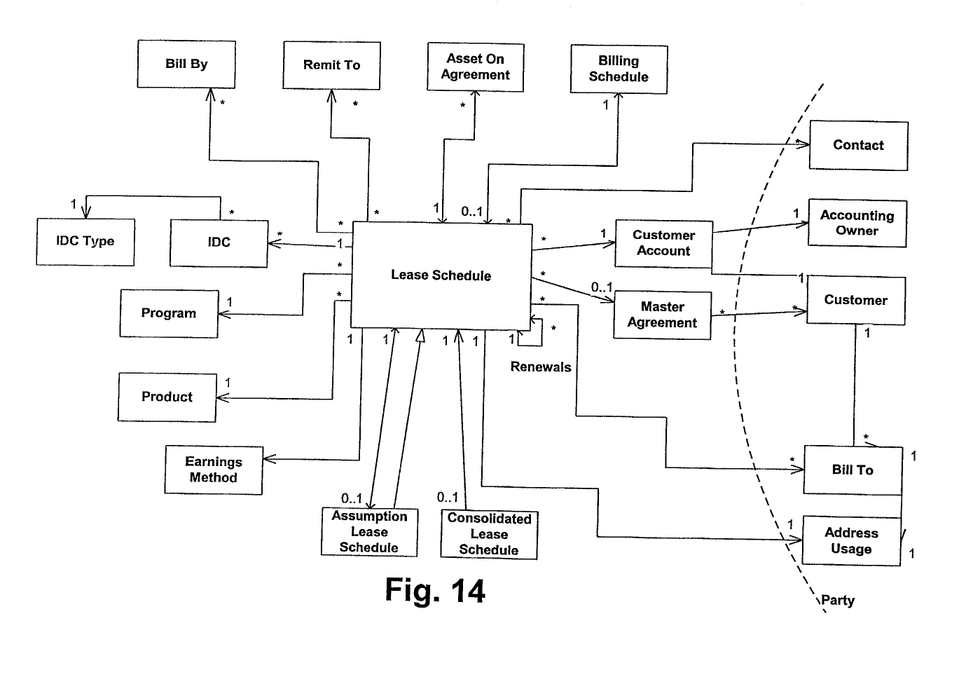

FIG. 14 discloses an object model for a lease schedule. The model is very similar to the asset object model. For instance, by looking at the “1” and “*” on the line between a lease schedule and a customer account, it is understood that a lease schedule belongs to only one customer, but a customer can have several lease schedules. Unlike the asset model, the notation “0 . . . 1” appears on FIG. 14. This means either a one to one relationship, or maybe no relationship at all depending on the circumstance. For example, if a master agreement exists, it can have many lease schedules. However, a lease schedule will never belong to more than one master agreement, and may in fact belong to none at all. Although a lease schedule does not directly relate to an asset, asset on agreement does directly relate to a lease schedule and a lease schedule can have many assets on agreement, while any asset on agreement can only belong to one lease schedule. Billing schedules 119 can be free-floating, so a billing schedule may or may not be associated with a lease schedule. A lease schedule does require a customer account. Assumption lease schedules and consolidated lease schedules also have a direct relationship to lease schedules. Each individual lease is associated with a single program, a single product and a single earnings method. A lease schedule may possess multiple bill by's and remit to's, and a bill by or remit to may be the same for multiple leases. A lease may or may not be affiliated with a single master agreement, but a master agreement can possess multiple leases.

FIG. 14 does not contain any reference to an asset. However, the object asset on agreement is referenced. Each asset on agreement object belongs to only one lease schedule, but a lease schedule may have many assets on agreement. The fact that the object assets-on-agreement has an independent existence from both assets and leases maximizes the flexibility of the system 100 to perform asset level processing and to navigate up and down the data hierarchy to perform roll-up and roll-down processing. Lease attributes include some of the data relationships not disclosed in FIG. 14, information such as a commencement date, a term, affiliation with a financial product, and other information set at the lease-level which does not logically extend lower to the billing schedule or asset level.

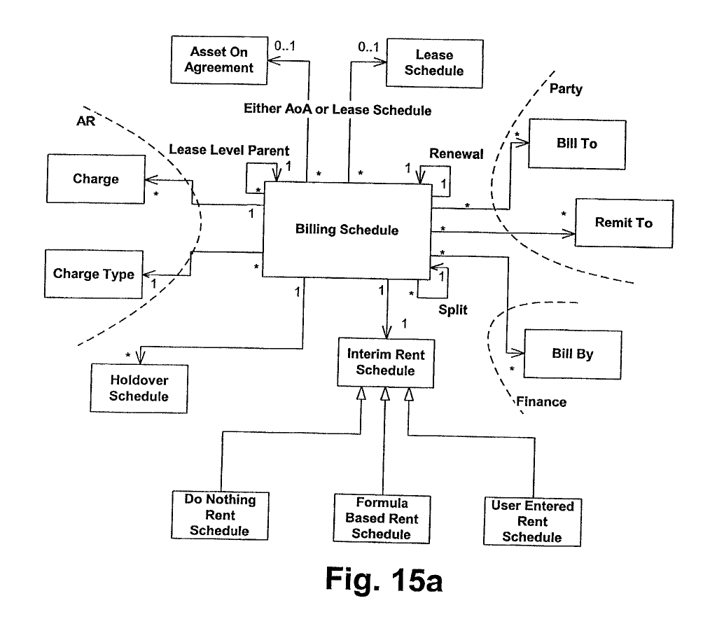

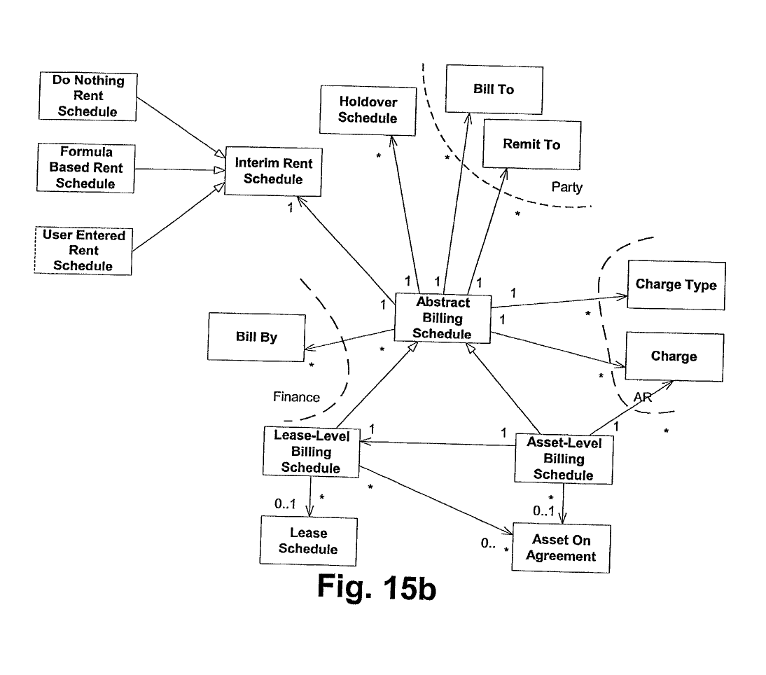

FIG. 15a discloses the object model for billing schedules, another critical part of lease management. It is important to note that a billing schedule object, just like the asset on agreement object, has a totally distinct and independent existence from both assets and leases. A billing schedule 119 can be set at the asset level (or more specifically, the asset on agreement level) or at the lease schedule level. Without these distinct object classes, the flexibility provided by the system 100 would not be possible. The most important billing schedule attributes are the actual schedule of charges. The creation, modification, or the deletion of such charges, whether at the asset level or the lease level, constitute billing schedule attributes requiring the billing schedule processing subsystem 212 to be invoked in order to conduct such processing.

A single billing schedule 119 can have many charges, but a charge can only belong to one billing schedule. In contrast, a charge type can be associated with numerous billing schedules, but a billing schedule can only have one charge type. A holdover rent schedule which occurs when a lease expires, but the assets have not been returned, can only have one billing schedule although a billing schedule can relate to multiple holdover schedules. An interim rent schedule relates to a period of time before a lease 110 is executed between a lessor and lessee. An interim rent schedule can only have one billing schedule, and a billing schedule can only be affiliated with one interim rent schedule. An interim rent schedule can be formula based, user defined, or simply the result of doing nothing, which results in no charges being accrued.

Billing schedules can be split, renewed, and set at the lease level. There is a many to many relationship between a billing schedule and bill to, remit to, or bill by.

FIG. 15b discloses a billing schedule object embodiment involving multiple subclasses relating up to a single abstract billing schedule object. To facilitate efficient processing of both lease-level billing schedules and asset-level billing schedules. Subclasses of lease-level billing schedule objects and asset-level billing schedule objects may be used by the billing schedule processing subsystem at 212. Subclasses of billing schedule objects does nothing to alter the fundamental qualities of the billing schedule processing subsystem 212, which must be invoked by a user 106 or different subsystem in a billing schedule attribute is to be created, modified, or deleted.

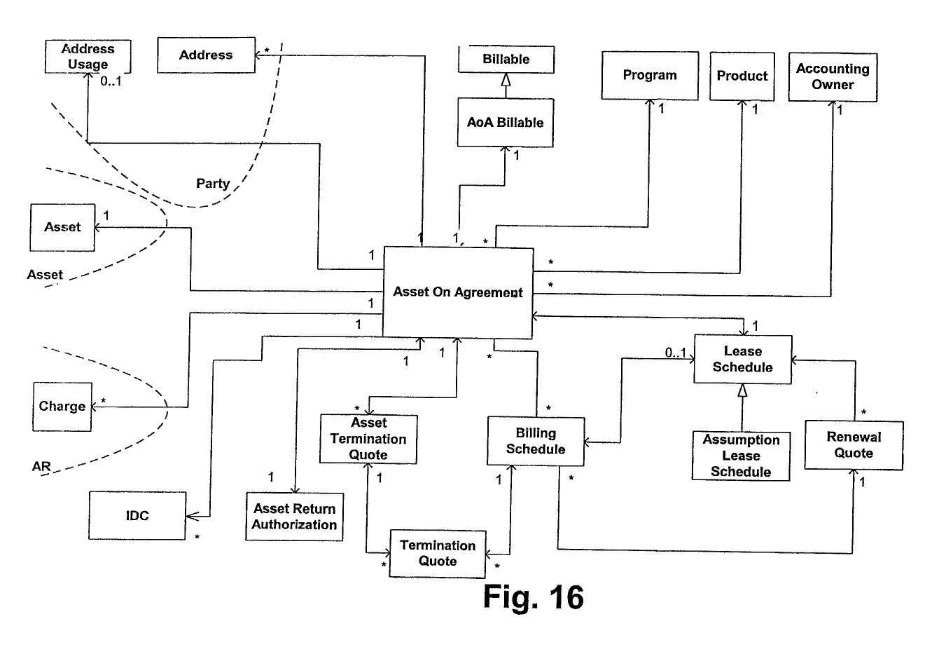

FIG. 16 discloses an object model for the asset on agreement object class. Numerous object classes such as lease schedules, accounting owners, and billing schedules have relationships with the asset on agreement object, but not the asset object. This supports the ability to provide true asset level processing as well as navigate up and down the hierarchy of data relationships.

Types of data relating to subgroups of a lessor will have one to many relationships with an asset-on-agreement. A program can contain many asset-on-agreements, but each asset-on-agreement can belong to only one program. A product can utilize many different asset-on-agreements, but each asset-on-agreement can belong to only one product. Similarly, an accounting owner 111 will likely have numerous asset-on-agreements, but each asset-on-agreement must relate to one and only one accounting owner 111.

As the conduit to connect asset level information to lease level information, an asset on agreement has a one to one relationship with an asset and a one to one relationship with a lease schedule. A single asset on agreement can be associated with multiple charges, termination quotes, or billing schedules. An asset on agreement can have multiple address and IDC codes associate, and even addresses over the life of an asset. However, at any particular time, an asset can have only one address.

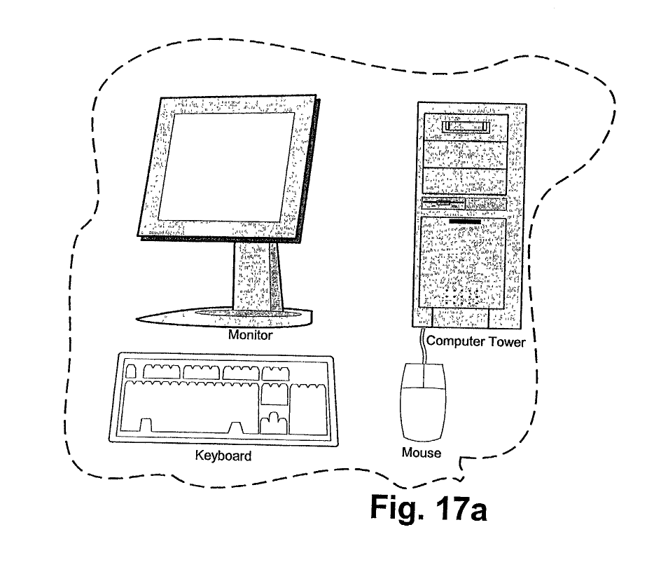

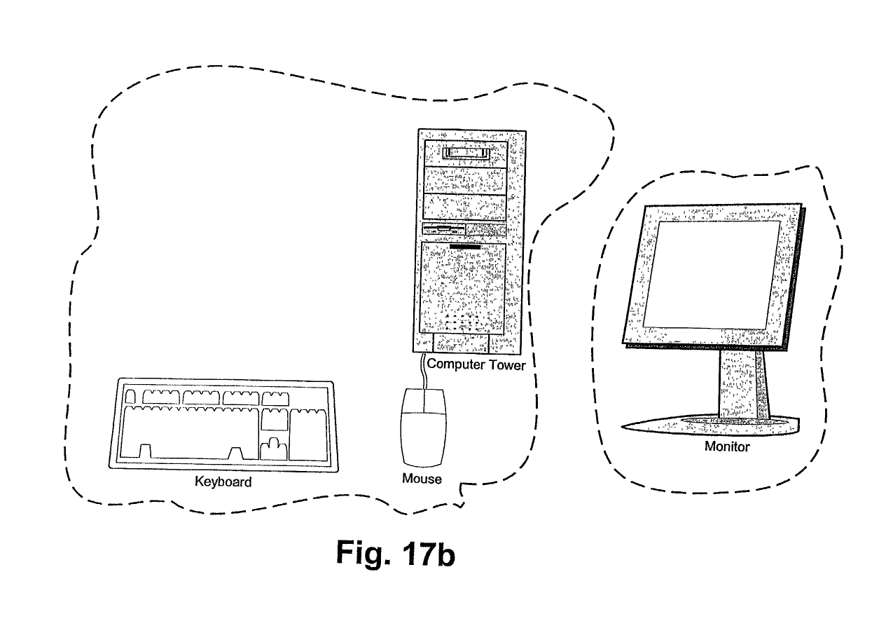

FIGS. 17a and 17b disclose one useful implication of asset-level processing, the ability of an individual asset 108 to be split by the asset processing subsystem 206 into two or more assets 108. FIG. 17a discloses a single asset 108 on the asset processing subsystem 206. The single asset of a computer system has various components, a monitor, a keyboard, a mouse, and a computer tower, that do not existing individually in the system 100. One or more of the various components can be split off into separate assets.

FIG. 17b discloses the results of an asset split where the monitor is now a separate asset 108 from the computer system. As a separate asset, the monitor can have a separate billing schedule, can be treated different for tax and book depreciation purposes, and can be placed on a different lease than the computer system. Historical information before the monitor was split off as a separate asset, is prorated so that the monitor has a depreciation history.

B. Roll-Up/Roll-Down through Use of Data Hierarchy

Asset-level processing results in more than simply the ability to manage data at the lowest logical level. Rather, by storing data at the lowest logical level, a user 106 is provided the ability to roll-up or roll-down the data hierarchy to process data at the level of abstraction that is relevant to the business objectives of the user 106 and the lessor. For example, if a user wants to evaluate the overall IRR for a particular customer 117, the computer system 102 can generate an aggregate IRR for all assets attached to all leases to which the particular customer is a party. This is referred to as a “roll-up.” The “roll-up” process can also be referred to as a “consolidated view” or “consolidated processing.” The user 106 could then “roll-down” to obtain more granular information. IRR information and other financial calculations such as Income statements, balance sheets, depreciation schedules, and asset cost information can be generated at the asset 108, billing schedule 119, lease 110, customer 117, master agreement, program, or accounting owner 111 level.

The benefits of “roll-up/roll-down” processing manifest itself in many ways. Different billing schedules can be created at the asset, lease, account number, account owner, and customer levels. Asset return and inventory tracking can be done at the asset, billing schedule lease, account number, and customer level. Tax jurisdictions, tax amounts, and tax exemptions can be viewed and calculated at the asset, address, or customer level. Charges, taxes, and penalties can be assigned at the asset, lease, account number and customer level. Historical information can be viewed at the asset, lease, account number, and customer level. “What-if” analyses can be performed to compare different customers so that unequal treatment can either be rationalized or eliminated. Taxes can be adjusted at a group level based on the charge group.

The asset processing system 206 can be invoked by a user 106 or by another subsystem to selectively create an asset 108, modify an asset 108, delete an asset 108, create a asset attribute, modify an asset attribute, or delete an asset attribute. Asset attributes include a unique numerical key for representing each asset, a legal owner, a sales source, a status, a vendor, an accounting owner, a program, an item type, an item category, a model, a current address, a quantity, a feature, an activation date, a description, an inventory value, an asset acquisition date, a split parent ID if the asset originated by splitting off of another asset, a tax code, a tax jurisdiction, a tax assessment date, a total cost, a tax capitalization flag, a status history, a date in which the inventory value was last set, an affiliation with a billing schedule, an affiliation with a lease (asset-on-agreement), a book depreciator, a tax depreciator, and any other characteristic that can be potentially attributable to an asset 108. The creation, modification, or deletion of an asset or asset attribute constitutes an business event. However, the accounting rules 121 determine whether or not such a business event is an accounting event that will invoke the accounting engine 500 to generate accounting entries 101 in the appropriate booksets 116.

The lease processing system at 210 can be invoked by a user 106 or another subsystem to create lease, modify a lease, delete a lease, create a lease attribute, modify a lease attribute, or delete a lease attribute. Lease attributes include a unique identifier for each lease, a possible affiliation with a master agreement, an agreement type, a default IDC type, a status, a program, a product, an earnings method, a residual earnings method, a customer notice period, a lessor term notice period, a customer renewal notice period, a customer buyout notice period, an effective (commencement) date, a deactivation date, a sales source, a booking date, a last unbook date, a last unbook maturity date, a default effective date, a default inservice date, a default tax exempt status, a default tax exempt reason code, a default equipment location, a default invoice format, a default bill by, a default remit to, a default invoice lead days, a default shipping date, a default delivery date, an assumption date, an affiliation with billing schedules, an affiliation with assets, a suspension date, a tax recovery method, an unbook reason, an affiliation with a customer, and any other information that could potentially relating to a lease. The creation, modification, or deletion of a lease or a lease attribute constitutes a business event. Based on the accounting rules, certain business events will trigger the accounting engine to generate accounting entries in one or more booksets in accordance with the accounting rules.

Many times, a user 106 or other subsystem will want to perform processing to information related to a lease, but not constituting a lease attribute. For example, it may be desirable to enact modifications to an asset attribute for each asset associated with a lease in a substantially simultaneous manner. The computer system 102 can process modifications to numerous assets in mere seconds, or often in mere fractions of a second. With such flexibility. a user 106 can make changes to multiple asset attributes across multiple assets with the same amount of user 106 effort that is required to make a change to a single asset attribute. Such processing may originate from the lease processing subsystem, but the asset processing subsystem must be invoked to modify asset attributes.

A similar process is involved when using other subsystems. Identical changes to asset attributes for assets associated with a particular billing schedule can be enacted in a substantially simultaneous manner by the invocation of the asset processing system by the billing schedule processing system. Similarly, all of the billing schedules associated with a lease can have identical changes enacted to billing schedule attributes in a substantially simultaneous manner by the invocation of the billing schedule processing subsystem by the lease processing subsystem.

Changes to any asset attribute, lease attribute, billing schedule attribute, organization attribute, or any other attribute in the system constitutes a business event in the system. The accounting rules determine which subset of business events will automatically trigger accounting activity by the accounting engine.

A system 100 designed to support the ability to conduct processing at various levels of abstraction also supports the ability to set operational rules at various levels of abstraction. Certain operational rules can be set at various levels in the data hierarchy simultaneously. Rules set at a high level, such as for a program or master agreement, can be overridden by rules set at a lower level, such as for an lease 110, billing schedule 119, or asset 108. This process is discussed in more detail above, during the discussion relating to FIG. 8.

IV. Lease Loan Accounting Engine and Transactors

A. Accounting Engine

The system 100 generates accounting entries 101 through an accounting engine which is automatically triggered by a subset of business events, which according to the accounting rules, require accounting treatment. The system isolates the accounting rules 121 from the business and operational logic of the system 100. Thus, business logic is distinct from accounting logic and business processing, which includes any type of operational processing, is distinct from the generation of accounting entries 101 resulting from the business processing. Similarly, a business attribute is broadly defined to include any attribute of the system not relating to generating of accounting entries 101 the accounting engine. With the exception of the financial accounting setup process at 200, a user's 108 direct interaction with the system 100 is limited to manipulating business attributes and in engaging business processing. Accounting treatment in contrast, is triggered by the accounting engine, which knows in accordance with the accounting rules, which business events require accounting entries 101 to be generated.

FIG. 18 discloses a high level flow chart illustrating selective examples of when and how a lease loan accounting engine (“accounting engine” or “LLAE”) 500 is invoked at various times throughout the lifetime of a lease 110. In the preferred embodiment of the invention, the accounting engine 500 is a component-based module using a Java/XML interface. In non-preferred embodiments, the accounting engine is still component-based and written in an object-oriented programming language. The accounting engine 500 facilitates the automation of accounting processes in a way that is transparent to the user 106 entering data relating to business events into the computer system 102. The accounting engine 500 allows users 106 with specialized accounting knowledge to define the accounting treatment that results from an accounting event. That start-up process is implemented in the financial accounting setup subsystem at 200. After the accounting rules 122 have been implemented at 200, users 106 without any accounting training can input operational events and rely on the accounting engine 500 to initiate and perform relevant accounting functions.

An accounting event is a business transaction that impacts the financial treatment that takes place within the computer system 102. In short, if an event affects the way an accountant keeps the books, that event is an accounting event. An accounting engine 500 uses a event-based processing approach that takes place based on defined business rules. Lease accounting components may be used throughout the lease life cycle because operational events trigger accounting ramifications throughout the life cycle of a lease. The accounting engine 500 will accommodate complex multi-entity accounting needs. Use of the accounting engine 500 requires an accountable object such as an asset 108 and a business transaction or temporal event such as a new month, that triggers an accounting event, such as the generation of charge 216.

The accounting engine 500 can be invoked for events occurring as early as lease origination at 502. Advance lease payments are commonly incurred upon execution of lease when the last month's rent may be due. The payment application subsystem 220 processes such payments. The payment application subsystem 220 would then invoke the accounting engine 500 to generate to appropriate accounting entries relating to the advance payment. Booking entries or stream calculations 504 also requires work to be performed by the accounting engine 500. Thus, the booking subsystem at 214 will also invoke the accounting engine 500. Lease maintenance activities 506 such as billing at 212, payment application at 220, lease and asset changes, income recognition, and book and tax depreciation each require use of the accounting engine at 500.

After the accounting engine 500 generates the appropriate accounting entries, the results of that processing may be stored in an LLAE database at 514. Detailed lease accounting audit trail information is stored at 514. Information is also sent to a general ledger system (“G/L system”) 510. In the preferred embodiment of the invention, the G/L system is third-party commercially available software package such as such as the Platinum system, interfaced with the computer system at 102. The G/L system is used for archive and audit purposes. The G/L system 510 stores summary posting information on the G/L database 512. In the preferred embodiment, both the LLAE database 514 and the G/L database 512 are relational databases that utilize standard query language (“SQL”).

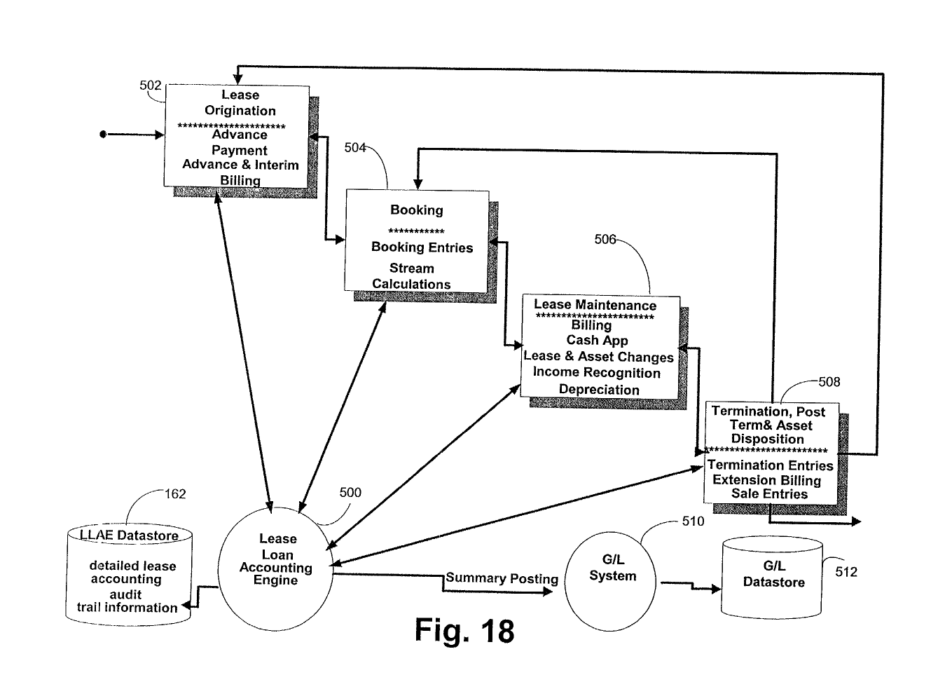

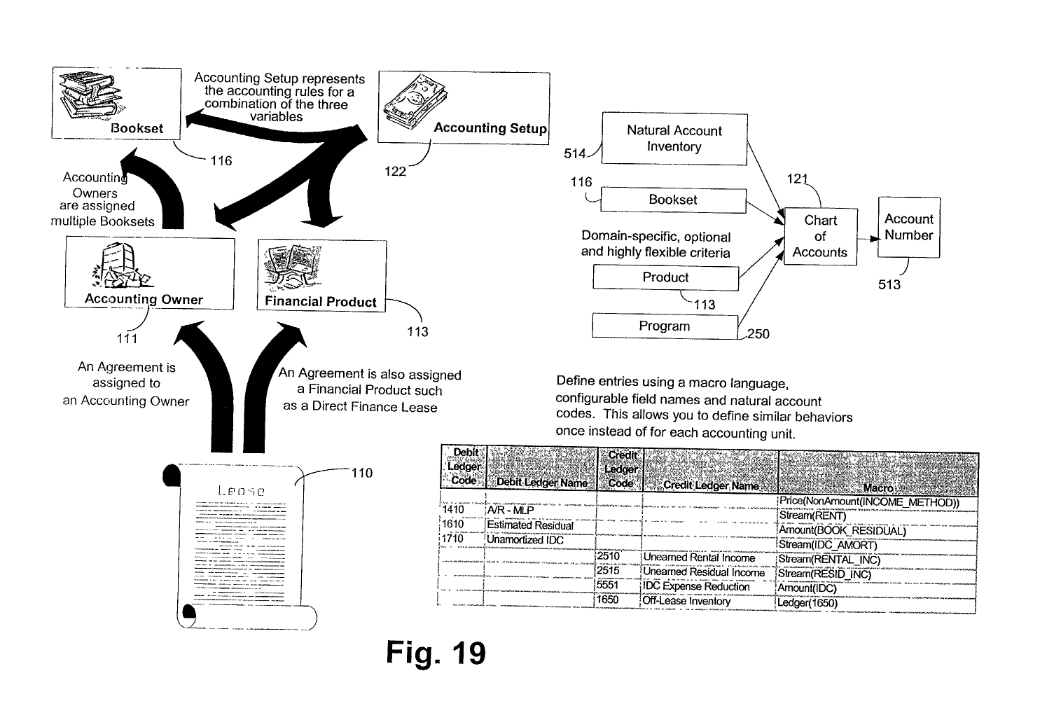

FIG. 19 illustrates key variables used by the accounting engine 500 to distinguish the way in which accounting functions are performed. Users 106 of the financial accounting setup subsystem 200 define the accounting rules 122 applied by the accounting engine 500. That is the one stage in the process of using the system 100 where in the preferred embodiment of the invention, the user 106 will be someone skilled in accounting. For all other subsystems requiring the user 106 to interact with the computer system 102, the user 106 need not possess any specialized accounting knowledge. Such users 106 need only be familiar with operational events such as asset activation, and need not be familiar with the accounting implications of such operation events since the computer system 102 will automatically perform such accounting through the accounting engine 500.

Accounting rules can distinguish between different financial products 113 and different accounting owners 111=As already discussed above, an accounting owner 111 is a subset group of the lessor. An accounting owner 111 can be a department, a division, a subsidiary, a particular office geography, a profit center, or any other subset of the lessor. The accounting owner 111 is the organization or entity responsible for transaction accounting and reporting. A financial product 113 is the type of business arrangement, such as a direct finance lease, an operating lease, an asset sale, or any other business arrangement relating to assets 108. Both accounting owners 111 and financial products 113 are defined by the user 106 in the financial accounting setup subsystem 200.

As is shown in FIG. 19, the financial product 113 and the accounting owner 111 are determined by the lease 110 while the accounting setup subsystem 200 determines the accounting rules 122 that will be applied. A bookset 116 entry is generated through the input of the lease 110 information and the application of the accounting rules 122 to the lease 110 information, which includes an accounting owner 111 and a financial product 113. All of the work performed by the accounting engine 500 is stored in a bookset 116 which is physically stored in the LLAE database 514. One operational event can result in multiple booksets 116. The LLAE database 514 records accounting history, so even if a transaction is undone, a user 106 will still be able to access accounting history on the LLAE database 514.

Booksets 116 can define entries using a macro language, configurable field names, and natural account codes. This supports a user's 106 ability to define and group together, accounts with common characteristics. Thus, similar behaviors need only be created, modified, or updated once, instead of for each accounting unit. A lease 110 is accounted for in all of the booksets 116 assigned to its accounting owner 111. The entries that will be made in each bookset 116 are based on the accounting rules 122 in the financial accounting setup subsystem 200 for the financial product embodied in the lease 110. Extensions to natural account numbers are mapped using ledger modifiers assigned using a flexible hierarchy defined by users 106.

A natural account inventory 514 contains a library of natural accounts. A natural account is a grouping of account numbers for accounts requiring similar accounting treating because those accounts share a common characteristics with respect to the generation of accounting entries 101 under the accounting rules 121. Natural accounts 514 facilitate the searching of individual account numbers 513. Knowledge of a natural account 514 and a bookset 116 can be used by a chart of accounts 121 to search and find individual account numbers 513. Additional information such as product 113, program 250, or other data can be used by the system 100 or its user 106 to narrow down the number of resulting account numbers 513.

B. Accounting Transactors

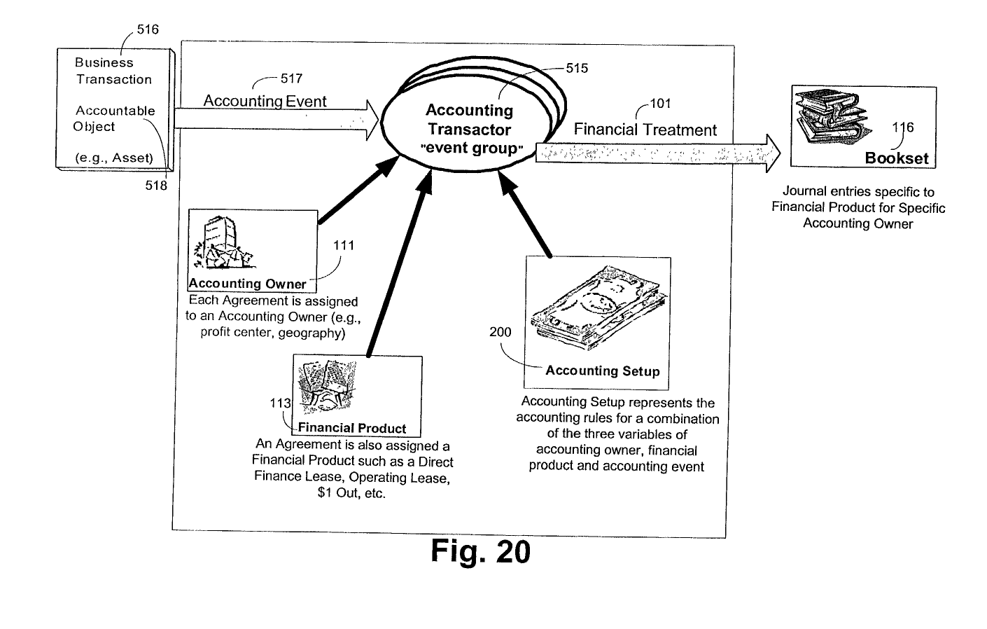

FIG. 20 discloses a flow chart of the accounting engine 500 including an accounting transactor 515 as a subcomponent. Inputs to the accounting transactor 515 include a business transaction 516, such as the acquisition of an asset 108 in inventory, and an accountable object 518, such as an asset 108 or any other object on which an accountant performs accounting. The Figure also discloses that accounting transactor 515 needs to be told the accounting owner 111, the financial product 113, and the accounting rules 122 inputted into the financial accounting setup subsystem 200. At 116 is the bookset upon which journal entries are created for the particular accounting owner 111.

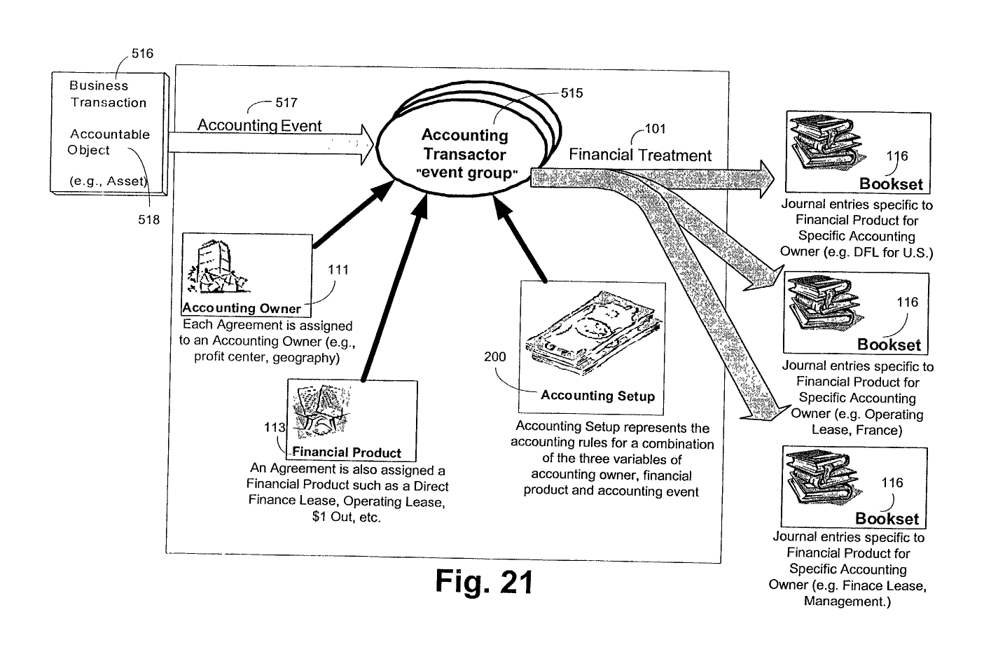

FIG. 21 discloses a similar flow chart for an embodiment involving multiple bookset entries from a single operational event 516. A common example of such an embodiment involves international leasing companies. A lessor headquartered in the United States and doing business in France may need to keep at least two sets of books, one for the United States and one for France, for transactions occurring in France. This may be true for each individual accounting event relating to the French lease. Complicating the situation is the fact that different nations also apply different lease treatments. In the United States, generally accepted accounting principles (“GAAP”) may classify a lease 110 as a direct finance lease while in France, GAAP may classify the same lease 110 as an operating lease. The modular nature of the accounting engine 500 supports this kind of flexibility.

The accounting transactor at 515 is the means in which the system 100 delivers accounting services in accordance with the accounting rules 122 as setup in the financial accounting setup subsystem at 200. In the preferred embodiment of the invention, there are at least 33 different accounting transactors. An accounting transactor 515 is a object-oriented object class which defines a particular accounting transaction. In the preferred embodiment, the Java programming language is used, and each accounting transactor 515 is a java class. An accounting transactor 515 knows how many accounting transactions to create per bookset, and which “natural accounts” to debit and/or credit, and for what amounts. A “natural account” is a label given to an account by a user 106 to identify and distinguish the account from other accounts. A “natural account” is not necessarily used as key on a database, but it is how a user 106 thinks of the account.

In the preferred embodiment, the following 33 different accounting transactors will be included.

1. ActivateBookDepreciatorTransactor

The ActivateBookDepreciator Transactor activates the book depreciator for an Asset 108. It also credits inventory for the amount of the asset's book basis and debits either OperatingLeaseEquipmentOnLease or OperatingLeaseEquipmentOffLease for the same amount. This transactor is invoked when an asset 108 is activated at 206 or by the booking subsystem at 214. An asset 108 need not be associated with a lease 110 in order for a user 106 to activate the asset 108. The activation of the asset is an event initiated by a user 106, but the accounting is generated automatically in accordance with the rules 122 setup by a user 106 who is skilled in the application of accounting rules to the leasing industry.

2. ActivateUSTaxDepreciatorTransactor

The ActivateUSTaxDepreciator Transactor activates U.S. tax depreciation accounting at the time in which an asset 108 is activated 206 by a user 106. Entries will be added to the appropriate bookset 116 or booksets 116 in accordance with the rules 122 inputted into the computer system 102 through the financial accounting setup subsystem 200. The ActivateUSTaxDepreciator also credits TaxEquipmentFunding for the amount of the asset's tax basis and debits TaxDeprEquipment. The transactor is invoked by the asset processing system at 206 and the booking system at 214.

3. AdjustBookDepreciation Transactor

The AdjustBookDepreciation Transactor adjusts book entries necessary to account for edits made to an asset's book depreciator's cost basis. These edits can be made at the asset or lease level. OperatingLeaseEquipmentOffLease is credited for the decrease in basis, and Gain/LossBookBasis is credited for the same amount. If the depreciation recalculation method in effect is “current” then additional entries are made to adjust AccumulatedDepreciationOffLease (debit) and DepreciationExpenseOffLease (credit). The amount used in this case is the difference between the depreciation recognized so far and the total depreciation stream through the posting date. Edits made to an asset's book depreciator are made in the same way that other asset 108 characteristics can be modified. The transactor is invoked during the rebook process at 228.

4. AdjustUSTaxDepreciation Transactor

The AdjustUSTaxDepreciation Transactor is similar to the AdjustBookDepreciationTransactor, except that it is used to account for changes in an asset's 108 USTaxDepreciator cost basis. Edits made to an asset's tax depreciator are made in the same way that other asset characteristics can be modified at 206, when those changes are rebooked at 228.

5. AppliedPayment Transactor

An AppliedPayment Transactor creates accounting entries to recognize that a payment has been applied to a charge. The AppliedPaymentTransactor is invoked by the payment application subsystem at 220. If the applied payment is based on a cash receipt, cash clearing is debited, otherwise unapplied payments is debited. A billed-received-offset account is then credited. If residual is being reduced due to the payment, an accumulated residual reduction account is credited for the residual reduction amount. The AppliedPayment Transactor also handles the reversal of a payment application (if it should be reversed to a cash receipt), performing the opposite accounting at 230 in the case of a payment reversal. If an applied payment is reversed, and converted into an unapplied payment, the UnappliedPaymentTransactor is called as described below.

6. AssetAcquisition Transactor

The AssetAcquisition Transactor is a very important transactor since it is used to activate assets at 206 or when a lease is booked at 214. The activation of an asset 108 means that it has been placed in inventory. An activated asset need not be attached to a activated lease, or even an unactivated lease. Rather, a stand alone asset can be activated to represent that it is available in inventory. When an asset is placed into inventory, inventory is debited and equipment funding is credited, for the amount of the asset's value, without tax. The AssetAcquisition Transactor is discussed in greater detail below; as an example how the architecture underneath the accounting engine 500 functions.

7. AssetReturnTransactor

Accounts for the return of an Asset to inventory, after being on lease. This transactor is invoked by the end of lease processing subsystem at 222. For an operating lease, debits OperatingLeaseEquipmentOffLease and credits OperatingLeaseEquipmentOnLease for the Asset's book basis amount. Also debits AccumulatedDepreciationOnLease and credits AccumulatedDepreciationOffLease for the amount of depreciation that has been recognized. For a direct finance lease, Inventory is debited in the amount of the asset's inventory value, AccumResidualReduction is debited for the total amount of the asset's residual reduction due to holdover payments, Residual is credited in the amount of the asset's original residual value, and a GainlLossOnReturnToInventory account is credited (in the case of a gain) or debited (in the case of a loss) to make the transaction balance.

8. BillingScheduleActivation Transactor

This transactor activates a billing schedule and is invoked at either the booking process at 214 or the billing schedule processing subsystem at 216. In the case of a financed rent billing schedule on an operating lease, debits UnbilledRecv for the total amount of the billing stream and credits Unearned for the total amount of the earnings stream. In the case of any other type of financed schedule on an operating lease or on a direct finance lease, and in addition to the above entries, the Payable account is credited for the financed amount of the billing schedule. In the case of a financed rent billing schedule on a direct finance lease, UnbilledRecv is debited for the total amount of the billing stream, Unearned is credited for the total amount of the earnings and residual earnings streams, Residual is debited in the amount of the original residual value of the asset 108, and Inventory is credited in the amount of the asset's capitalized cost. This transactor also handles reversing a billing schedule activation by performing the opposite accounting.

9. BillingScheduleTermination Transactor

This transactor terminates a billing schedule, and can be activated during end of lease processing at 222. In the case of a financed billing schedule, a termination proceeds account is debited for the amount of any termination charge, UnbilledRecv is credited for the receivable balance to be closed out due to the termination, Unearned is debited for the amount of unearned income to be closed out, SuspendedEarnings is debited for the amount of suspended earnings to be closed out, and Gain/LossOnBillingScheduleTermination is either credited (in the case of a gain) or debited (in the case of a loss) in the amount of the gain/loss on termination. If the financed billing schedule is a rent schedule, in addition to the above entries, IDCSuspended is credited for the total amount of the Asset's suspended Initial Direct Costs, and IDCDeferred is credited for the total amount of the Asset's unrecognized Initial Direct Costs. Finally, in the case of a non-financed billing schedule, only two entries are made: a termination proceeds account is debited, and the Gain/LossOnBillingScheduleTermination account is credited, in the amount of the termination charge.

10. CashReceipt Transactor

The CashReceipt Transactor is used to generate the appropriate accounting entries for the receipt of cash, and is invoked by the payment application subsystem at 220. The Cash account is debited, and CashClearing is credited, in the amount of the cash receipt. This transactor also handles reversing a cash receipt by performing the opposite accounting. The reversal process is invoked by the payment adjustment and reversal subsystem at 230.

11. ChargeGeneration Transactor

The ChargeGeneration Transactor handles the accounting necessary upon the creation of an accrual-based charge, and the transactor is invoked during by the charge generation subsystem at 216. Depending on the accounting rules at 122, either BilledRecvOffset or UnbilledRecv is credited, and BilledRecv is debited, for the amount of the charge. If the charge is a scheduled charge created on a billing schedule that has been activated prior to it's agreement's activation, then special “prebooked” versions of the above accounts are used instead. The accounting done in this case is then reclassified upon the Agreement's activation (see ChargeReclassificationTransactor). The transactor also handles residual reduction as necessary by crediting AccumResidualReduction for the reduction portion attributable to the charge. This transactor also handles the reversal of a charge by performing the opposite accounting. The reversal process in performed in conjunction with the charge reversal, adjustment, or credit subsystem at 224.

12. ChargeReclassification Transactor

The ChargeReclassification Transactor handles the reclassification of scheduled charges (and their applied payments) that were generated as a result of a billing schedule's activation prior to its agreement's activation. The transactor is invoked by the rebook system at 228. Since scheduled charges (and any payments applied to them) are accounted for differently depending on the status of the agreement they are on, this transactor is called upon to perform a movement of account balances at the point of Agreement activation. Various accounts may be affected, depending on which accounts were hit when the charge(s) were first created.

13. CreditMemo Transactor

The CreditMemo Transactor handles the accounting necessary when a Credit Memo is created and is invoked by the charge reversal, adjustment, or credit subsystem at 224. Credit Memos serve to offset charges without actually reversing them. Either a TaxAdjustment account or a CreditExpense account is debited, depending on whether the Credit Memo is a Tax Adjustment. The credit account is determined by the original debit account used to account for the creation of the parent charge (if accrual-based) or by the original credit account used to account for the creation of the parent charge's applied payment (if cash-based). The transactor handles the reversal of a portion of the residual reduction which may have been recognized (if the parent charge is on a direct finance lease) when the charge was first created by crediting AccumResidualReduction for the residual reduction reversal amount attributable to the Credit Memo. This transactor also handles reversing a Credit Memo by performing the opposite accounting. This transactor is invoked through the system's 100 credit reversal, adjustment, or credit subsystem at 224.

14. DisposeBookAssetTransactor

The DisposeBookAsset Transactor accounts for the disposal (by sale or other means) of an asset 108 during end of lease processing at 222. It effectively removes the asset from the lessor's books, but without regard to tax depreciation (see DisposeTaxAssetTransactor). The disposal charge is retired by debiting the account which had been credited when the disposal charge was first created (if accrual-based) or when it's payment was applied (if cash-based). In the case of the asset's being disposed directly from a direct finance lease, Inventory is credited in the amount of the asset's inventory value, and Gain/LossOnSaleOfAsset is credited (if a gain) or debited (if a loss) to make the transaction balance. In the case of a disposal from an asset not on a lease, or from an operating lease, OperatingLeaseEquipmentOffLease is credited for the amount of the book depreciator's cost basis, AccumulatedDepreciationOffLease is debited for the amount of book depreciation which was recognized for the Asset, and Gain/LossOnAssetDispositionBook is either credited or debited to make the transaction balance.

15. DisposeTaxAsset Transactor

Accounts for the tax aspects of the disposal (by sale or other means) of an Asset and is invoked by the end of lease processing subsystem at 222. TaxDeprEquipment is credited in the amount of either the Asset's inventory value (in the case of a disposal directly from a Direct Finance Lease) or in the amount of the Tax Depreciator's cost basis. AccumTaxDepr is debited in the amount of the amount of tax depreciation recognized on for the Asset. TaxDispProceeds is debited for the amount of the disposal charge, and Gain/LossOnAssetDispositionTax is either credited or debited to balance the transaction. This transactor is invoked during end of lease processing at 222.

16. Divestiture Transactor

Accounts for the assumption (taking over by a new Lessee) of an Agreement. For each billing schedule on each Asset on the original assumed Agreement, a transaction is created which credits UnbilledRecv for the amount of unbilled receivables as of the assumption date, debits Unearned for the amount of unearned income as of the assumption date, and either credits or debits Gain/LossOnAssumption to balance the transaction. The divestiture of a lease to new customer is handled by the lease processing subsystem at 210.

17. EarningsReclassification Transactor

Accounts for the suspension of earnings recognition for a billing schedule. For each month in the earnings stream of the schedule, a transaction is created which debits Earned for the amount of earnings recognized for the month, and credits SuspendedEarnings for the same amount. This transactor also handles the resumption of normal earnings recognition as of a specified resumption date by performing the opposite accounting for any earnings recognized after that date. The suspension of earnings recognition is done through the rebook subsystem at 228.

18. HaltBookDepreciator Transactor

Handles the accounting required to halt book depreciation when an Asset is put on to a Direct Finance Lease. Inventory is debited for the Asset's net book value, OperatingLeaseEquipmentOffLease is credited for the Asset's book basis, and AccumulatedDepreciationOffLease is debited for the amount of depreciation recognized so far for the Asset. This transactor is invoked by the booking system at 214.

19. IDCActivation Transactor

Activates an Initial Direct Cost by crediting IDCPayable for the total amount of the Initial Direct Cost and debiting IDCDeferred by the same amount. This transactor can also reverse the activation by performing the opposite accounting, and is invoked by the booking subsystem at 214.

20. IDCReclassification Transactor

This transactor handles the accounting necessary to suspend the recognition of Initial Direct Costs. For each month in the amortization stream of the Initial Direct Cost, an accounting transaction is created which credits IDCEarned in the amount of the Initial Direct Cost to be recognized for that month, and debits IDCSuspended for the same. This transactor also handles the resumption of normal recognition as of a specified resumption date by performing the opposite accounting for any costs recognized after that date. This transactor is invoked by the rebooking subsystem at 228.

21. IncludeInRentPurchaseTaxRecognition Transactor

Performs accounting required for recognizing an Asset's Purchase Tax included in rent. Inventory is debited for the Purchase Tax amount, while either EquipmentFunding (in case the Purchase Tax represents sales tax) or PurchaseTaxPayable (in case the Purchase Tax represents use tax) is debited for the same amount. This transactor can be invoked by the booking subsystem at 214 or the rebooking subsystem at 228.

22. IncludeInRentUpfrontTaxRecognition Transactor

Performs accounting required for recognizing an Asset's Upfront Tax included in rent. Inventory is debited for the Upfront Tax amount, while UpfrontTaxLiability is debited for the same. This transactor also handles the reversal accounting. This transactor can be invoked by the booking subsystem at 214 or the rebooking subsystem at 228.

23. InventoryValueWriteDown Transactor

Performs the accounting required for writing down the inventory value of an Asset. Inventory is credited for the amount of the write down, while Gain/LossOnInventoryRevaluation is debited for the same. This transactor also handles the reversal of an inventory write down by performing the opposite accounting. This transactor can be invoked by the booking subsystem at 214 or the rebooking subsystem at 228.

24. LumpSumPurchaseTaxRecognition Transactor

Performs accounting required for recognizing an Asset's Purchase Tax as a lump sum. TaxLiabilityExpense is debited for the Purchase Tax amount, while either EquipmentFunding (in case the Purchase Tax represents sales tax) or PurchaseTaxPayable (in case the Purchase Tax represents use tax) is debited for the same amount. This transactor can be invoked by the booking subsystem at 214 or the rebooking subsystem at 228.

25. LumpSumUpfrontTaxRecognition Transactor

Performs accounting required for recognizing an Asset's Upfront Tax as a lump sum. TaxLiabilityExpense is debited for the Upfront Tax amount, while UpfrontTaxLiability is debited for the same. This transactor also handles the reversal accounting. This transactor can be invoked by the booking subsystem at 214 or the rebooking subsystem at 228.

26. RecognizeBookDepreciation Transactor

Handles accounting for the recognition of an Asset's book depreciation. If the Asset is on lease, DepreciationExpenseOnLease is debited for the amount of depreciation to be recognized, and AccumulatedDepreciationOnLease is credited for the same amount. If the Asset is in inventory, the DepreciationExpenseOffLease and AccumulatedDepreciationOffLease accounts are used instead. This transactor also handles the reversal of depreciation recognition by performing the opposite accounting. This transactor can be invoked by the booking subsystem at 214 or the rebooking subsystem at 228.

27. RecognizeEarnings Transactor

Handles the accounting required for recognizing that rental income has been earned. Unearned is debited for the total earnings to be recognized (normal plus suspended), while Earned is credited for the normal earnings amount, and SuspendedEarnings is credited for the suspended earnings amount. This transactor also handles the reversal of earnings recognition by performing the opposite accounting. This transactor can be invoked by the booking subsystem at 214 or the rebooking subsystem at 228.

28. RecognizeIDC Transactor

Handles the accounting required for recognizing that Initial Direct Cost income has been earned. IDCDeferred is debited for the total Initial Direct Cost earnings to be recognized (normal plus suspended), while IDCEarned is credited for the normal earnings amount, and IDCSuspended is credited for the suspended earnings amount. This transactor also handles the reversal of Initial Direct Cost earnings recognition by performing the opposite accounting. This transactor can be invoked by the booking subsystem at 214 or the rebooking subsystem at 228.

29. RecognizeUSTaxDepreciation Transactor

Handles accounting for the recognition of an Asset's U.S. tax depreciation. TaxDeprExp is debited for the amount of depreciation to be recognized, and AccumTaxDepr is credited for the same amount. This transactor also handles the reversal of depreciation recognition by performing the opposite accounting. This transactor can be invoked by the booking subsystem at 214 or the rebooking subsystem at 228.

30. TransferAssetToLeaseForDivestiture Transactor

This transactor performs the same function as the TransferAssetToLeaseTransactor, but for transferring an asset to an Assumption Operating Lease. Since the Program of the Assumption may be different from that of the Assumed lease, the Assumption's Program is used to look up the “OnLease” account numbers, while the Assumed lease's Program is used to look up the “OffLease” account numbers. This transactor can be invoked by the lease processing at 210.

31. TransferAssetToLease Transactor

Does the accounting required for putting an Asset onto an Operating Lease from inventory. OperatingLeaseEquipmentOnLease is debited for the amount of the Asset's book basis, and OperatingLeaseEquipmentOffLease is credited for the same amount. AccumulatedDepreciationOnLease is credited for the amount of the Asset's book depreciation recognized so far, while AccumulatedDepreciationOffLease is debited for the same. This transactor can be invoked by the booking subsystem at 214 or the rebooking subsystem at 228.

32. UnappliedPayment Transactor

Creates accounting entries to recognize that an Unapplied Payment has been created due to either the reversal of one or more Applied Payments, or due to the receipt of cash. If the Unapplied Payment is cash-receipt-based, a single transaction is created which credits UnappliedPayments for the amount of the Unapplied Payment and debits CashClearing for the same amount. If the Unapplied Payment has been created due to the reversal of one or more Applied Payments, an accounting transaction is created for each of the source Applied Payments. The transaction credits UnappliedPayments for the amount of the reversed Applied Payment, and debits BilledRecv for the same amount. This transactor also handles the reversal of an Unapplied Payment: a single transaction is created which credits Cash and debits UnappliedPayments for the amount of the Unapplied Payment. This transactor is invoked by the payment application subsystem 220 or the unbooking process at 226.

33. UndoAssetReturnOnOperatingLease Transactor

Accounts for undoing an Asset return from an Operating Lease. This undo functionality is required if the original return was made in error. OperatingLeaseEquipmentOnLease is debited for the amount of the Asset's book depreciation basis as of the return date. OperatingLeaseEquipmentOffLease is credited for the Asset's current book depreciation basis. Gain/LossBookBasis is either credited (in the case of a gain) or debited (in the case of a loss) for the difference. AccumulatedDepreciationOnLease Is credited for the total amount of book depreciation recognized as of the return date. AccumulatedDepreciationOffLease is debited for the current total amount of book depreciation recognized. Finally, DepreciationExpenseOffLease is either credited or debited to make the transaction balance. This transactor can be invoked during the end of lease process at 222.

C. Technical Architecture of Accounting Transactors

In the computer system 102, the accounting rules 122 necessary to generate book entries 101 for operational activities are stored in accounting transactors 515. Each transactor 515 knows how to create a particular type of accounting function using a particular kind of accountable object 518. Storing all accounting rules 122 at the level of accounting transactors 514 maximizes the flexibility of the system 100, and makes it as easy as possible to make changes to the way accounting is performed, since it is only performed in one place, in the accounting transactor 515.

FIG. 22 discloses a detailed flowchart of how the AssetAcquisition Transactor is invoked. In an operational event-based accounting system, a business transaction 516 is required to initiate accounting activity. As is indicated by FIG. 22, a business transaction 516 exists in the EJB (enterprise java bean) or application level 154. At the level of the application, all that is known is that an asset is to be acquired and the function acquireAsset( ) is called. The accountable object 518, in this case an asset 108, knows that accounting is to be performed upon in, and the function(s) used. FIG. 22 makes clear that the substantive accounting knowledge is not kept at the application/EJB level 154 or at the level of the accountable object 518. The programming code at the level of the accountable object 518 simply accesses a transaction registry 520 but then selects the appropriate accounting transactor 515, which in the case of asset acquisition, is the AssetAcquisition Transactor 522. In FIG. 22, the AssetAcquisition Transactor 522 is the only transactor 515 returned from the registry 520. The AssetAcquisition Transactor 522 contains the process for generating an accounting transaction to record the asset acquisition, but the transactor 522 does not know which particular accounts to debit or credit. Some information such as the asset's inventory value, needs to come from the accountable object 518 itself.

The process continues when the asset 108 requests that the transactor 522 create the accounting transactions. Since there is only a single appropriate transactor 522 for an asset acquisition, it must handle accounting for the one or more booksets 116 belonging to the asset's 108 accounting owner 111. It generates the accounting by retrieving all of the booksets 116 from the accounting owner 111, and iteratively creating a virtually identical accounting transaction for each of the booksets 116. The booksets 116 are not exactly identical, as explained below.

Accounting entries 101, or “journal entries” require amounts and account numbers, and of course whether the entry is a debit or a credit. As stated previously, the transactor 522 can retrieve an amount to use from the accountable object 518, in this case an asset 108. The account number is retrieved from the chart of accounts 121, the master cross-index for connecting accounting owners 111 to the appropriate booksets 116. The transactor 522 provides certain input into the chart of accounts 121 such as the natural account for a journal entry, the program that the asset 108 is on, the sales source of the asset 108, the current bookset 116, and other inputs. The accountable object 518 knows some information such as the program and the sales source. Other information is known by the transactor 522, such as the natural account, the bookset 116, whether the entry is a debit or credit. The chart of accounts 111 performs a lookup and returns the appropriate account number matching all of the criteria passed to it. The transactor 522 can then use the account number to generate a journal entry 526 in a bookset 116. The process is repeated for each journal entry 526 that the accounting transactor 522 requires. Due to the lookup process in the chart of accounts 121, account numbers can easily be added, removed, and changed without having to change the application software 182 residing on the computer system 102.

Since the current bookset 116 is an input to the chart of accounts 121, the accounting transactions created for each bookset 116 are not necessarily exactly identical, since the account numbers set up in the chart of accounts will probably vary as a function of the bookset 116. After all booksets 116 have been accounted for, the accounting transactions are posted and persisted to the LLAE database 514.

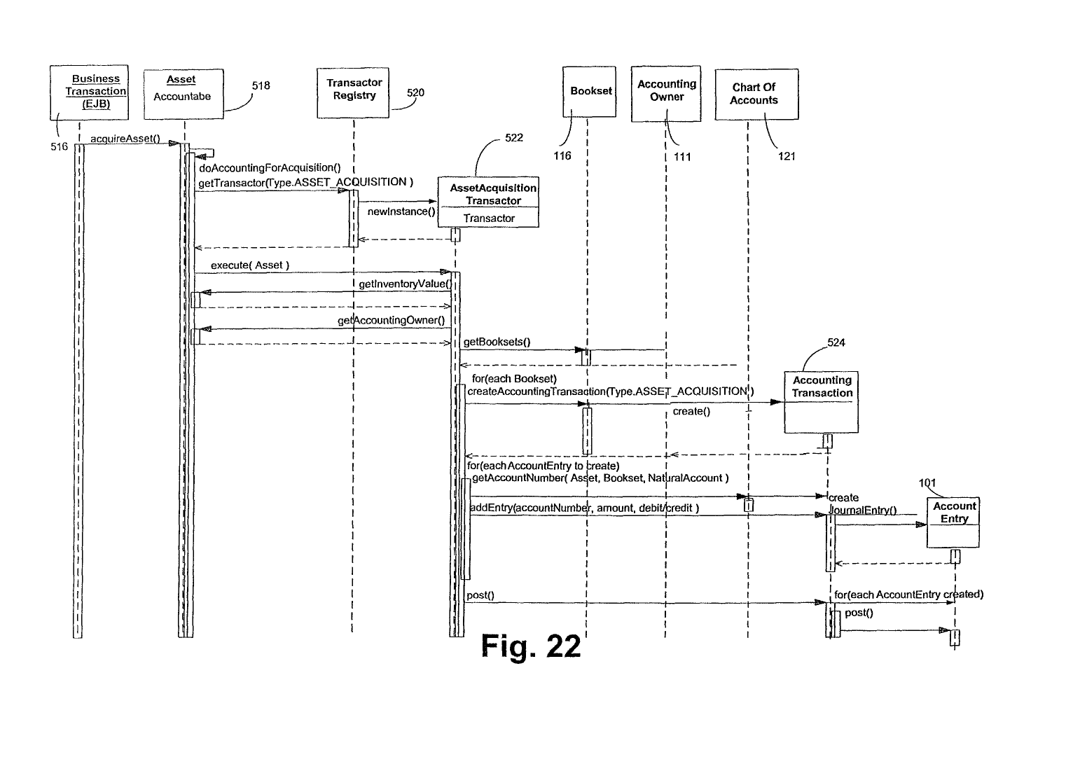

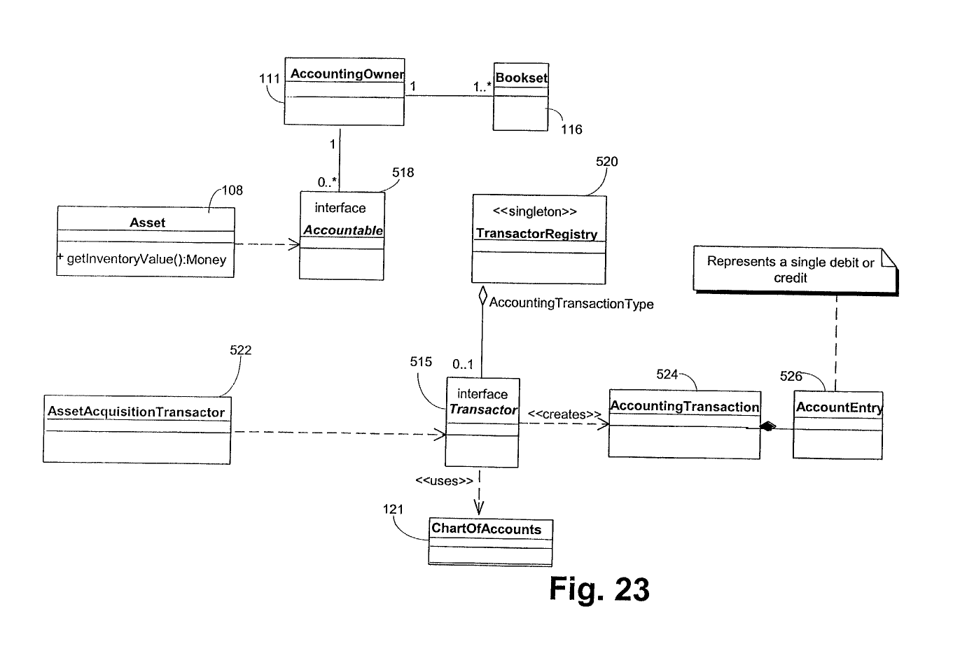

FIG. 23 illustrates a data model that corresponds with the flow chart in FIG. 22. The asset 108 has the ability to determine its own inventory value. It can serve as an accountable object at 518, an abstract for which a user 106 wants to conduct an operational act which necessarily has a financial accounting consequence, in this example, activating an asset 108. An accounting owner 111 can have many such accountable objects 518, but an accountable object 518 can only have one accounting owner 111. An accounting owner 111 can have many booksets 116, but each bookset 116 can have only one accounting owner 111.

The AssetAcquisition Transactor 522 uses an interface transactor 514 from the transactor registry 520 and in the information in the chart of accounts 121 to generate the accounting transaction 524 and the accounting entry.

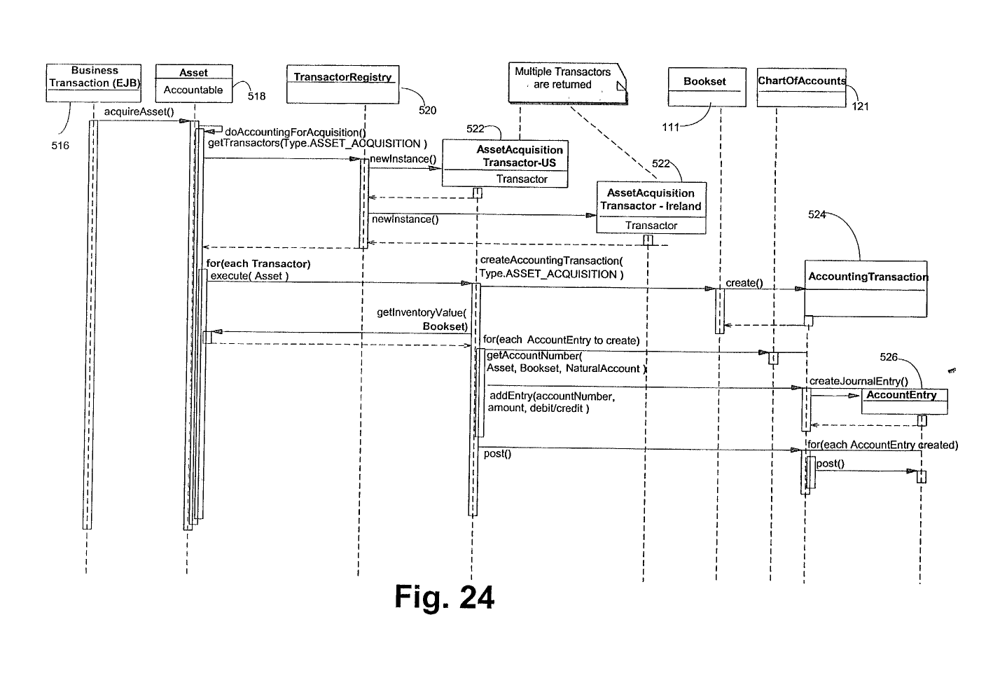

FIG. 24 is very similar to FIG. 22, except that FIG. 24 discloses a multiple bookset 116 accounting process. Multiple transactors are returned, AssetAcquisitionTransactorUS 522 and AssetAcquisitionTransactorIreland 522 are both returned.

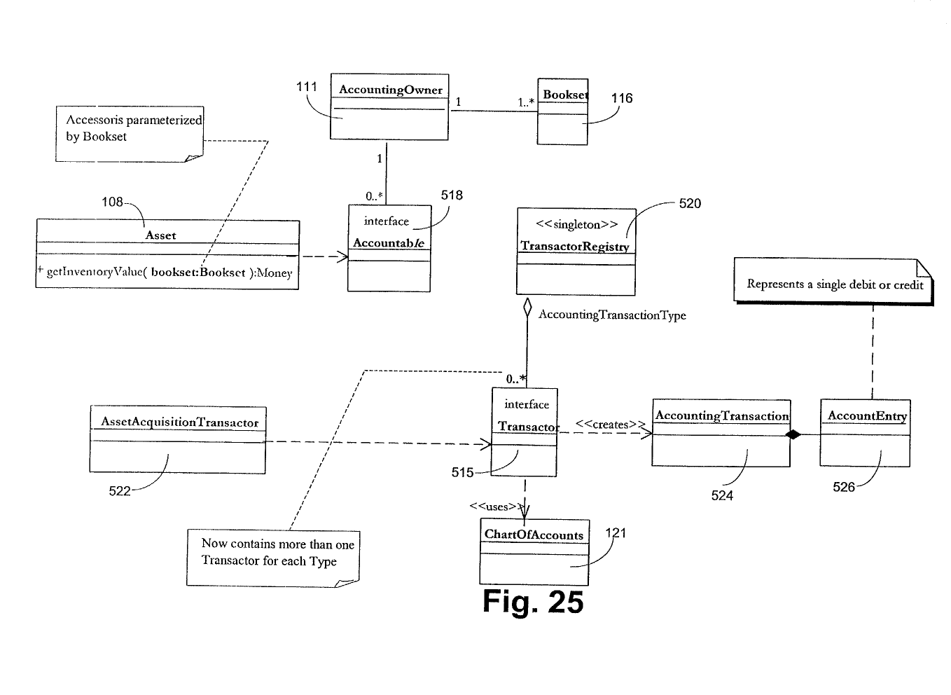

FIG. 25 is very similar to FIG. 23, except that FIG. 25 discloses a data model for a multiple bookset accounting process. There is more than one accounting transactor at 514 per accounting transaction types in the accounting registry 520, resulting in multiple booksets 113 being generated by multiple accounting transactors 514.

V. Other Features

A. Document Generation and Tracking

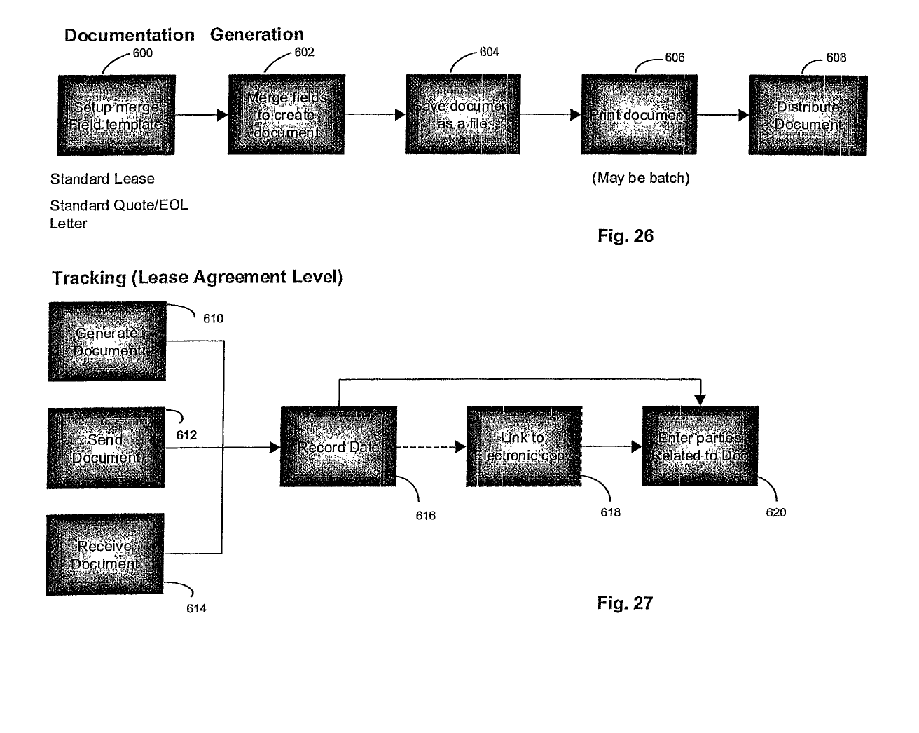

The computer system 102 can be used to generate and track documents. FIG. 26 describes the document generation subsystem. The first step in the process is to setup merge field templates at 600. This is where standard leases and standard quotes for end of lease processing can be generated. The fields can then be merged at 602 to create a document. At 604 the document is saved as a file. Printing of the document 606 and distribution of the document 608 can be performed in either batch mode, or on a one by one basis as desired by the user 106.

FIG. 27 illustrates the tracking of documents at the lease agreement level. A document is generated at 610. The sending of the document is stored at 612 and the receiving of the document is stored at 614. For all documents the date is recorded at 616, a link is generated to an electronic copy 618 and all parties related to the document are also stored along with the link at 620. It is important that the sender, receiver, and the Signor of all documents be accurately tracked and stored.

B. Inquiry

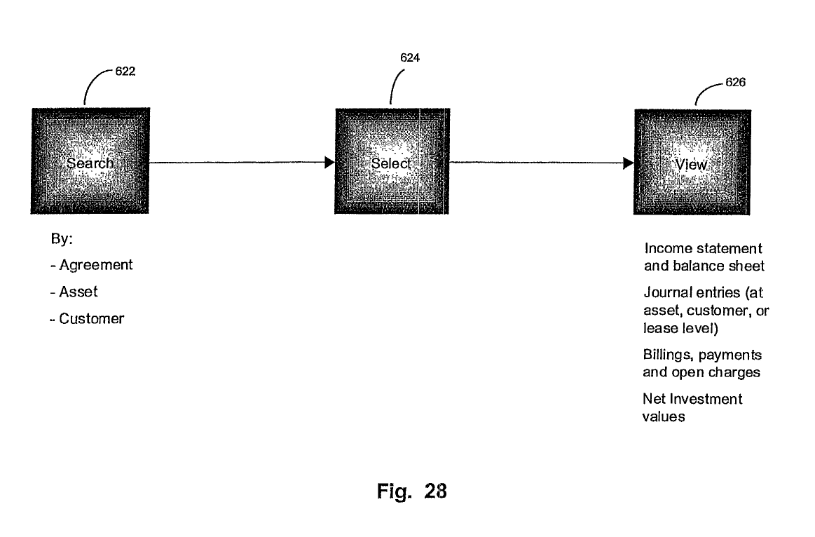

The ability to search for information relating to a customer (organization), an asset, an agreement, or any other information relating to an asset or a lease is very important. Search screens should be implemented in a uniform way, and as independent of the characteristic being searched, as possible. FIG. 28 discloses a basic flow chart illustrating how inquiry screens work. First, the user must initiate the search of a particular characteristic through a menu selection, a button, or some other means at 622. When a screen containing a list of data of the desired characteristic appears at 624, the user 106 needs to highlight the appropriate row that is to be examined in greater detail or is to be modified, and execute the selection. The detailed information can then be viewed at 626.

The ability to perform roll-up/roll-down inquiries is facilitated by the underlying architecture of the invention as described above. Information can be rolled-up into aggregate reports. For example, the internal rate of return can be calculated for an individual asset, an individual billing schedule, an individual lease, an individual customer, or for an entire program. The ability to perform such flexible searches supports the ability to conduct flexible “what if” analysis, such as what the IRR for a customer would be if a new proposed lease was executed, or what the different IRR's for different customers are, or any other useful analysis to the management of lease transactions.

While the invention has been specifically described in connection with certain specific embodiments thereof, it is to be understood that this is by way of illustration and not of limitation, and the scope of the appended claims should be construed as broadly as the prior art will permit.

What is claimed:

1. A lease transaction management and accounting system comprising:
a plurality of business attributes;
a plurality of business events triggered by the creation, modification or deletion of said business attributes;
an accounting entry;
a bookset for the recording of said accounting entry;
an accounting engine including a plurality of accounting rules used to generate said accounting entry; and
wherein said accounting rules determine whether at least one of said business events event triggers said accounting engine.

2. A lease transaction management and accounting system as recited in claim 1, said accounting engine comprising a plurality of accounting transactors and an accounting event, wherein one of said business events triggers said accounting event and said accounting event triggers said accounting engine to use at least one of said accounting transactors to generate said accounting entry.

3. A lease transaction management and accounting system as recited in claim 1, comprising multiple booksets, wherein one of said business events triggers said accounting engine to generate said accounting entry in multiple booksets.

4. A lease transaction management and accounting system as recited in claim 1, further comprising a plurality of accounting owners, wherein a subset of said accounting rules distinguish between said accounting owners.

5. A lease transaction management and accounting system as recited in claim 1, further comprising a plurality of programs, wherein a subset of said accounting rules distinguish between said programs.

6. A lease transaction management and accounting system as recited in claim 1, further comprising a plurality of financial products, wherein a subset of said accounting rules distinguish between said financial products.

7. A lease transaction management and accounting system as recited in claim 1, further comprising a plurality of initial direct cost types, wherein a subset of said accounting rules distinguish between said initial direct cost types.

8. A lease transaction management and accounting system as recited in claim 1, further comprising a plurality of charge types, wherein a subset of said accounting rules distinguish between said charge types.

9. A lease transaction management and accounting system as recited in claim 1, comprising an accounting owner, a program, and a financial product, wherein said accounting owner has at least one program and each said program has at least one financial product, a subset of said accounting rules distinguishing between combinations of said accounting owner, said program, and said financial product.

10. A lease transaction management and accounting system as recited in claim 1, further comprising an item category, a cost category, and a depreciator, wherein a subset of said accounting rules distinguish between combinations of said item category, said cost category, and said book depreciator.

11. A lease transaction management and accounting system as recited in claim 10, wherein said depreciator is a book depreciator.

12. A lease transaction management and accounting system as recited in claim 10, wherein said depreciator is said tax depreciator.

13. A lease transaction management and accounting system as recited in claim 1, further comprising an accounting owner, an item type, and a depreciation selection, wherein a subset of said accounting rules distinguish between combinations of said item type, said accounting owner, and said depreciation selection.

14. A lease transaction management and accounting system as recited in claim 13, wherein said depreciation selection is said tax depreciation selection.

15. A lease transaction management and accounting system as recited in claim 13, wherein said depreciation selection is said tax depreciation selection.

16. A lease transaction management and accounting system as recited in claim 1, further comprising a natural account, a chart of accounts, and an account number, wherein said natural account represents a plurality of accounts having a common characteristic, and said system locating said account number by searching said natural account on said chart of accounts.

17. A lease transaction management and accounting system as recited in claim 1, further comprising business logic isolated from said accounting engine and said accounting rules, said business logic creating, modifying or deleting said business attributes.

18. A lease transaction management and accounting system as recited in claim 1, said business attributes comprising an asset attribute, wherein said accounting engine generates said accounting entry from said asset attribute.

19. A lease transaction management and accounting system as recited in claim 1, said one of said business events includes a passage of time.

20. A lease transaction management and accounting system comprising:
a plurality of business attributes;
a plurality of business events triggered by the creation, modification or deletion of said business attributes;
an accounting entry;
a bookset for the recording of said accounting entry;
an accounting engine including a plurality of accounting rules and accounting transactors, said accounting rules determining whether at least one of said business events triggers said accounting transactors to generate said accounting entry;
a plurality of accounting owners, wherein each said bookset is attributable to one said accounting owner;
a plurality of programs, wherein each said program is attributable to one said accounting owner;
a plurality of financial products, wherein each said financial product is attributable to one said program; and
wherein said accounting rules distinguish between said accounting owners, said programs, and said financial products.

21. A lease transaction management and accounting system as recited in claim 20, comprising multiple booksets, wherein one of said business events triggers a specific accounting transactor to generate said accounting entry in each of said multiple booksets.

22. A lease transaction management and accounting system as recited in claim 20, further comprising a plurality of initial direct cost types, charge types, and cost categories, and wherein said accounting rules distinguish between combinations of said plurality.

23. A lease transaction management and accounting system as recited in claim 20, further comprising an item category, a cost category, a book depreciator, wherein said accounting rules distinguish between combinations of said item category, said cost category, and said book depreciator.

24. A lease transaction management and accounting system as recited in claim 20, further comprising an item category, a cost category, and a tax depreciator, wherein said accounting rules distinguish between combinations of said item category, said cost category, and said tax depreciator

25. A lease transaction management and accounting system as recited in claim 20, further an item type and a depreciation method wherein said accounting rules distinguish between said combinations of said accounting owner, said item type, and said depreciation method.

26. A lease transaction management and accounting system as recited in claim 20, further comprising a natural account, a chart of accounts, and an account number, wherein said natural account represents a plurality of accounts having a common characteristic, and said system locating said account number searching said natural account on said chart of accounts.

27. A lease transaction management and accounting system as recited in claim 26, wherein said program, said accounting owner, and said natural account identify said account number.

28. A lease transaction management and accounting system as recited in claim 20, further comprising business logic isolated from said accounting engine and said accounting rules, said business logic creating, modifying or deleting business attributes.

29. A lease transaction management and accounting system comprising:
a plurality of business attributes;
a plurality of business events triggered by the creation, modification or deletion of said business attributes or the passage of time;
a plurality of accounting entries;
a bookset for the recording of said accounting entry;
an accounting engine including a plurality of accounting rules and accounting transactors, said accounting rules determining whether one of said business events triggers at least one accounting transactor to generate a specific type of said accounting entry;
a plurality of accounting owners, wherein each said bookset is attributable to one said accounting owner;
a plurality of programs, wherein each said program is attributable to one said accounting owner;
a plurality of financial products, wherein each said financial product is attributable to one said program;
a plurality of charge types;
a plurality of asset categories;
a plurality of depreciators;
a plurality of depreciation selections; and
a plurality of accounting rules that determine which subset of business events trigger said accounting engine to generate said accounting entry, and wherein said accounting rules distinguish between said accounting owners, said programs, said financial products, said charge types, said asset categories, said depreciators, and said depreciationselections.

30. A lease transaction management and accounting system as recited in claim 20, comprising multiple booksets, wherein one of said business events triggers a specific accounting transactor to generate said accounting entry in each of said multiple booksets.
